(19) United States
(12) Patent Application Publication
(10) Pub. No.: US 2023/0327092 A1
(43) Pub. Date: Oct. 12, 2023

(54) ELECTRODE, SECONDARY BATTERY, MOVING VEHICLE, ELECTRONIC DEVICE, AND METHOD FOR MANUFACTURING ELECTRODE FOR LITHIUM-ION SECONDARY BATTERY

(71) Applicant: SEMICONDUCTOR ENERGY LABORATORY CO., LTD., Atsugi-shi, Kanagawa-ken (JP)

(72) Inventors: Kazutaka KURIKI, Ebina, Kanagawa (JP); Tatsuyoshi TAKAHASHI, Atsugi-shi, Kanagawa-ken (JP); Yoshiharu ASADA, Odawara, Kanagawa (JP); Daichi HIGO, Atsugi-shi, Kanagawa-ken (JP); Yuji IWAKI, Isehara, Kanagawa (JP); Shunpei YAMAZAKI, Sestagaya, Tokyo (JP); Taisuke NAKAO, Atsugi, Kanagawa (JP); Teppei OGUNI, Atsugi, Kanagawa (JP)

(21) Appl. No.: 18/004,700

(22) PCT Filed: Jul. 1, 2021
(86) PCT No.: PCT/IB2021/055893

§ 371 Date: Jan. 9, 2023

(30) Foreign Application Priority Data
Jul. 14, 2020 (JP) 2020-120985
Aug. 20, 2020 (JP) 2020-139636
Sep. 8, 2020 (JP) 2020-150428
May 20, 2021 (JP) 2021-085189

(51) Int. Cl. H01M 4/38; H01M 4/587; H01M 4/134; H01M 4/133

(52) U.S. Cl. CPC H01M 4/386; H01M 4/133; H01M 4/134; H01M 4/587

(57) ABSTRACT

An electrode with little deterioration or a secondary battery with little deterioration is provided. An electrode includes a first region and a second region. The first region includes a particle containing silicon. The second region includes a particle containing silicon and a graphene compound. The second region is in contact with the first region to cover at least part thereof. Alternatively, an electrode includes a plurality of particles containing silicon and a graphene compound. Each of the plurality of particles containing silicon includes a functional group containing oxygen and carbon, a functional group containing oxygen, or a fluorine atom in at least part of the surface. The graphene compound includes at least one of carbon terminated with hydrogen and carbon terminated with fluorine in a plane of the graphene compound. The graphene compound is in contact with the plurality of particles containing silicon to closely cling thereto. The particle containing silicon preferably contains amorphous silicon or polycrystalline silicon.

### TECHNICAL FIELD

One embodiment of the present invention relates to an electrode and a method for manufacturing the electrode. Another embodiment of the present invention relates to an active material included in an electrode and a method for manufacturing the active material. Another embodiment of the present invention relates to a secondary battery and a method for manufacturing the secondary battery. Another embodiment of the present invention relates to a moving vehicle such as a vehicle, a portable information terminal, an electronic device, and the like that each include a secondary battery.

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

Note that in this specification, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today’s information society.

It is important for secondary batteries to have high capacity as well as their stability. A silicon-based material has high capacity and is used as an active material of a secondary battery. A silicon material can be characterized by a chemical shift value obtained from an NMR spectrum (Patent Document 1).

Improvement of a negative electrode including a coating film has been studied to increase the cycle performance and the capacity of the lithium-ion secondary battery (Patent Document 2).

### Reference

### Patent Document

[Patent Document 1] Japanese Published Pat. Application No. 2015-156355
[Patent Document 2] Japanese Published Pat. Application No. 2015-88482

### SUMMARY OF THE INVENTION

### Problems to Be Solved by the Invention

Capacity of secondary batteries used in moving vehicles such as electric vehicles or hybrid vehicles need to be increased for longer driving ranges.

Furthermore, portable terminals and the like have more and more functions, resulting in an increase in power consumption. In addition, reductions in size and weight of secondary batteries used in portable terminals and the like are demanded. Therefore, secondary batteries used in portable terminals are desired to have higher capacity.

For example, an electrode of a secondary battery is formed using materials such as an active material, a conductive agent, and a binder. As the proportion of a material that contributes to charge and discharge capacity, for example, an active material, becomes higher, a secondary battery can have increased capacity. When an electrode includes a conductive agent, the conductivity of the electrode is increased and excellent output characteristics can be obtained. Repeated expansion and contraction of an active material in charging and discharging of a secondary battery might cause detachment of the active material, blocking of a conductive path, and the like in the electrode. In such a case, the detachment of the active material and the blocking of a conductive path can be inhibited with a conductive agent and a binder included in the electrode. In contrast, when the conductive agent and the binder are included, the proportion of the active material is decreased and thus the capacity of the secondary battery might be decreased.

An object of one embodiment of the present invention is to provide an electrode with excellent characteristics. Another object of one embodiment of the present invention is to provide an active material with excellent characteristics. Another object of one embodiment of the present invention is to provide a novel electrode.

Another object of one embodiment of the present invention is to provide a mechanically sturdy negative electrode. Another object of one embodiment of the present invention is to provide a mechanically sturdy positive electrode. Another object of one embodiment of the present invention is to provide a negative electrode having high capacity. Another object of one embodiment of the present invention is to provide a positive electrode having high capacity. Another object of one embodiment of the present invention is to provide a negative electrode with little deterioration. Another object of one embodiment of the present invention is to provide a positive electrode with little deterioration.

Another object of one embodiment of the present invention is to provide a secondary battery with little deterioration. Another object of one embodiment of the present invention is to provide a highly safe secondary battery. Another object of one embodiment of the present invention is to provide a secondary battery with high energy density. Another object of one embodiment of the present invention is to provide a novel secondary battery.

Note that the description of these objects does not preclude the existence of other objects. One embodiment of the present invention does not have to achieve all these objects. Other objects can be derived from the description of the specification, the drawings, and the claims.

### Means for Solving the Problems

An electrode of one embodiment of the present invention includes a particle and a sheet-like material. The particle includes a region that is terminated with a functional group containing oxygen and carbon, a functional group containing oxygen, or a fluorine atom.

The particle included in the electrode of one embodiment of the present invention preferably includes a region that is terminated with a functional group containing oxygen and carbon, a functional group containing oxygen and hydrogen, a functional group containing oxygen and lithium, a functional group containing fluorine, a hydrogen atom, or a fluorine atom. Examples of the functional group containing oxygen and hydrogen include a hydroxy group, a carboxyl group, and a functional group containing a hydroxy group.

The sheet-like material is curved so as to be close to the particle by an intermolecular force, and thus can cling to the particle due to a hydrogen bond. Note that the sheet-like material preferably includes a plurality of regions terminated with hydrogen atoms in a sheet plane. The sheet plane has a plane facing a particle and a plane on the back thereof, for example. The sheet plane is not limited to a plane and includes a curved plane. The area of the sheet plane refers to a surface area including the areas of the plane and the curved plane. It is preferable that in the region that is terminated with a hydrogen atom, the hydrogen atom that terminates an atom in the region be provided in the plane in contact with the particle, for example. The plurality of regions terminated with hydrogen atoms are widely provided across the sheet plane, so that the area where the sheet-like material clings to the particle can be increased. The area where the sheet-like material clings to the particle means an area where a sheet plane is in contact with a surface of a particle. In addition, the above-described sheet-like material has hydrogen bond regions, and the hydrogen bond regions may be localized and distributed. In such a distribution, an oxygen atom or a fluorine atom contained in a functional group terminating the particle and the hydrogen bond region can cling to each other more closely by an intermolecular force or the like.

An electrode of one embodiment of the present invention includes a particle and a sheet-like material. The electrode includes a first region in which a plurality of the particles aggregate and a second region including the particle and the sheet-like material.

The particle included in the electrode of one embodiment of the present invention preferably includes a region that is terminated with one or more of a functional group containing oxygen and carbon, a functional group containing oxygen and hydrogen, a functional group containing oxygen and lithium, and a hydrogen atom.

The particle included in the electrode of one embodiment of the present invention preferably functions as, for example, an active material. As the particle included in the electrode of one embodiment of the present invention, a material functioning as an active material can be used. Alternatively, the particle included in the electrode of one embodiment of the present invention preferably contains a material functioning as an active material, for example. A sheet-like material included in the electrode of one embodiment of the present invention preferably functions as a conductive agent, for example. One embodiment of the present invention can provide an electrode having high conductivity, because a conductive agent can cling to an active material by a hydrogen bond.

The particle included in the electrode of one embodiment of the present invention preferably contains silicon. Silicon preferably includes amorphous silicon. Alternatively, silicon preferably includes polycrystalline silicon.

A graphene compound is preferably included as the sheet-like material. A preferred example of the graphene compound is graphene in which a carbon atom in a sheet plane is terminated with an atom or a functional group other than carbon.

Graphene has a structure in which an edge is terminated with hydrogen. A sheet of graphene has a two-dimensional structure which is formed with a six-membered ring of carbon. When a defect or a hole is formed in the two-dimensional structure, a carbon atom in the vicinity of the defect or a carbon atom forming the hole is terminated with any of various functional groups or an atom such as a hydrogen atom or a fluorine atom in some cases.

In one embodiment of the present invention, a defect or a hole is formed in graphene, and a carbon atom in the vicinity of the defect or a carbon atom forming the hole is terminated with a hydrogen atom, a fluorine atom, a functional group containing a hydrogen atom or a fluorine atom, a functional group containing oxygen, or the like, whereby graphene can cling to a particle included in the electrode. The defect or the hole formed in graphene is preferably formed in the amount that does not notably decrease the conductivity of the whole graphene. Here, an “atom forming a hole” indicates, for example, an atom around an opening, an atom on an end portion of the opening, or the like.

A graphene compound of one embodiment of the present invention includes a hole formed with a many-membered ring such as a 9- or more-membered ring composed of carbon atoms, preferably an 18- or more-membered ring composed of carbon atoms, further preferably a 22- or more-membered ring composed of carbon atoms. One of carbon atoms in the many-membered ring is terminated with a hydrogen atom. Moreover, in one embodiment of the present invention, one carbon atom in the many-membered ring is terminated with a hydrogen atom, and another carbon atom in the many-membered ring is terminated with a fluorine atom. Furthermore, in one embodiment of the present invention, the number of carbon atoms in the many-numbered ring that are terminated with fluorine is less than 40 % of the number of carbon atoms that are terminated with hydrogen atoms.

The hole included in the graphene compound can be determined from a high-resolution image obtained with a TEM (transmission electron microscope) or a STEM (scanning transmission electron microscope). In the case of using a TEM for observing the hole included in the graphene compound, a lattice can be easily determined when a TEM observation image is subjected to FFT (Fast Fourier Transform) filtering processing to reduce noise.

A graphene compound of one embodiment of the present invention includes a hole, and the hole is formed by a plurality of carbon atoms bonded to each other in a ring and atoms or functional groups terminating the plurality of carbon atoms, for example. One or more of the plurality of carbon atoms bonded to each other in a ring may be substituted by any of a Group 13 element such as boron, a Group 15 element such as nitrogen, and a Group 16 element such as oxygen.

In the graphene compound of one embodiment of the present invention, a carbon atom other than the carbon atom at the edge is preferably terminated with a hydrogen atom, a fluorine atom, a functional group containing a hydrogen atom or a fluorine atom, a functional group containing oxygen, or the like. In addition, for example, in the graphene compound of one embodiment of the present invention, a carbon atom near the center of a plane of graphene is preferably terminated with a hydrogen atom, a fluorine atom, a functional group containing a hydrogen atom or a fluorine atom, a functional group containing oxygen, or the like.

One embodiment of the present invention is an electrode including a first region and a second region. The first region includes a first particle containing silicon. The second region includes a second particle containing silicon and a graphene compound. The second region is in contact with at least part of the first region.

One embodiment of the present invention is an electrode including a first region and a second region. The first region includes a first particle containing silicon. The second region includes a second particle containing silicon and a graphene compound. The second region is in contact with at least part of the first region to cover the part.

In the electrode described in either of the above, the graphene compound is preferably in contact with the second particle to cling to the second particle.

In the electrode described in any of the above, it is preferable that the first particle and the second particle each include a region where the particle surface is terminated with one or more of a functional group containing oxygen and carbon, a functional group containing oxygen and hydrogen, a functional group containing oxygen and lithium, and a hydrogen atom.

In the electrode described in any of the above, the first particle and the second particle each preferably contain oxygen, carbon, and lithium in at least part of a surface portion.

In the electrode described in any of the above, the first particle and the second particle each preferably contain amorphous silicon.

In the electrode described in any of the above, the first particle and the second particle each preferably contain polycrystalline silicon.

One embodiment of the present invention is an electrode including a particle containing silicon and a graphene compound. The particle containing silicon has a bond with a functional group containing oxygen and carbon, a functional group containing oxygen, or a fluorine atom in at least part of the surface. The graphene compound includes hydrogen or a functional group containing hydrogen. The graphene compound closely clings to the particle containing silicon.

One embodiment of the present invention is an electrode including a plurality of particles containing silicon and a graphene compound. Each of the plurality of particles containing silicon has a bond with a functional group containing oxygen and carbon, a functional group containing oxygen, or a fluorine atom in at least part of the surface. The graphene compound includes hydrogen or a functional group containing hydrogen. The graphene compound closely clings to the plurality of particles containing silicon.

In the electrode described in either of the above, the particle containing silicon preferably includes a carbonate group, a hydrocarbonate group, a hydroxy group, an epoxy group, or a carboxyl group.

In the electrode described in any of the above, it is preferable that the particle containing silicon include a region where the particle surface is terminated with one or more of a functional group containing oxygen and carbon, a functional group containing oxygen and hydrogen, a functional group containing oxygen and lithium, and a hydrogen atom.

In the electrode described in any of the above, the particle containing silicon preferably contains oxygen, carbon, and lithium in at least part of a surface portion.

In the electrode described in any of the above, the particle containing silicon preferably contains amorphous silicon.

In the electrode described in any of the above, the particle containing silicon preferably contains polycrystalline silicon.

In the electrode described in any of the above, the graphene compound preferably has a hole.

In the electrode described in any of the above, it is preferable that the graphene compound include a plurality of carbon atoms and one or more hydrogen atoms, the one or more hydrogen atoms each terminate any one of the plurality of carbon atoms, and the vacancy be formed by the plurality of carbon atoms and the one or more hydrogen atoms.

One embodiment of the present invention is a secondary battery including the electrode described in any one of the above and an electrolyte.

One embodiment of the present invention is a moving vehicle including the secondary battery described in any one of the above.

One embodiment of the present invention is an electronic device including the secondary battery described in any of the above.

One embodiment of the present invention is a method for manufacturing a negative electrode active material, which includes a first step of mixing a particle containing silicon, lithium fluoride, a material containing halogen, and a material containing oxygen and carbon to form a first mixture and a second step of heating the first mixture. The heating in the second step is performed at a temperature higher than or equal to 350° C. and lower than or equal to 900° C. for a time longer than or equal to 1 hour and shorter than or equal to 60 hours. The heating in the second step is performed in a nitrogen atmosphere or a rare gas atmosphere.

One embodiment of the present invention is a method for manufacturing a negative electrode active material layer, which includes a first step of mixing the negative electrode active material manufactured by the above method for manufacturing a negative electrode active material, a graphene compound, and a solvent to form a first mixture; a second step of mixing the first mixture, a precursor of polyimide, and a solvent to form a second mixture; a third step of applying the second mixture to metal foil to form a first coating film; a fourth step of drying the first coating film to form a second coating film; and a fifth step of heating the second coating film. The heating in the fifth step is performed in a reduction atmosphere. The heating in the fifth step reduces the graphene compound and imidizes the precursor of polyimide.

One embodiment of the present invention is a method for manufacturing an electrode for a lithium-ion secondary battery, which includes a first step of mixing silicon and lithium carbonate to form a first mixture; a second step of heating the first mixture to obtain a particle containing silicon; a third step of mixing the particle containing silicon and a solvent to obtain a second mixture; a fourth step of mixing the second mixture and a graphene compound to form a third mixture; a fifth step of mixing the third mixture, a precursor of polyimide, and a solvent to form a fourth mixture; a sixth step of applying the fourth mixture to metal foil; a seventh step of drying the fourth mixture; and an eighth step of heating the fourth mixture to form an electrode. The heating in the eighth step is performed in a reduction atmosphere.

In the method for manufacturing an electrode for a lithium-ion secondary battery described in the above, the particle containing silicon preferably contains oxygen, carbon, and lithium in at least part of a surface portion.

In the method for manufacturing an electrode for a lithium-ion secondary battery described in any of the above, the particle containing silicon preferably contains amorphous silicon.

In the method for manufacturing an electrode for a lithium-ion secondary battery described in any of the above, the particle containing silicon preferably contains polycrystalline silicon.

### Effect of the Invention

According to one embodiment of the present invention, an electrode with excellent characteristics can be provided. According to one embodiment of the present invention, a novel electrode can be provided.

According to one embodiment of the present invention, a mechanically sturdy negative electrode can be provided. According to one embodiment of the present invention, a mechanically sturdy positive electrode can be provided. According to one embodiment of the present invention, a negative electrode having high capacity can be provided. According to one embodiment of the present invention, a positive electrode having high capacity can be provided. According to one embodiment of the present invention, a negative electrode with little deterioration can be provided. According to one embodiment of the present invention, a positive electrode with little deterioration can be provided.

According to one embodiment of the present invention, a secondary battery with little deterioration can be provided. According to one embodiment of the present invention, a highly safe secondary battery can be provided. According to one embodiment of the present invention, a secondary battery with high energy density can be provided. According to one embodiment of the present invention, a novel secondary battery can be provided.

Note that the description of these effects does not preclude the existence of other effects. One embodiment of the present invention does not need to have all the effects. Other effects will be apparent from and can be derived from the description of the specification, the drawings, the claims, and the like.

### BRIEF DESCRIPTION OF THE DRAWINGS

FIG. 1A to FIG. 1C are diagrams illustrating examples of cross sections of electrodes.

FIG. 2A to FIG. 2C illustrate examples for describing how much a graphene compound clings to a particle.

FIG. 3A and FIG. 3B are diagrams illustrating an example of a cross section of an electrode, and

FIG. 3C and FIG. 3D are diagrams each illustrating an example of a first region and a second region.

FIG. 4A to FIG. 4D are diagrams each illustrating an example of a cross section of a negative electrode active material.

FIG. 5A and FIG. 5B are diagrams regarding quantum molecular dynamics calculation.

FIG. 6 is a diagram regarding quantum molecular dynamics calculation.

FIG. 7A and FIG. 7B each illustrate an example of a model containing silicon.

FIG. 8 illustrates an example of a model containing silicon and a model of a graphene compound.

FIG. 9A and FIG. 9B each illustrate an example of a model containing silicon and a model of a graphene compound.

FIG. 10A and FIG. 10B each illustrate an example of a model containing silicon and a model of a graphene compound.

FIG. 11A and FIG. 11B each illustrate an example of a model of a graphene compound.

FIG. 12A and FIG. 12B illustrate an example of a model containing silicon and a model of a graphene compound.

FIG. 13A and FIG. 13B illustrate an example of a model containing silicon and a model of a graphene compound.

FIG. 14A and FIG. 14B each illustrate an example of a model containing silicon and a model of a graphene compound.

FIG. 15 is a diagram regarding dissipative particle dynamics calculation.

FIG. 16A and FIG. 16B illustrate an example of a model including a particle containing silicon and a graphene compound.

FIG. 17A and FIG. 17B illustrate an example of a model including a particle containing silicon and a graphene compound.

FIG. 18A and FIG. 18B are graphs regarding dissipative particle dynamics calculation.

FIG. 19 is a diagram showing an example of a manufacturing method of a negative electrode active material of one embodiment of the present invention.

FIG. 20 is a diagram showing an example of a manufacturing method of a negative electrode active material of one embodiment of the present invention.

FIG. 21 is a diagram showing an example of a manufacturing method of an electrode of one embodiment of the present invention.

FIG. 22 is a diagram illustrating the charge depth and crystal structures of a positive electrode active material of one embodiment of the present invention.

FIG. 23 shows XRD patterns calculated from crystal structures.

FIG. 24 is a diagram illustrating the charge depth and crystal structures of a positive electrode active material for a comparison example.

FIG. 25 shows XRD patterns calculated from crystal structures.

FIG. 26A and FIG. 26B are diagrams each showing a manufacturing method of a material.

FIG. 27 is an example of a cross-sectional view of a step of one embodiment of the present invention.

FIG. 28 is a diagram showing an example of a cross section of a secondary battery.

FIG. 29A is an exploded perspective view of a coin-type secondary battery, FIG. 29B is a perspective view of the coin-type secondary battery, and FIG. 29C is a cross-sectional perspective view thereof.

FIG. 30A and FIG. 30B are examples of a cylindrical secondary battery, FIG. 30C is an example of a plurality of cylindrical secondary batteries, and FIG. 30D is an example of a power storage system including a plurality of cylindrical secondary batteries.

FIG. 31A and FIG. 31B are diagrams for describing examples of a secondary battery, and FIG. 31C is a diagram illustrating the internal state of a secondary battery.

FIG. 32A, FIG. 32B, and FIG. 32C are diagrams for describing an example of a secondary battery.

FIG. 33A and FIG. 33B are external views of secondary batteries.

FIG. 34A, FIG. 34B, and FIG. 34C are diagrams illustrating a method for manufacturing a secondary battery.

FIG. 35A is a perspective view showing a battery pack, FIG. 35B is a block diagram of the battery pack, and FIG. 35C is a block diagram of a vehicle having a motor.

FIG. 36A to FIG. 36D are diagrams illustrating examples of transport vehicles. FIG. 36E is a diagram illustrating an example of an artificial satellite.

FIG. 37A and FIG. 37B are diagrams illustrating a power storage device.

FIG. 38A to FIG. 38D are diagrams illustrating examples of electronic devices.

FIG. 39A is a SEM observation image of a surface, and FIG. 39B is a SEM observation image of a cross section.

FIG. 40A and FIG. 40B are SEM images of a surface and a cross section of an electrode in Example 3.

FIG. 41A and FIG. 41B are enlarged SEM images of FIG. 40B.

FIG. 42A and FIG. 42B are graphs showing cycle performance.

### MODE FOR CARRYING OUT THE INVENTION

Embodiments of the present invention are described in detail below with reference to the drawings. Note that the present invention is not limited to the following descriptions, and it is readily understood by those skilled in the art that modes and details of the present invention can be modified in various ways. In addition, the present invention should not be construed as being limited to the descriptions of the embodiments below.

In the drawings, the size, the layer thickness, or the region is exaggerated for clarity in some cases. Therefore, they are not limited to the illustrated scale.

The ordinal numbers such as “first” and “second” in this specification and the like are used for convenience and do not denote the order of steps or the stacking order of layers. Therefore, for example, the term “first” can be replaced with the term “second”, “third”, or the like as appropriate. In addition, the ordinal numbers in this specification and the like do not sometimes correspond to the ordinal numbers that are used to specify one embodiment of the present invention.

### Embodiment 1

In this embodiment, an electrode, an active material, a conductive agent, and the like of one embodiment of the present invention are described.

### Example 1 of Electrode

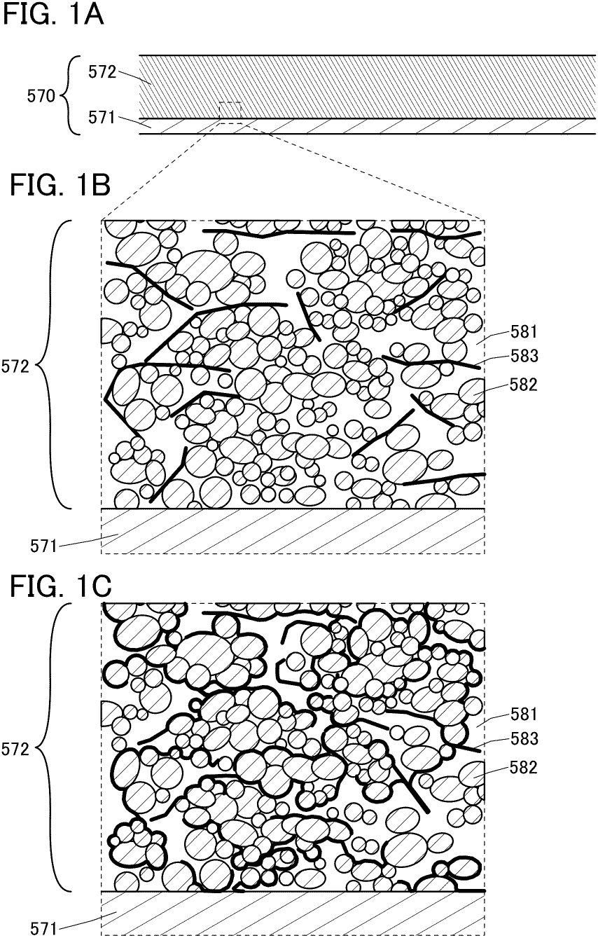

FIG. 1A is a cross-sectional schematic view illustrating an electrode of one embodiment of the present invention. An electrode 570 illustrated in FIG. 1A can be used as a positive electrode and/or a negative electrode included in a secondary battery. The electrode 570 includes at least a current collector 571 and an active material layer 572 formed in contact with the current collector 571. FIG. 1B and FIG. 1C are enlarged views of a region surrounded by a dashed line in FIG. 1A. The active material layer 572 includes an electrolyte 581, a particle 582, and a sheet-like material.

The particle 582 preferably functions as an active material. A material functioning as an active material can be used as the particle 582. The particle 582 preferably includes a material functioning as an active material, for example. The sheet-like material included in the electrode 570 preferably functions as a conductive agent, for example. In one embodiment of the present invention, the conductive agent can cling to the active material due to a hydrogen bond, whereby an electrode with high conductivity can be provided. As the particle 582, various materials can be used.

FIG. 1B and FIG. 1C illustrate an example in which a graphene compound 583 is used as the sheet-like material.

In the case where as the particle 582, a particle including fluorine or a functional group containing oxygen and carbon in a surface portion, or a particle including a region that is terminated with a fluorine atom or a functional group containing oxygen and carbon in the surface, which is a particle of one embodiment of the present invention, is used, affinity between the particle 582 and the graphene compound 583 is improved as illustrated in FIG. 1C, and the graphene compound 583 can be in contact with the particle 582 to closely cling to the particle 582 as illustrated in FIG. 1C. Since the graphene compound 583 can closely cling to the particle 582, an electrode with high conductivity can be formed. The state of being in contact to closely cling can be rephrased as the state of not being in point contact but being in contact to adhere. In addition, it can also be rephrased as the state of being in contact along the particle surface or the state of being in surface contact with a plurality of particles. A material that can be used for the particle 582 will be described later.

FIG. 1C is a schematic view of an active material layer including the graphene compound 583 as the sheet-like material, and, as the particle 582, a particle including fluorine or a functional group containing oxygen and carbon in a surface portion or a particle including a region that is terminated with a fluorine atom or a functional group containing oxygen and carbon in the surface, which is the particle of one embodiment of the present invention. With the use of the active material of one embodiment of the present invention as the particle 582, affinity with the graphene compound 583 can be improved, and the graphene compound 583 can be in contact with the active material to closely cling to the active material as illustrated in FIG. 1C.

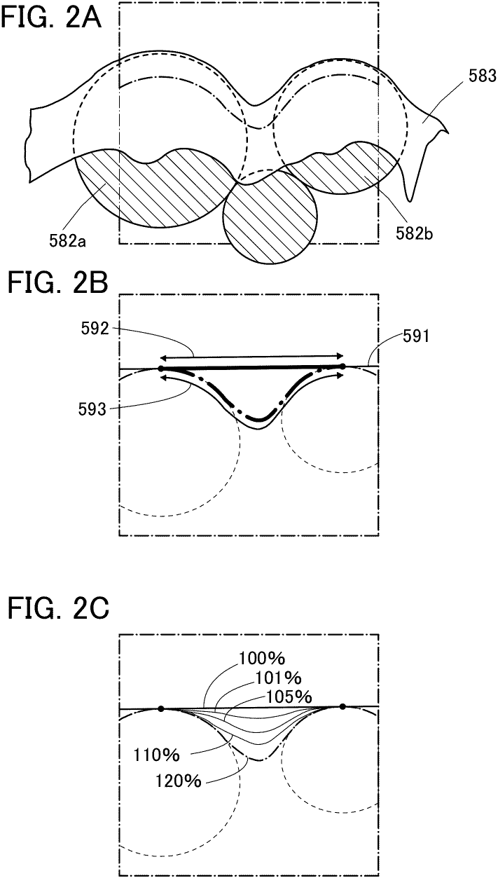

An example of the state of being in contact to closely cling is described with reference to FIG. 2. FIG. 2A is a schematic view illustrating two adjacent particles 582 and the graphene compound 583 in contact with the two particles 582, where a cross section being indicated by a dashed-dotted line and including the surface of the first particle 582a in contact with the graphene compound 583, the surface of the second particle 582b in contact with the graphene compound 583, and substantially center portions of the respective particles 582 is cut. FIG. 2B is a schematic view of the cross section indicated by the dashed-dotted line in FIG. 2A. In the schematic view of the cross section in FIG. 2B, on a first tangent 591 in contact with the surface of the first particle 582 and the surface of the second particle 582, a distance between a first point of contact between the first particle 582 and the first tangent 591 and a second point of contact between the second particle 582 and the first tangent 591 is a first distance 592, and a distance of a first portion of a cross-sectional curve of the graphene compound 583 in contact with the first point of contact and the second point of contact is a second distance 593. Here, the state of being in contact to cling is the case where the second distance 593 is longer than the first distance 592 in comparison between the first distance 592 and the second distance 593, and the first portion of the cross-sectional curve of the graphene compound 583 is located closer to the active material particle than the first tangent 591 is. Furthermore, the state of being in contact to closely cling is the case where the second distance 593 is 105 % or more when the first distance 592 is 100 %. The second distance 593 is preferably 101 % or more, further preferably 105 % or more, still further preferably 110 % or more when the first distance 592 is 100 %. FIG. 2C illustrates examples of the cases where the second distance 593 is 100 %, 101 %, 105 %, 110 %, and 120 % when the first distance 592 is 100 %.

When the graphene compound is in contact with the active material to cling to the active material, the area of contact between the graphene compound and the active material is increased and thus the conductivity of electrons transferring through the graphene compound is improved. Furthermore, in the case where the volume of the active material greatly changes due to charging and discharging, the graphene compound is in contact with the active material to cling to the active material, whereby the detachment of the active material can be effectively prevented. These effects can become more remarkable when the graphene compound is in contact with the active material to closely cling to the active material. Here, it is desirable that the graphene compound include a hole with a size through which a Li ion can pass and include many holes to the degree of not inhibiting the electron conductivity of the graphene compound.

The active material layer 572 preferably contains a carbon-based material such as a graphene compound, carbon black, graphite, carbon fiber, or fullerene, and especially a graphene compound is preferably contained. As the carbon black, acetylene black (AB) can be used, for example. As the graphite, natural graphite or artificial graphite such as mesocarbon microbeads can be used, for example. These carbon-based materials have high conductivity and can function as a conductive agent in the active material layer. These carbon-based materials may each function as an active material. FIG. 1B and FIG. 1C each show an example in which the active material layer 572 contains the graphene compound 583.

Examples of the carbon fiber include mesophase pitch-based carbon fiber and isotropic pitch-based carbon fiber. Other examples of the carbon fiber include carbon nanofiber and carbon nanotube. Carbon nanotube can be formed by, for example, a vapor deposition method.

The active material layer may contain, as a conductive agent, metal powder or metal fiber of copper, nickel, aluminum, silver, gold, or the like, a conductive ceramic material, or the like.

The content of the conductive agent to the total amount of the active material layer is preferably greater than or equal to 1 wt% and less than or equal to 10 wt%, further preferably greater than or equal to 1 wt% and less than or equal to 5 wt%.

Unlike a particulate conductive agent such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive agent. This can increase the proportion of the active material in the active material layer. Thus, discharge capacity of the secondary battery can be increased.

Furthermore, the graphene compound of one embodiment of the present invention has excellent permeability to lithium; therefore, the charging and discharging rate of the secondary battery can be increased.

A particulate carbon-containing compound such as carbon black or graphite and a fibrous carbon-containing compound such as carbon nanotube easily enter a microscopic space. A microscopic space means, for example, a region or the like between a plurality of active materials. When a carbon-containing compound that easily enters a microscopic space and a sheet-like carbon-containing compound, such as graphene, that can impart conductivity to a plurality of particles are used in combination, the density of the electrode is increased and an excellent conductive path can be formed. When the secondary battery includes an electrolyte of one embodiment of the present invention, the secondary battery can be operated more stably. That is, the secondary battery of one embodiment of the present invention can have both high energy density and stability, and is useful as an in-vehicle secondary battery. When a vehicle becomes heavier with an increasing number of secondary batteries, more energy is required to move the vehicle, which shortens the driving range. With the use of a high-density secondary battery, the driving range of the vehicle can be increased with almost no change in the total weight of a vehicle equipped with a secondary battery having the same weight.

Furthermore, an in-vehicle secondary battery with high capacity requires more power for charging, and charging is preferably ended in a short time. What is called a regenerative charging, in which electric power temporarily generated when the vehicle is braked is used for charging, is performed under high rate charging conditions; thus, a secondary battery for a vehicle is desired to have favorable rate characteristics.

In the active material layer 572 in each of FIG. 1B and FIG. 1C, a plurality of graphene compounds 583 are arranged in a three-dimensional net-like shape and the particles 582 are provided between the plurality of graphene compounds 583.

With the use of an electrolyte of one embodiment of the present invention, an in-vehicle secondary battery having a wide operation temperature range can be obtained.

In addition, the secondary battery of one embodiment of the present invention can be downsized owing to its high energy density, and can be charged fast owing to its high conductivity. Thus, the structure of the secondary battery of one embodiment of the present invention is useful also in a portable information terminal.

The active material layer 572 preferably includes a binder (not illustrated). The binder binds or fixes the electrolyte and the active material, for example. In addition, the binder can bind or fix the electrolyte and a carbon-based material, the active material and a carbon-based material, a plurality of active materials, a plurality of carbon-based materials, or the like.

As the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Polyimide has extremely excellent thermal, mechanical, and chemical stability. In the case of using polyimide as a binder, a dehydration reaction and a cyclization (imidizing) reaction are performed. These reactions can be performed by heat treatment, for example. In an electrode of one embodiment of the present invention, when graphene having a functional group containing oxygen and polyimide are used as the graphene compound and the binder, respectively, the graphene compound can also be reduced by the heat treatment, leading to simplification of the process. Because of high heat resistance, heat treatment can be performed at a heat temperature of 200° C. or higher. The heat treatment at a heat temperature of 200° C. or higher allows the graphene compound to be reduced sufficiently and the conductivity of the electrode to increase.

As the binder, a fluorine polymer which is a high molecular material containing fluorine, specifically, polyvinylidene fluoride (PVDF) or the like can be used. PVDF is a resin having a melting point in the range of higher than or equal to 134° C. and lower than or equal to 169° C., and is a material with excellent thermal stability.

As the binder, a rubber material such as styrene-butadiene rubber (SBR), styreneisoprene-styrene rubber, acrylonitrile-butadiene rubber, butadiene rubber, or ethylene-propylene-diene copolymer is preferably used. Alternatively, fluororubber can be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferred that such water-soluble polymers be used in combination with any of the above rubber materials.

Two or more of the above materials may be used in combination for the binder.

The graphene compound 583 is flexible and has a flexibility, and can cling to the particle 582, like natto (fermented soybeans). For example, the particle 582 and the graphene compound 583 can be likened to a soybean and a sticky ingredient, e.g., polyglutamic acid, respectively. By providing the graphene compound 583 as a bridge between materials included in the active material layer 572, such as the electrolyte, the plurality of active materials, and the plurality of carbon-based materials, it is possible to not only form an excellent conductive path in the active material layer 572 but also bind or fix the materials with the use of the graphene compound 583. In addition, for example, a three-dimensional net-like structure or an arrangement structure of polygons, e.g., a honeycomb structure in which hexagons are arranged in matrix, is formed using the plurality of graphene compounds 583 and materials such as the electrolyte, the plurality of active materials, and the plurality of carbon-based materials are placed in meshes, whereby the graphene compounds 583 form a three-dimensional conductive path and the detachment of an electrolyte from the current collector can be suppressed. In the arrangement structure of polygons, polygons with different number of sides may be intermingled. Thus, in the active material layer 572, the graphene compound 583 functions as a conductive agent and may also function as a binder.

The particle 582 can have any of various shapes such as a rounded shape and an angular shape. In addition, on the cross section of the electrode, the particle 582 can have any of various cross-sectional shapes such as a circle, an ellipse, a shape having a curved line, and a polygon. For example, FIG. 1B and FIG. 1C each illustrate an example in which the cross section of the particle 582 has a rounded shape as an example; however, the cross section of the particle 582 may be angular, for example. Alternatively, one part may be rounded and another part may be angular.

### Example 2 of Electrode

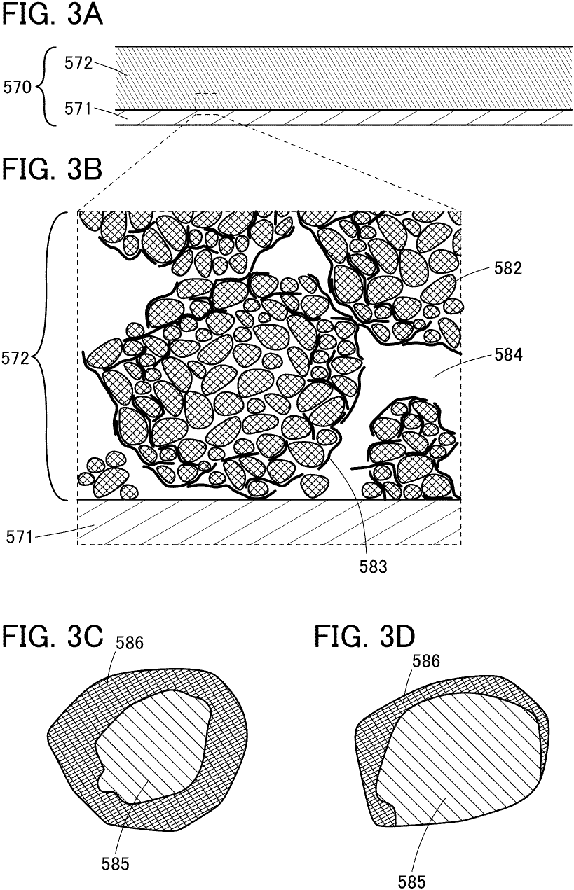

FIG. 3A is a cross-sectional schematic view illustrating an electrode of one embodiment of the present invention. The electrode 570 illustrated in FIG. 3A can be used as a positive electrode and/or a negative electrode included in a secondary battery. The electrode 570 includes at least the current collector 571 and the active material layer 572 formed in contact with the current collector 571.

FIG. 3B is an enlarged view of a region surrounded by a dashed line in FIG. 3A. FIG. 3B illustrates an embodiment of a structure in which a sheet-like material is in contact with a particle to cling to the particle.

As illustrated in FIG. 3B, the active material layer 572 includes the particle 582, the graphene compound 583 as the sheet-like material, and an electrolyte 584. A material that can be used for the particle 582 will be described later. FIG. 3C and FIG. 3D illustrate a first region 585 where the particles 582 aggregate and a second region 586 including the particles 582 and the sheet-like material. The particle 582 preferably functions as an active material. A material that functions as an active material can be used for the particle 582. The graphene compound 583 included in the active material layer 572 preferably functions as a conductive agent, for example. In one embodiment of the present invention, the conductive agent can cling to the active material due to a hydrogen bond, so that an electrode with high conductivity can be formed. For the particle 582, a variety of materials can be used. In the case where, as the particle 582, a particle including a functional group containing oxygen in a surface portion, a particle including a region that is terminated with a functional group containing oxygen in a surface portion, or a particle including a region containing oxygen and carbon in a surface portion, which is the particle of one embodiment of the present invention, is used, affinity between the particle 582 and the graphene compound 583 is improved as illustrated in FIG. 3B, and the graphene compound 583 can be in contact with the particle 582 to cover, wrap, or cling to the particle 582 as illustrated in FIG. 3B. Since the graphene compound 583 can cling to the particle 582, an electrode with high conductivity can be formed. The state of being in contact to cling can be rephrased as the state of not being in point contact but being in contact to adhere. Alternatively, it can be rephrased as the state of being in contact along the particle surface. Further alternatively, it can be rephrased as the state of being in surface contact with a plurality of particles. In the case where, as the particle 582, a particle including a functional group containing oxygen in a surface portion, a particle including a region that is terminated with a functional group containing oxygen in a surface portion, or a particle including a region containing oxygen and carbon in a surface portion is used, affinity between the particles 582 is improved and a region where the plurality of particles 582 aggregate can be formed as illustrated in FIG. 3B. The active material layer 572 can include the first region 585 where the particles 582 aggregate and the second region 586 including the particles 582 and the graphene compound 583, and can include a composite particle including the first region 585 and the second region 586 as illustrated in FIG. 3C and FIG. 3D. In the composite particle, the second region 586 is preferably in contact with at least part of the first region 585, and the second region 586 is further preferably in contact with at least part of the first region 585 to cover the part. Furthermore, the second regions 586 of two or more adjacent composite particles are preferably in contact with each other, and the second regions 586 of the respective composite particles further preferably include a bonded portion(s). Note that the active material layer 572 may include the first region 585 that does not form a composite particle and the second region 586 that does not form a composite particle.

The active material layer 572 can include a carbon-based material such as carbon black, graphite, carbon fiber, or fullerene in addition to the graphene compound. As the carbon black, acetylene black (AB) can be used, for example. As the graphite, natural graphite or artificial graphite such as mesocarbon microbeads can be used, for example. These carbon-based materials have high conductivity and can function as a conductive agent in the active material layer. These carbon-based materials may each function as an active material.

The above description can be referred to for the material that can be used as the carbon fiber.

The content of the conductive agent in the total solid content of active material layer is preferably greater than or equal to 0.5 wt% and less than or equal to 10 wt%, further preferably greater than or equal to 0.5 wt% and less than or equal to 5 wt%.

The active material layer 572 preferably includes a binder (not illustrated). The binder binds or fixes the electrolyte and the active material, for example. In addition, the binder can bind or fix the electrolyte and a carbon-based material, the active material and a carbon-based material, a plurality of active materials, a plurality of carbon-based materials, or the like. The material that can be used for the binder is as described above.

The graphene compound 583 is flexible and has a flexibility, and can cling to the particle 582, like natto (fermented soybeans). For example, the particle 582 and the graphene compound 583 can be likened to a soybean and a sticky ingredient, e.g., polyglutamic acid, respectively. By providing the graphene compound 583 as a bridge between materials included in the active material layer 572, such as the electrolyte, the plurality of active materials, and the plurality of carbon-based materials, it is possible to not only form an excellent conductive path in the active material layer 572 but also bind or fix the materials with the use of the graphene compound 583. In addition, for example, a three-dimensional net-like structure or an arrangement structure of polygons, e.g., a honeycomb structure in which hexagons are arranged in matrix, is formed using the plurality of graphene compounds 583 and materials such as the electrolyte, the plurality of active materials, and the plurality of carbon-based materials are placed in meshes, whereby the graphene compounds 583 form a three-dimensional conductive path and the detachment of an electrolyte from the current collector can be suppressed. In the arrangement structure of polygons, polygons with different number of sides may be intermingled. Thus, in the active material layer 572, the graphene compound 583 functions as a conductive agent and may also function as a binder.

The particle 582 can have any of various shapes such as a rounded shape and an angular shape. In addition, on the cross section of the electrode, the particle 582 can have any of various cross-sectional shapes such as a circle, an ellipse, a shape having a curved line, and a polygon. For example, FIG. 3B illustrates an example in which the cross section of the particle 582 has a rounded shape as an example; however, the cross section of the particle 582 may be angular, for example. Alternatively, one part may be rounded and another part may be angular.

### Graphene Compound

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring of carbon. The two-dimensional structure formed of the six-membered ring of carbon may be referred to as a carbon sheet. A graphene compound may include a functional group containing oxygen. The graphene compound is preferably bent. A graphene compound may be rounded like a carbon nanofiber.

In this specification and the like, for example, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring of carbon, for example. The reduced graphene oxide may also be referred to as a carbon sheet. Only one sheet of the reduced graphene oxide can function but may have a stacked structure of multiple sheets. The reduced graphene oxide preferably includes a portion where the carbon concentration is higher than 80 atomic% and the oxygen concentration is higher than or equal to 2 atomic% and lower than or equal to 15 atomic%. With such a carbon concentration and such an oxygen concentration, the reduced graphene oxide can function as a conductive agent with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive agent with high conductivity even with a small amount.

Reducing graphene oxide can form a vacancy in a graphene compound in some cases.

Furthermore, a material in which an end portion of graphene is terminated with fluorine may be used.

In the longitudinal cross section of the active material layer, the sheet-like graphene compounds are dispersed substantially uniformly in a region inside the active material layer. The plurality of graphene compounds are formed to partly cover the plurality of particulate active materials or adhere to the surfaces thereof, so that the graphene compounds make surface contact with the particulate active materials.

Here, the plurality of graphene compounds can be bonded to each other to form a net-like graphene compound sheet (hereinafter, referred to as a graphene compound net or a graphene net). A graphene net that covers the active material can function also as a binder for bonding the active materials. Accordingly, the amount of the binder can be reduced, or the binder does not have to be used. This can increase the proportion of the active material in the electrode volume and the electrode weight. That is to say, the charge and discharge capacity of the secondary battery can be increased.

Here, preferably, graphene oxide is used as the graphene compound and mixed with an active material to form a layer to be the active material layer, and then reduction is performed. In other words, the formed active material layer preferably contains reduced graphene oxide. When graphene oxide with extremely high dispersibility in a polar solvent is used to form the graphene compounds, the graphene compounds can be substantially uniformly dispersed in a region inside the active material layer. The solvent is removed by volatilization from a dispersion medium containing the uniformly dispersed graphene oxide to reduce the graphene oxide; hence, the graphene compounds remaining in the active material layer partly overlap with each other and are dispersed such that surface contact is made, thereby forming a three-dimensional conductive path. Note that graphene oxide can be reduced by heat treatment or with the use of a reducing agent, for example.

It is possible to form, with a spray dry apparatus, a graphene compound serving as a conductive agent as a coating film to cover the entire surface of the active material in advance and to electrically connect the active materials by the graphene compound to form a conductive path.

A material used in formation of the graphene compound may be mixed with the graphene compound to be used for the active material layer. For example, particles used as a catalyst in formation of the graphene compound may be mixed with the graphene compound. As an example of the catalyst in formation of the graphene compound, particles containing any of silicon oxide (SiO₂ or SiOₓ (x < 2)), aluminum oxide, iron, nickel, ruthenium, iridium, platinum, copper, germanium, and the like can be given. The D50 of the particles is preferably less than or equal to 1 µm, further preferably less than or equal to 100 nm.

A graphene compound of one embodiment of the present invention preferably includes a vacancy in part of a carbon sheet. In the graphene compound of one embodiment of the present invention, a vacancy through which carrier ions such as lithium ions can pass is provided in part of a carbon sheet, which can facilitate insertion and extraction of carrier ions in the surface of an active material covered with the graphene compound to increase the rate characteristics of a secondary battery. The hole provided in part of the carbon sheet is referred to as a vacancy, a defect, or a gap in some cases.

A graphene compound of one embodiment of the present invention preferably includes a hole formed by a plurality of carbon atoms and one or more fluorine atoms. Furthermore, the plurality of carbon atoms are preferably bonded to each other in a ring and one or more of the plurality of carbon atoms bonded to each other in a ring are preferably terminated with fluorine. Fluorine has high electronegativity and is easily negatively charged. Approach of positively charged lithium ions causes interaction, whereby energy is stable and the barrier energy in passage of lithium ions through the hole can be lowered. Thus, fluorine forming the hole in a graphene compound allows a lithium ion to easily pass through even a small hole; therefore, the graphene compound can have excellent conductivity.

### <Example of Negative Electrode Active Material>

In the case where the electrode 570 is a negative electrode, a particle containing a negative electrode active material can be used as the particle 582. As the negative electrode active material, a material that can react with carrier ions of the secondary battery, a material into and from which carrier ions can be inserted and extracted, a material that enables an alloying reaction with a metal serving as a carrier ion, a material that enables melting and precipitation of a metal serving as a carrier ion, or the like is preferably used.

An example of the negative electrode active material is described below.

Silicon can be used as the negative electrode active material. In the electrode 570, a particle containing silicon is preferably used as the particle 582. The particle containing silicon preferably contains amorphous silicon. Alternatively, the particle containing silicon preferably contains polycrystalline silicon. The particle containing silicon preferably contains amorphous silicon and polycrystalline silicon.

Alternatively, the particle 582 included in the electrode 570 further preferably includes a region that is terminated with one or more of a functional group containing oxygen and carbon, a functional group containing oxygen and hydrogen, a functional group containing oxygen and lithium, and a hydrogen atom.

Alternatively, the particle 582 included in the electrode 570 further preferably includes a region containing oxygen, carbon, and lithium in at least part of the surface portion of the particle 582. For example, in the case where the surface portion of each of the particles 582 includes a region containing oxygen, carbon, and lithium, the particles 582 easily aggregate and the sheet-like graphene compound 583 easily clings to the particles 582 in some cases.

In addition, a metal or a compound containing one or more elements selected from tin, gallium, aluminum, germanium, lead, antimony, bismuth, silver, zinc, cadmium, and indium can be used as the negative electrode active material contained in the particle 582. Examples of an alloy-based compound using such elements include Mg₂Si, Mg₂Ge, Mg₂Sn, SnS₂, V₂Sn₃, FeSn₂, CoSn₂, Ni₃Sn₂, C_{U6}Sn₅, Ag₃Sn, Ag₃Sb, Ni₂MnSb, CeSb₃, LaSn₃, La₃Co₂Sn₇, CoSb₃, InSb, and SbSn.

An element such as nitrogen, phosphorus, arsenic, boron, aluminum, or gallium may be added to silicon so that a material with lowered resistance may be used. The concentration of the added element is preferably higher than or equal to 10¹⁸ atoms/cm³ and lower than or equal to 10²² atoms/cm³. The concentration of nitrogen, phosphorus, or boron is preferably higher than or equal to 10¹⁸ atoms/cm³ and lower than or equal to 10²² atoms/cm³. The concentration of the added element can be analyzed by an analysis method such as secondary ion mass spectrometry (SIMS) or X-ray photoelectron spectroscopy (XPS). The added element can be introduced to silicon by an ion implantation method or a thermal diffusion method. Nitrogen, phosphorus, or boron is preferably introduced to silicon by a thermal diffusion method. For example, at least boron can be diffused into silicon by a thermal diffusion method using boron nitride (BN). A thermal diffusion method can be performed at a temperature higher than or equal to 600° C. and lower than or equal to 1200° C.

Nanosilicon can be used for the particle 582, for example. The average diameter of nanosilicon is, for example, preferably greater than or equal to 5 nm and less than 1 µm, further preferably greater than or equal to 10 nm and less than or equal to 300 nm, still further preferably greater than or equal to 10 nm and less than or equal to 100 nm.

Nanosilicon may have a spherical shape, a flat spherical shape, or a cuboid shape with rounded corners. As the size of nanosilicon, for example, D50 of laser diffraction particle size distribution measurement is preferably greater than or equal to 5 nm and less than 1 µm, further preferably greater than or equal to 10 nm and less than or equal to 300 nm, still further preferably greater than or equal to 10 nm and less than or equal to 100 nm.

Here, D50 is a particle diameter when the cumulative volume of a particle size distribution curve accounts for 50 % in a measurement result of the particle size distribution, i.e., a median. The measurement of the size of a particle is not limited to laser diffraction particle size distribution measurement; in the case where the size of a particle is less than or equal to the lower measurement limit of laser diffraction particle size distribution measurement, the major axis of a particle cross section may be measured by analysis with a SEM (scanning electron microscope), a TEM (transmission electron microscope), or the like.

Nanosilicon may have crystallinity. Nanosilicon may include a region with crystallinity and an amorphous region.

As a material containing silicon, a material represented by SiOₓ (x is preferably less than 2, further preferably greater than or equal to 0.5 and less than or equal to 1.6) can be used, for example.

A material containing silicon, which has a plurality of crystal grains in a single particle, for example, can be used. For example, a configuration where a single particle includes one or more silicon crystal grains can be used. The single particle may also include silicon oxide around the silicon crystal grain(s). The silicon oxide may be amorphous. A particle in which a graphene compound clings to a secondary particle of silicon may be used.

As the material containing silicon, Li₂SiO₃ and Li₄SiO₄ can be used, for example. Each of Li₂SiO₃ and Li₄SiO₄ may have crystallinity, or may be amorphous.

Analysis of the material containing silicon can be performed by NMR (Nuclear Magnetic Resonance), XRD (X-ray Diffraction), Raman spectroscopy, SEM, TEM, EDX (Energy dispersive X-ray spectroscopy), or the like.

In addition to the material containing silicon, a carbon-based material such as graphite, graphitizing carbon, non-graphitizing carbon, carbon nanotube, carbon black, or a graphene compound can be used for the electrode 570.

Furthermore, in addition to the material containing silicon, an oxide containing one or more elements selected from titanium, niobium, tungsten, and molybdenum can be used for the electrode 570.

In addition to the material containing silicon, an oxide such as SnO, SnO₂, titanium dioxide (TiO₂), lithium titanium oxide (Li₄Ti₅O₁₂),a lithium-graphite intercalation compound (LiₓC₆), niobium pentoxide (Nb₂O₅), tungsten oxide (WO₂), or molybdenum oxide (MoO₂) can be used for the electrode 570, for example.

In addition to the material containing silicon, a material that causes a conversion reaction can be used for the electrode 570. For example, a transition metal oxide that does not cause an alloying reaction with lithium, such as cobalt oxide (CoO), nickel oxide (NiO), or iron oxide (FeO), may be used for the particle 582. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides may be used as a positive electrode material because of its high potential.

In addition to the material containing silicon, the metal, the material, the compound, and the like mentioned above can be used in combination for the electrode 570.

A silicon material pre-doped with lithium may also be used. Examples of the pre-doping method include a method of mixing lithium fluoride, lithium carbonate, or the like with silicon and heating the mixture and a method of mechanical alloying a lithium metal and silicon. A secondary battery may be fabricated in the following manner: an electrode is formed; lithium doping is performed through charging and discharging reaction with a combination of the formed electrode and an electrode of a lithium metal or the like; and then the electrode subjected to doping is combined with a counter electrode (e.g., a positive electrode for a negative electrode subjected to pre-doping).

Furthermore, the active material of one embodiment of the present invention preferably contains fluorine in the surface portion, further preferably contains lithium, carbon, and oxygen in addition to fluorine. It is still further preferable to contain a carbonate group or a region that is terminated with a fluorine atom in the surface of the active material.

The charge and discharge efficiency of a secondary battery might decrease due to an irreversible reaction typified by a reaction between an electrode and an electrolyte. The charge and discharge efficiency might significantly decrease particularly in the initial charging and discharging.

In the case where the negative electrode active material containing halogen in the surface portion, which is one embodiment of the present invention, is used, a decrease in charge and discharge efficiency can be suppressed. It is considered that when the negative electrode active material of one embodiment of the present invention contains halogen in its surface portion, a reaction with an electrolyte at the surface of the active material is suppressed. In addition, at least part of the surface of the negative electrode active material of one embodiment of the present invention is covered with a region containing halogen in some cases. The region may have a film shape, for example. It is preferable to contain a carbonate group or a region that is terminated with a halogen atom in the surface of the active material.

A surface portion is preferably a region that is less than or equal to 50 nm, preferably less than or equal to 35 nm, further preferably less than or equal to 20 nm from the surface, for example. In addition, a region in a deeper position than a surface portion is referred to as an inner portion.

The surface portion of the negative electrode active material of one embodiment of the present invention contains halogen, whereby a secondary battery can achieve excellent performance even at high charge and discharge rates. Thus, the charge and discharge speeds can be increased. In the case where the negative electrode active material contains graphite in the inner portion and halogen in the surface portion, halogen or a halogen compound is inserted between layers of graphite in some cases. The insertion of halogen or a halogen compound between the layers expands the interlayer distance at a surface of graphite or in the vicinity of the surface, whereby the insertion and extraction of carrier ions between the layers is facilitated. This leads to a possibility that a secondary battery achieves excellent performance at high charge and discharge rates. The interlayer distance of graphite can be analyzed through XRD, observation with a transmission electron microscope, EDX, or the like.

The negative electrode active material of one embodiment of the present invention contains halogen, lithium, and oxygen in the surface portion, whereby a secondary battery can achieve excellent performance even at high charge and discharge rates. Thus, the charge and discharge speeds can be increased. When the negative electrode active material contains silicon in the inner portion and halogen in the surface portion, a compound containing silicon, halogen, lithium, and oxygen can be formed in the surface portion. When the compound containing silicon, halogen, lithium, and oxygen is formed in the surface portion, the diffusibility of carrier ions is improved, and thus a secondary battery can probably achieve excellent performance at high charge and discharge rates.

Furthermore, when the negative electrode active material of one embodiment of the present invention contains halogen in the surface portion, there is a possibility that a solvent that solvates a carrier ion in an electrolyte is likely to be extracted at the surface of the negative electrode active material. When the solvent that solvates a carrier ion is likely to be extracted, there is a possibility that a secondary battery can achieve excellent performance at high charge and discharge rates.

It is particularly preferable that the negative electrode active material of one embodiment of the present invention contain fluorine as halogen.

The compound containing lithium, silicon, and oxygen further contains fluorine in some cases. A compound containing lithium, silicon, oxygen, and fluorine may be a composite oxide represented by a general formula LiₓSi(₁₋ₓ)O(_{2-y})F_{y}, for example.

When the negative electrode active material of one embodiment of the present invention includes a region that is terminated with a functional group containing oxygen and carbon or a fluorine atom in the surface, affinity between the negative electrode active material and the graphene compound is improved and thus the graphene compound can be in contact with the negative electrode active material to closely cling to the negative electrode active material. Since the conductive agent can closely cling to the active material, an electrode having high conductivity can be formed. The state of being in contact to closely cling can be rephrased as the state of being in contact to adhere. Furthermore, the state of being in contact to closely cling can also be rephrased as the state of being in contact along the particle surface or the state of being in surface contact with a plurality of particles.

Fluorine has high electronegativity, and the negative electrode active material containing fluorine in the surface portion may have an effect of facilitating extraction of the solvating solvent at the surface of the negative electrode active material.

The volume of the particle 582 sometimes changes in charging and discharging; however, an electrolyte containing fluorine between the plurality of particles 582 in the negative electrode maintains smoothness and suppresses a crack even when the volume changes in charging and discharging, so that an effect of dramatically increasing cycle performance is obtained. It is important that an organic compound containing fluorine exists between a plurality of active materials included in an electrode.

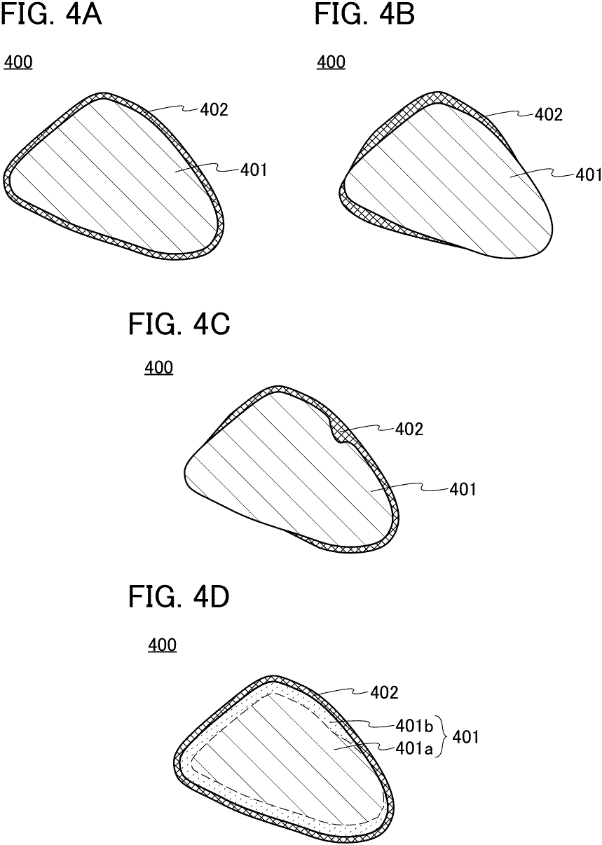

FIG. 4A, FIG. 4B, FIG. 4C, and FIG. 4D each illustrate an example of a cross section of a negative electrode active material 400. The negative electrode active material 400 can be used as the particle 582.

The cross section of the negative electrode active material 400 is exposed by processing, whereby observation and analysis of the cross section can be performed.

The negative electrode active material 400 illustrated in FIG. 4A includes a region 401 and a region 402. The region 402 is positioned on an outer side of the region 401. The region 402 is preferably in contact with the surface of the region 401.

At least part of the region 402 preferably includes the surface of the negative electrode active material 400.

The region 401 is, for example, a region including an inner portion of the negative electrode active material 400.

The region 401 contains a first material 801. The region 402 is a region formed using a material 802 containing halogen and a material 803 containing oxygen and carbon. The region 402 contains halogen, oxygen, carbon, a metal A1, and a metal A2, for example. Halogen is fluorine, chlorine, or the like, for example. The region 402 does not contain some of elements of halogen, oxygen, carbon, the metal A1, and the metal A2, in some cases. Alternatively, in the region 402, some of the elements of halogen, oxygen, carbon, the metal A1, and the metal A2 have a low concentration and thus are not detected by analysis in some cases.

As the metal A1, one or more elements selected from lithium, magnesium, aluminum, sodium, potassium, calcium, barium, lanthanum, cerium, chromium, manganese, iron, cobalt, nickel, zinc, zirconium, titanium, vanadium, and niobium can be used, for example. As the metal A2, one or more elements selected from lithium, magnesium, aluminum, sodium, potassium, calcium, barium, lanthanum, cerium, chromium, manganese, iron, cobalt, and nickel can be used, for example.

The region 402 is called a surface portion of the negative electrode active material 400 or the like, in some case.

The negative electrode active material 400 can have a variety of forms such as one particle, a group of a plurality of particles, and a thin film.

The region 401 may be a particle of the first material 801. Alternatively, the region 401 may be a group of a plurality of particles of the first material 801. Alternatively, the region 401 may be a thin film of the first material 801.

The region 402 may be part of a particle. For example, the region 402 may be a surface portion of the particle. Alternatively, the region 402 may be part of a thin film. For example, the region 402 may be an upper layer portion of a thin film.

The region 402 may be a coating layer formed on the surface of the particle.

The region 402 may be a region including a bond of a constituent element of the first material 801 and halogen. For example, in the region 402 or the interface between the region 401 and the region 402, the surface of the first material 801 may be modified with halogen or a functional group containing halogen. Thus, in the negative electrode active material of one embodiment of the present invention, the bond of a constituent element of the first material 801 and halogen is observed in some cases. As an example, in the case where the first material 801 is graphite and halogen is fluorine, a C-F bond is, for example, observed in some cases. As another example, in the case where the first material 801 contains silicon and halogen is fluorine, a Si-F bond is, for example, observed in some cases.

As an example where the first material 801 contains silicon and halogen is fluorine, a composite oxide represented by a general formula LiₓSi(₁₋ₓ₎O(_{2-y})F_{y} may be used as the compound containing lithium, silicon, oxygen, and fluorine, for example.

When the first material 801 contains silicon and lithium carbonate is used as the material 803 containing oxygen and carbon, the region 402 includes a carbonate group in some cases.

For example, in the case where silicon is used as the first material 801, the region 401 is a particle of silicon, and the region 402 is a coating layer of the silicon particle. As another example, in the case where silicon is used as the first material 801, the region 401 is a region including an inner portion of a silicon particle, and the region 402 is a surface portion of the silicon particle.

The region 402 includes, for example, a bond of halogen and carbon. The region 402 includes, for example, a bond of halogen and the metal A1. The region 402 includes, for example, a carbonate group.

In the example illustrated in FIG. 4B, the region 401 includes a region not covered with the region 402. In the example illustrated in FIG. 4C, the region 402 covering a region depressed at the surface of the region 401 has a large thickness.

In the negative electrode active material 400 illustrated in FIG. 4D, the region 401 includes a region 401a and a region 401b. The region 401a is a region including the inner portion of the region 401, and the region 401b is positioned on an outer side of the region 401a. In addition, the region 401b is preferably in contact with the region 402.

The region 401b is a surface portion of the region 401.

The region 401b contains one or more elements of halogen, oxygen, carbon, the metal A1, and the metal A2 contained in the region 402. In the region 401b, the elements contained in the region 402, such as halogen, oxygen, carbon, the metal A1, and the metal A2, may have a concentration gradient such that the element concentration decreases gradually from the surface or the vicinity of the surface to the inner portion.

The concentration of halogen contained in the region 401b is higher than the concentration of halogen contained in the region 401a. The concentration of halogen contained in the region 401b is preferably lower than the concentration of halogen contained in the region 402.

The concentration of oxygen contained in the region 401b is higher than the concentration of oxygen contained in the region 401a in some cases. The concentration of oxygen contained in the region 401b is lower than the concentration of oxygen contained in the region 402 in some cases.

Although not illustrated, the surface portion of the negative electrode active material 400 contains one or both of the material 802 containing halogen and the material 803 containing oxygen and carbon in some cases.

When the negative electrode active material of one embodiment of the present invention is subjected to measurement by energy dispersive X-ray spectroscopy (EDX) with a scanning electron microscope (SEM), it is preferable that halogen be detected. For example, assuming that the total of the halogen and oxygen concentrations is 100 atomic%, a region having a halogen concentration preferably higher than or equal to 0.6 atomic% and lower than or equal to 20 atomic%, further preferably higher than or equal to 4 atomic% and lower than or equal to 20 atomic% is preferably included.

The region 402 has a region whose thickness is smaller than or equal to 50 nm, preferably larger than or equal to 1 nm and smaller than or equal to 35 nm, further preferably larger than or equal to 5 nm and smaller than or equal to 20 nm, for example.

The region 401b has a region whose thickness is smaller than or equal to 50 nm, preferably larger than or equal to 1 nm and smaller than or equal to 35 nm, further preferably larger than or equal to 5 nm and smaller than or equal to 20 nm, for example.

In the case where fluorine is used as halogen and lithium is used as the metal A1 and the metal A2, the region 402 may include a region covered with a region containing lithium fluoride and a region covered with a region containing lithium carbonate, with respect to the region 401. The region 402 does not obstruct the insertion and extraction of lithium and accordingly enables an excellent secondary battery to be achieved without a degradation of output characteristics or the like of the secondary battery.

### Calculation 1

### Reaction in Annealing of Silicon, LiF, and Li₂CO₃

Next, results of examination using quantum molecular dynamics calculation relating to the surface of a particle containing silicon are described.

### Quantum Molecular Dynamics

A reaction of the surface of the particle containing silicon with lithium fluoride and lithium carbonate is examined by quantum molecular dynamics. Here, calculation is performed assuming that the surface of the particle containing silicon is SiO₂.

A first principle electronic state calculation package, VASP, is used for the atomic relaxation calculation. For other specific calculation conditions of the quantum molecular dynamics, the conditions shown in Table 1 are used.

[TABLE 1]

| Software | VASP |
|---|---|
| Functional | GGA+U (DFT-D2) |
| Pseudopotential | PAW |
| Cut-off energy (eV) | 600 |
| k-points | 1×1×1 |

First, a mixed phase of LiF and Li₂CO₃ is formed. Specifically, a structure in which LiF and Li₂CO₃ are positioned to be in contact with each other is prepared, and structure relaxation is performed at a temperature of 1200 K for 1 ps; thus, the mixed phase of LiF and Li₂CO₃ is formed.

Moreover, structure relaxation is performed at a temperature of 1200 K for 1 ps, and thus, a SiO₂ phase is formed.

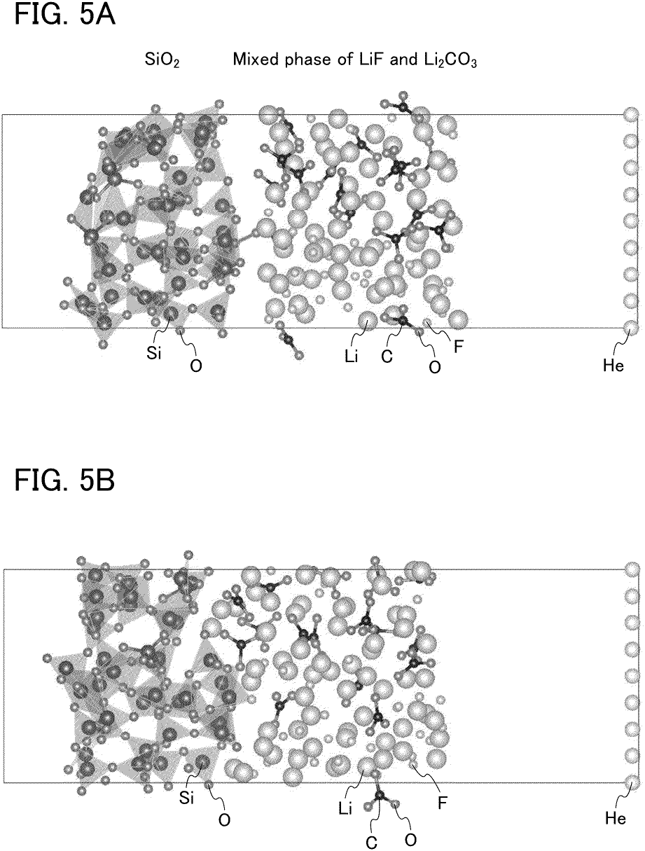

Next, a structure illustrated in FIG. 5A is prepared as an initial state. In the structure illustrated in FIG. 5A, the SiO₂ phase and the mixed phase of LiF and Li₂CO₃, on each of which structure relaxation has been performed, are positioned to be in contact with each other. Moreover, helium atoms are arranged and fixed in the vicinity of the periodic boundary to prevent a reaction from a region outside the periodic boundary. The structure illustrated in FIG. 5A includes 64 lithium atoms, 16 carbon atoms, 40 silicon atoms, 128 oxygen atoms, 32 fluorine atoms, and 24 helium atoms.

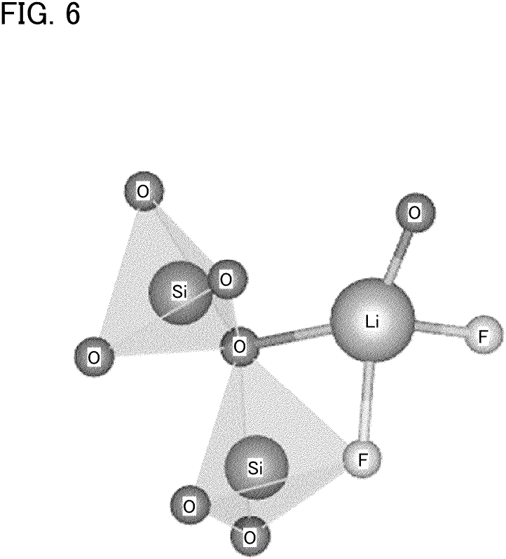

FIG. 5B illustrates a structure after the initial state illustrated in FIG. 5A is subjected to structure relaxation at 1200 K for 1.23 ps. Diffusion of lithium atoms and fluorine atoms of the mixed phase of LiF and Li₂CO₃ into the SiO₂ phase is observed. In addition, a bond of a silicon atom and a fluorine atom is observed. FIG. 6 illustrates an extracted part of the structure illustrated in FIG. 5B.

The quantum molecular dynamics calculation indicates that a compound containing lithium, silicon, oxygen, and fluorine is formed by the reaction of the surface of the particle containing silicon with lithium fluoride and lithium carbonate.

### Calculation 2

### Particle Containing Silicon and Graphene Compound

An interaction between a particle containing silicon and a graphene compound is optimized and evaluated by density functional theory (DFT). The calculation of optimization is performed using Gaussian 09. The main conditions of calculation are listed in Table 2.

[TABLE 2]

| Calculation program | Gaussian 09 |
|---|---|
| Functional | ω Β97ΧD |
| Basis function | 6-31G∗∗ |
| Charge | 0 |
| Spin multiplicity | 1 |

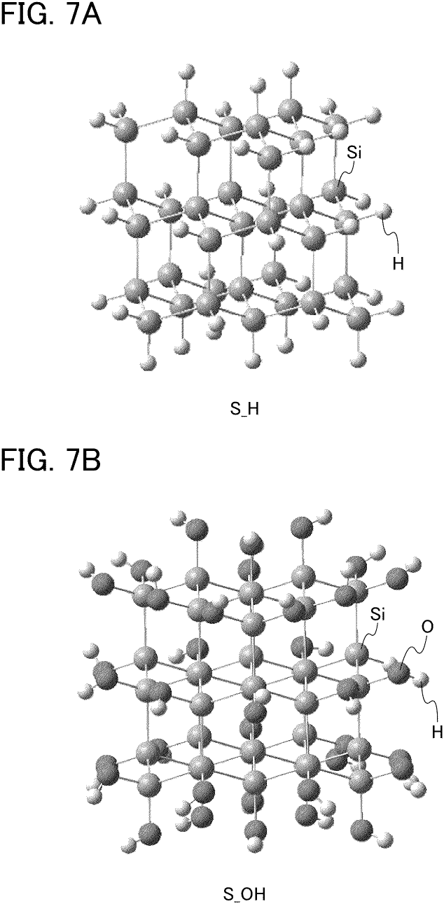

As the particle containing silicon, two kinds of Models, hydrogen-terminated silicon (Model S_H) and hydroxy group-terminated silicon (Model S_OH), are used. A structure composed of 35 silicon atoms and 35 hydrogen atoms illustrated in FIG. 7A is used as Model S_H. A structure composed of 35 silicon atoms, 35 oxygen atoms, and 35 hydrogen atoms illustrated in FIG. 7B is used as Model S_OH.

As graphene (Model G-1), a structure composed of 170 carbon atoms and 36 hydrogen atoms is used. All of the 36 hydrogen atoms terminate the end portions of the graphene.

Five models are used as graphene compounds, including graphene containing one carbon atom bonded to an epoxy group (Model G-2), graphene containing two carbon atoms bonded to hydroxy groups (Model G-3), graphene containing two hydrogen-terminated carbon atoms (Model G-4), and graphene containing two fluorine-terminated carbon atoms (Model G-5). In each model, carbon terminated with a functional group or an atom is placed near the center.

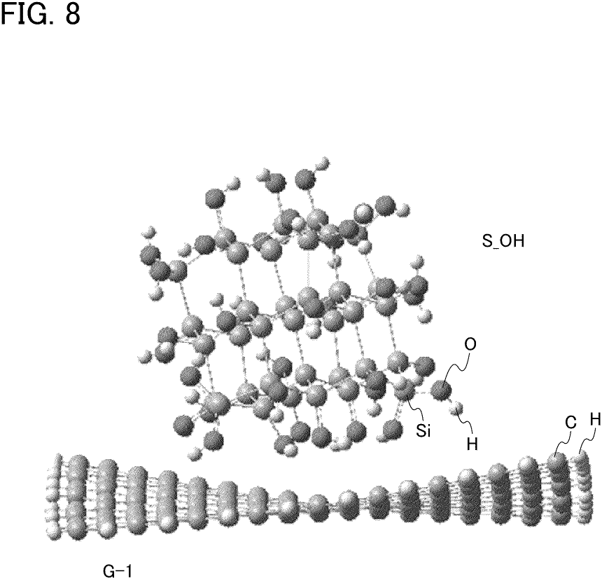

FIG. 8 illustrates an example of an interaction between the particle containing silicon and the graphene compound after the optimization. It is shown that the particle containing silicon comes close to the graphene compound in distance by the optimization. It is also shown that the graphene compound is curved. The curve of the graphene compound is considered to result from London dispersion force. Note that the state where the hydroxy group-terminated silicon (Model S_OH) and graphene (Model G-1) are close to each other is illustrated in FIG. 8.

Stabilization energy of each combination is calculated to evaluate the interaction between the particle containing silicon and the graphene compound. The results are shown in Table 3. The energy in the case where the particle containing silicon and the graphene compound are arranged at infinity is a reference, and an absolute value of the difference from the reference is regarded as stabilization energy. Higher value of the stabilization energy in Table 3 and Table 4 to be shown later show higher stability.

TABLE 3

[eV]

| | | |
|---|---|---|
| S_OH | G-1 | 1.52 |
| | G-2 ( —O— ) | 1.74 |
| | G-3 ( —OH ) | 1.66 |
| | G-4 ( -H ) | 1.62 |
| | G-5 ( —F ) | 1.76 |
| S_H | G-1 | 1.38 |
| | G-4 ( —H ) | 1.33 |

As shown in Table 3, the stabilization energy of the hydroxy group-terminated silicon (Model S_OH) is higher than that of the hydrogen-terminated silicon (Model S_H). Moreover, the stabilization energy of each of the graphene compounds containing carbon bonded to a functional group, a hydrogen atom, or a fluorine atom in a two-dimensional structure formed of a six-membered ring of carbon (Models G-2 to G-5) is higher than that of the graphene (Model G-1).

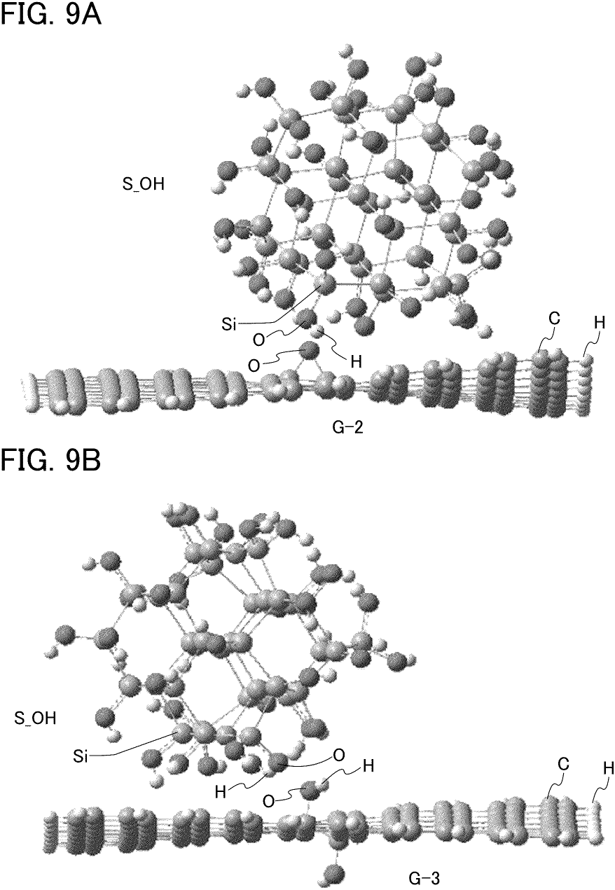

FIG. 9A illustrates the state where the hydroxy group-terminated silicon (Model S_OH) is brought close to the graphene containing carbon bonded to an epoxy group (Model G-2). This suggests that a hydrogen bond is formed between oxygen contained in the epoxy group and the hydroxy group in the silicon surface.

FIG. 9B illustrates the state where the hydroxy group-terminated silicon (Model S_OH) is brought close to the graphene containing carbon bonded to a hydroxy group (Model G-3). This suggests that a hydrogen bond is formed between the hydroxy groups of the both.

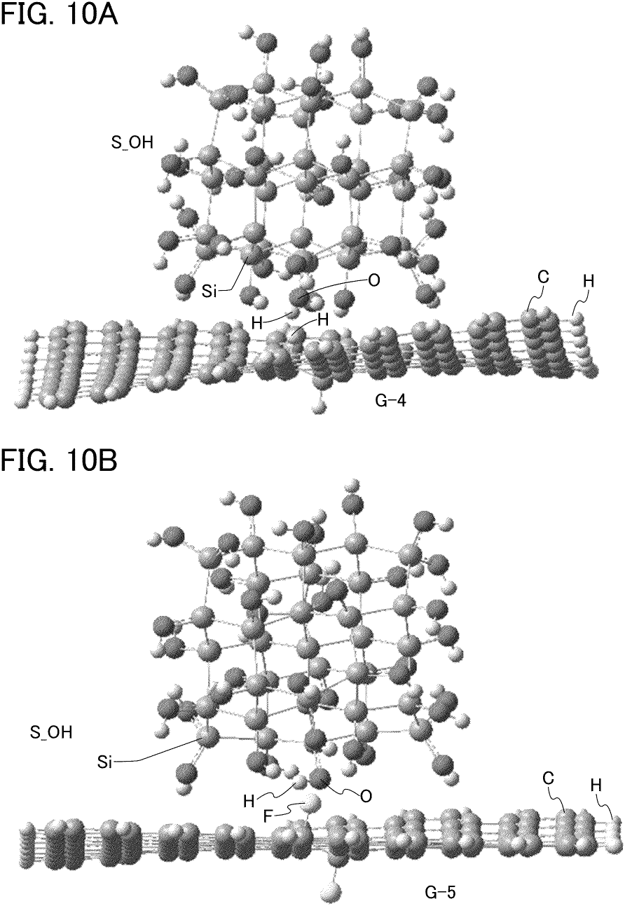

FIG. 10A illustrates the state where the hydroxy group-terminated silicon (Model S_ OH) is brought close to the graphene containing carbon terminated with a hydrogen atom (Model G-4). This suggests that a hydrogen bond is formed between the hydrogen atom contained in the graphene and the hydroxy group in the silicon surface.

FIG. 10B illustrates the state where the hydroxy group-terminated silicon (Model S_ OH) is brought close to the graphene containing carbon terminated with a fluorine atom (Model G-5). This suggests that a hydrogen bond is formed between the fluorine atom contained in the graphene and the hydroxy group in the silicon surface.

The silicon surface is terminated with a hydroxy group, so that a hydrogen bond with the graphene compound is probably formed, increasing the stabilization energy.

Next, a model of graphene having a hole is examined.

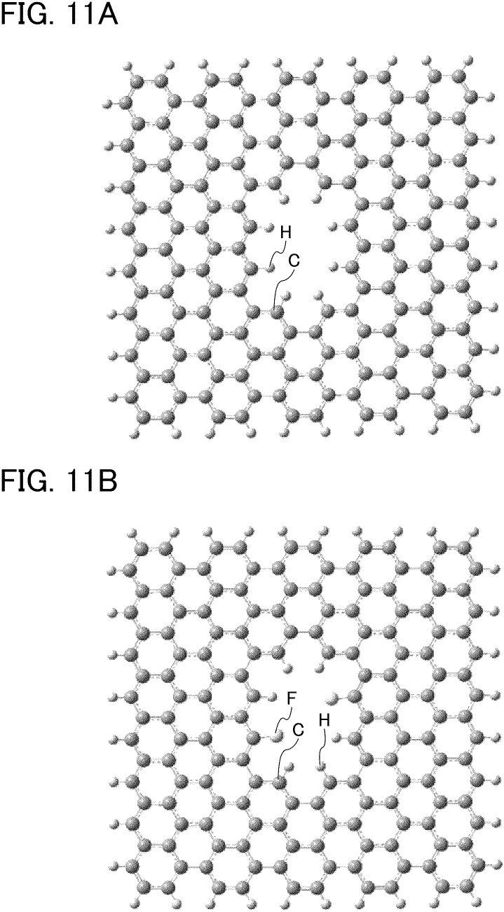

FIG. 11A and FIG. 11B each illustrate an example of a structure of a graphene compound having a hole.

A structure illustrated in FIG. 11A (hereinafter, Model G-22H8) has a 22-membered ring, and eight carbon atoms contained in the 22-membered ring are each terminated with hydrogen. Model G-22H8 has a structure in which two six-membered rings that are connected to each other are removed from graphene and carbon bonded to the removed six-membered rings is terminated with hydrogen.

A structure illustrated in FIG. 11B (hereinafter, Model G-22H6F2) has a 22-membered ring, and six carbon atoms of eight carbon atoms contained in the 22-membered ring are terminated with hydrogen, and two carbon atoms thereof are terminated with fluorine. Model G-22H6F2 has a structure in which two six-membered rings that are connected to each other are removed from graphene and carbon bonded to the removed six-membered rings is terminated with hydrogen or fluorine.

Stabilization energy of each combination of the particle containing silicon and the graphene compound having the hole is calculated. The results are shown in Table 4.

TABLE 4

[eV]

| | | |
|---|---|---|
| S_OH | G-22H8 | 1.94 |
| | G-22H6F2 | 2.05 |
| S_H | G-22H8 | 1.33 |
| | G-22H6F2 | 1.35 |

The hydroxy group-terminated silicon (Model S_OH) has a higher stabilization energy than the hydrogen-terminated silicon (Model S_H) as shown in Table 4, and it is suggested that the hydroxy group-terminated silicon (Model S_OH) has a larger interaction with the graphene compound having the hole than the hydrogen-terminated silicon (Model S_H).

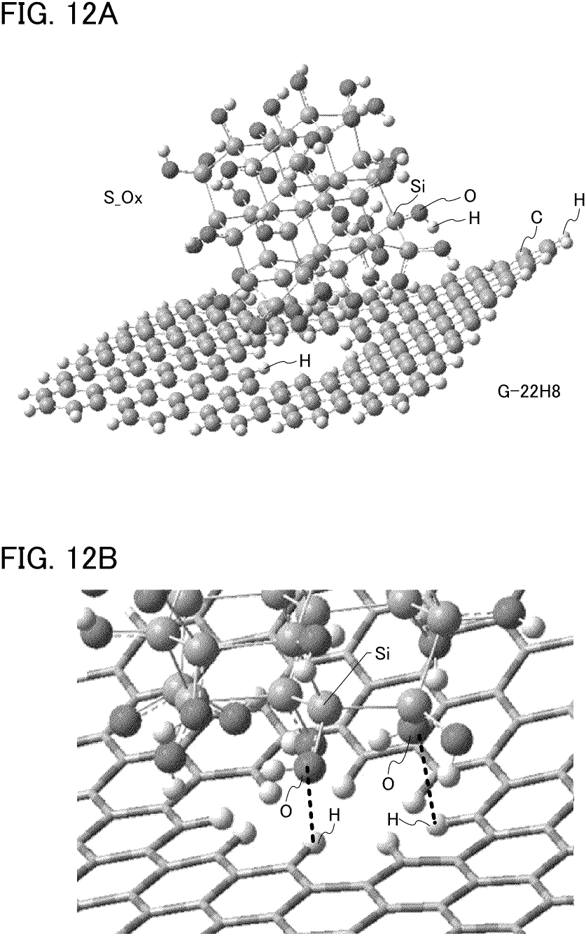

FIG. 12A illustrates the state where the hydroxy group-terminated silicon (Model S_OH) and Model G-22H8 are brought closer together. FIG. 12B is an enlarged view including a region where the hydroxy group-terminated silicon (Model S_ OH) and Model G-22H8 are brought closer together. As shown by dashed lines in FIG. 12B, it is suggested that a hydrogen bond is formed between the hydrogen atom contained in the graphene and the hydroxy group in the silicon surface.

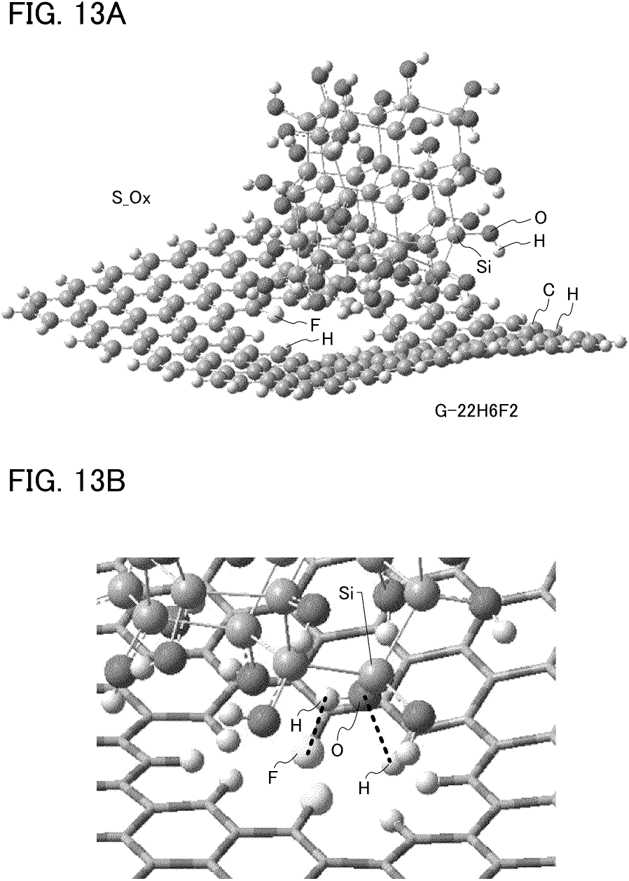

FIG. 13A illustrates the state where the hydroxy group-terminated silicon (Model S_OH) and Model G-22H6F2 are brought closer together. FIG. 13B is an enlarged view including a region where the hydroxy group-terminated silicon (Model S_OH) and Model G-22H6F2 are brought closer together. As shown by dashed lines in FIG. 13B, it is suggested that a hydrogen bond is formed between the hydrogen atom contained in the graphene and oxygen of the hydroxy group in the silicon surface. It is also suggested that a hydrogen bond is formed between the fluorine atom contained in the graphene and hydrogen contained in the hydroxy group in the silicon surface.

It is suggested that, when the graphene compound contains fluorine as well as hydrogen, in addition to the hydrogen bond between the oxygen atom of the hydroxy group and the hydrogen atom of the graphene compound, the hydrogen bond between the hydrogen atom of the hydroxy group and the fluorine atom of the graphene compound is also formed, further strengthening the interaction between the particle containing silicon and the graphene compound and further increasing the stabilization energy.

On the other hand, as shown in Table 4, the hydrogen-terminated silicon (Model S_H) has a lower stabilization energy with each of two kinds of the graphene compounds having the hole than the hydroxy group-terminated silicon (Model S_OH).

It is considered that the silicon surface is terminated with a hydroxy group, and the graphene compound includes the hole terminated with hydrogen or fluorine, whereby a hydrogen bond is formed and the stabilization energy is increased.

Next, the interaction with the graphene compound in the case where the particle containing silicon is silicon oxide is calculated. As a model of the silicon oxide (hereinafter, Model S_Ox), a structure composed of 20 silicon atoms, 28 hydrogen atoms, and 54 oxygen atoms is used. A dangling bond at the end is terminated with a hydroxy group.

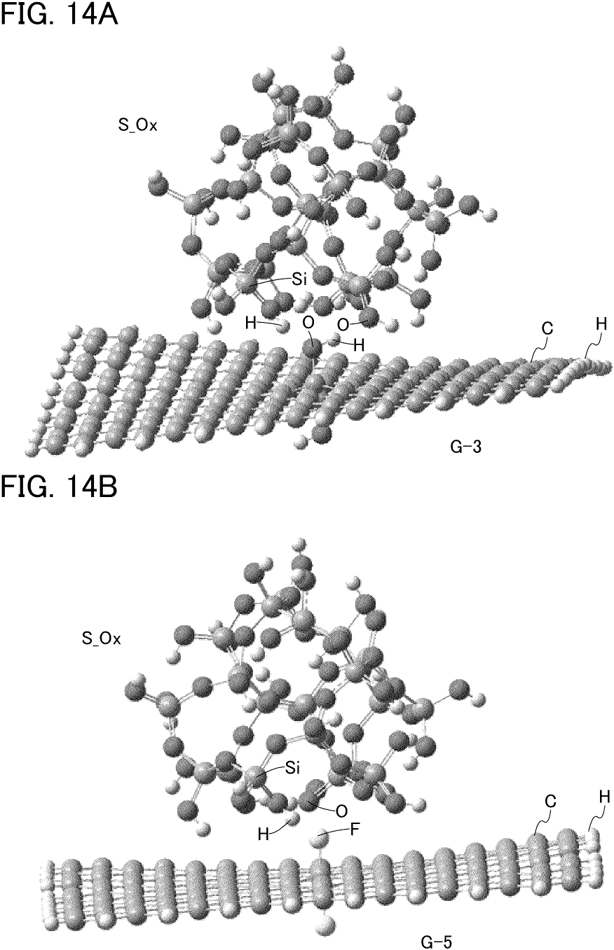

Table 5 shows the calculated results of the stabilization energy. FIG. 14A illustrates an optimization state of silicon oxide and the graphene containing carbon terminated with a hydroxy group (Model G-3), and FIG. 14B illustrates an optimization state of silicon oxide and the graphene containing carbon terminated with fluorine (Model G-5).

TABLE 5

[eV]

| | | |
|---|---|---|
| S_Ox | G-1 | 1.71 |
| | G-2 ( —O— ) | 2.04 |
| | G-3 ( —OH ) | 2.14 |
| | G-4 ( —H ) | 1.75 |
| | G-5 ( —F ) | 2.15 |
| | G-22H8 | 1.88 |
| | G-22H6F2 | 1.97 |

It is suggested that a bond becomes stronger also in silicon oxide that is terminated with a hydroxy group when the graphene compound includes a functional group or a hole.

For example, in the case where graphene has the hole, it is possible that a spectrum based on a feature caused by the hole is observed in Raman spectroscopic mapping measurement. Furthermore, it is possible that a bond, a functional group, and the like included in the hole are observed by ToF-SIMS. It is also possible that the vicinity, surrounding, and the like of the hole are observed in TEM observation.

### Calculation 3

### Interaction Between Graphene Compound and Particle Containing Silicon

Calculation results relating to an interaction between the graphene compound 583 and silicon including a region containing oxygen, carbon, and lithium are shown. Change in forms due to the interaction between the graphene compound 583 and the particle 582 is calculated by dissipative particle dynamics (DPD). For the calculation, HOOMD-blue (version 2.9.0) is used. A particle containing silicon is assumed as the particle 582. Table 6 shows parameters of the Lennard-Jones potentials for the particle included in the graphene compound 583 and the particle 582 containing silicon, which are used in the calculation. As for the calculation condition, attraction between the particle included in the graphene compound 583 and the particle 582 containing silicon, and attraction between the particle 582 containing silicon and the particle 582 containing silicon are set stronger in a calculation condition C-2 than in a calculation condition C-1. The calculation condition C-1 is a condition assuming silicon that has not been subjected to lithium carbonate treatment, and the calculation condition C-2 is a condition assuming silicon subjected to lithium carbonate treatment (silicon including a region containing oxygen, carbon, and lithium). Silicon subjected to lithium carbonate treatment is to be described later.

TABLE 6

Parameters ε of Lennard-Jones potentials

| Calculation condition | Graphene compound and Graphene compound | Graphene compound and Particle containing silicon | Particle containing silicon and Particle containing silicon |
|---|---|---|---|
| C-1 | 0.1 | 0.5 | 1.2 |
| C-2 | 0.1 | 0.7 | 2.2 |

* Parameters σ of Lennard-Jones potentials are each set to 1.0.
The diameters of all the particles in the models are set to 1.0.

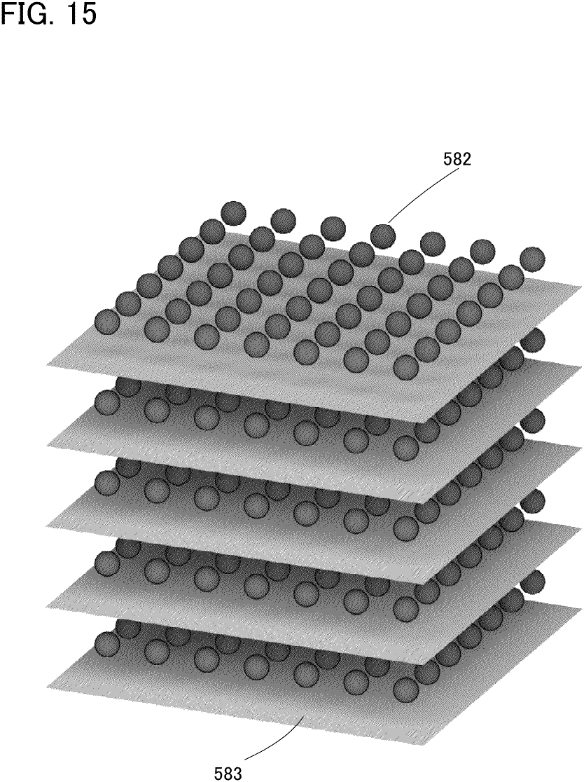

FIG. 15 shows the initial arrangement in the calculation model of the graphene compound and the particle containing silicon under the calculation condition C-1 and the calculation condition C-2. In FIG. 15, one graphene compound is shown to have a sheet-like shape of 400 connected particles, and five sheets of the graphene compound are arranged in the model. In FIG. 15, 245 independent particles containing silicon are arranged in the model. Note that FIG. 15 to FIG. 17 show coarse-grained graphene compound and particle containing silicon, and the graphene compound is assumed to have a carbon hexagonal net surface.

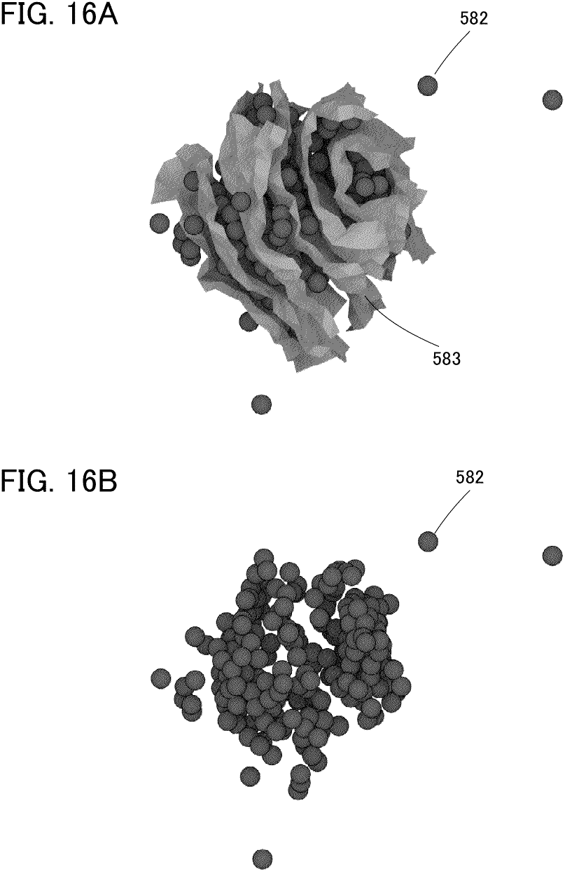

FIG. 16A and FIG. 16B illustrate arrangement after predetermined time elapses by dissipative particle dynamics under the calculation condition C-1. FIG. 16A illustrates both the graphene compound and the particles containing silicon, and FIG. 16B illustrates only the particles containing silicon.

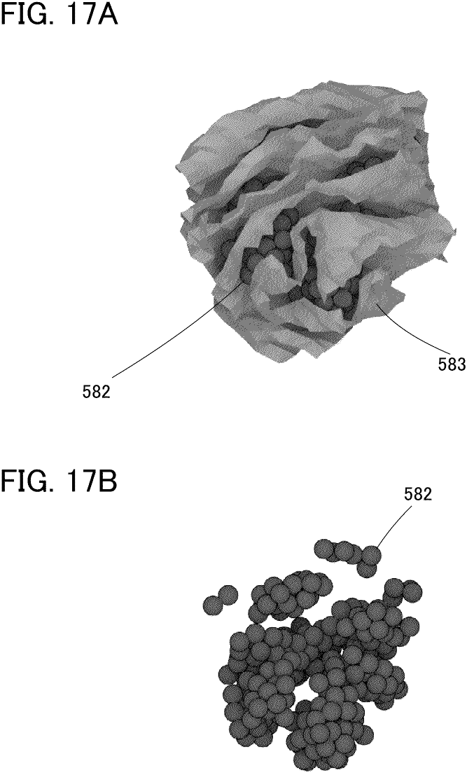

FIG. 17A and FIG. 17B illustrate arrangement after predetermined time elapses by dissipative particle dynamics under the calculation condition C-2. FIG. 17A illustrates both the graphene compound and the particles containing silicon, and FIG. 17B illustrates only the particles containing silicon.

Comparison between FIG. 16B and FIG. 17B shows that more particles containing silicon aggregate under the calculation condition C-2 assuming silicon subjected to lithium carbonate treatment.

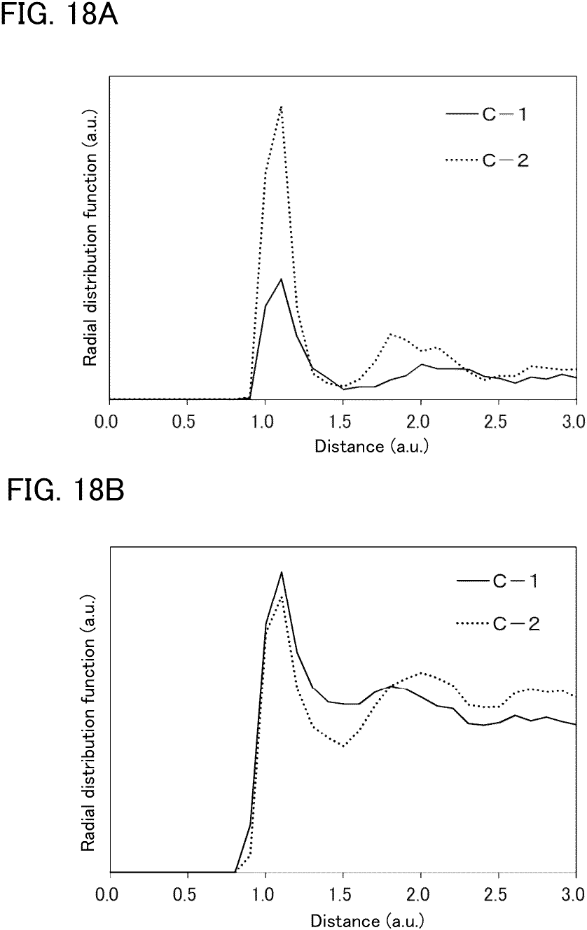

FIG. 18A and FIG. 18B show calculation results of the radial distribution function under the calculation condition C-1 and the calculation condition C-2. The radial distribution function shows the distance from a particle as the center and the distribution of the existing probability of another particle. FIG. 18A shows the radial distribution function between the particle containing silicon and the particle containing silicon, and FIG. 18B shows the radial distribution function between the particle containing silicon and the graphene compound. It is found from FIG. 18A that more particles containing silicon exist in the vicinity of the particle containing silicon under the calculation conduction C-2 than under the calculation condition C-1. Furthermore, it is found from FIG. 18B that the graphene compound exists around the particle containing silicon with a high probability both under the calculation condition C-1 and under the calculation condition C-2. Therefore, under the calculation condition C-2 assuming silicon subjected to lithium carbonate treatment, there is a possibility of achieving both aggregation of the particles containing silicon and clinging of the graphene compound to the particle containing silicon.

### Manufacturing Method 1 of Negative Electrode Active Material

The negative electrode active material of one embodiment of the present invention can be manufactured, for example, in a manner such that the first material 801 that can contribute to reaction of a secondary battery and a second material are mixed and subjected to heat treatment. In addition to the second material, a material causing eutectic reaction with the second material may be mixed as a third material. Thus, the negative electrode active material included in the electrode described in <Example 1 of electrode> can be manufactured.

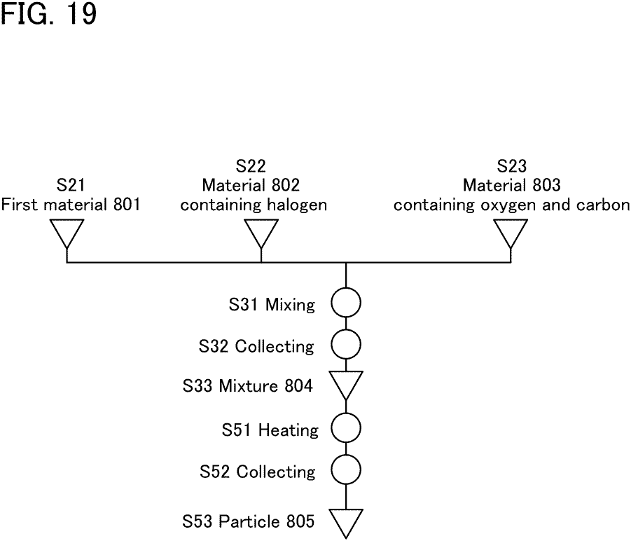

A manufacturing method of the negative electrode active material of one embodiment of the present invention is described with reference to FIG. 19. FIG. 19 shows an example in which the material 802 containing halogen is used as the second material and the material 803 containing oxygen and carbon is used as the third material.

The eutectic point of the eutectic reaction is preferably lower than at least one of the melting point of the material 802 containing halogen and the melting point of the material 803 containing oxygen and carbon. A decrease in the melting point due to the eutectic reaction brings the feasibility of covering the surface of the first material 801 with the material 802 containing halogen and the material 803 containing oxygen and carbon during the heating treatment, which increases the coverage in some cases.

As the material 802 containing halogen and the material 803 containing oxygen and carbon, a material containing a metal whose ion functions as a carrier ion in the reaction of a secondary battery is used, whereby such a metal can contribute to charging and discharging using its carrier ion, in some cases, when the metal is included in a negative electrode active material.

As the material 803 containing oxygen and carbon, for example, the material 803 containing oxygen and carbon can be used. As the material containing oxygen and carbon, carbonate can be used, for example. Alternatively, as the material containing oxygen and carbon, an organic compound can be used, for example. The material containing oxygen and carbon may be used as an organic compound.

Alternatively, as the material 803 containing oxygen and carbon, hydroxide may be used.

Materials such as carbonate and hydroxide are preferable because many of them are inexpensive and have a high level of safety. Furthermore, carbonate, hydroxide, and the like have a eutectic point with a material containing halogen, which is preferable.

Note that a negative electrode active material described below may have an effect of increasing conductivity in an electrode. In the case where the negative electrode active material has an effect of increasing conductivity, a small amount of reaction with carrier ions of the negative electrode active material, which is described below, is allowable in some cases.

Furthermore, a manufacturing method of a negative electrode active material described below may be applied to a manufacturing method of a conductive agent. For example, as fluorine modification of graphene functioning as a conductive agent, Step S31 to Step S53 in a flowchart of FIG. 19 described below are performed on the assumption that the first material 801 is graphene, so that graphene modified with fluorine can be obtained as a conductive material.

Specific examples of the material 802 containing halogen and the material 803 containing oxygen and carbon are described. When lithium fluoride is used as the material 802 containing halogen, lithium fluoride does not cover the surface of the first material but aggregates only with itself, in some cases, in heating after being mixed with the first material 801. In such a case, a material causing a eutectic reaction with lithium fluoride is used as the material 803 containing oxygen and carbon, whereby the coverage of the surface of the first material is improved in some cases.

As an example of the material 803 containing oxygen and carbon and causing a eutectic reaction with lithium fluoride, lithium carbonate is described.

As for the relation between the temperature and the ratio of LiF to Li₂CO₃, the melting point of LiF is approximately 850° C., but the melting point can be decreased by mixing with Li₂CO₃. Thus, at the same heating temperature, dissolution occurs more easily in the case of mixing LiF and Li₂CO₃ than in the case of using only LiF, for example, and the coverage of the surface of the first material can be improved in the former case. In addition, the temperature in heating can be decreased.

In particular, when the molar quantity of LiF with respect to the total molar quantity of LiF and Li₂CO₃ [LiF/(Li₂CO₃+LiF)] is approximately 0.48, the melting point is lowest (approximately 615° C.). In other words, at a molar ratio of LiF to Li₂CO₃ (LiF:Li₂CO₃) set to a1:(1-a1), the lowest melting point can be obtained when a1 is around 0.48.

Note that when a1 is set to a value larger than 0.48, the surface of the first material can be covered with a material with a higher fluorine content. Thus, for example, a1 is preferably a value larger than 0.2, further preferably a value larger than or equal to 0.3. However, when the fluorine content is too high, the coverage might be poor due to an increase in the melting point. For example, a1 is preferably a value smaller than 0.9, further preferably a value smaller than or equal to 0.8.

An example of a manufacturing method of the negative electrode active material of one embodiment of the present invention is described with reference to the flowchart shown in FIG. 19.

In Step S21, the first material 801 is prepared.

As the first material 801, it is preferable to use a material that can be reacted with a carrier ion of a secondary battery, a material into and from which a carrier ion can be inserted and extracted, a material capable of alloying reaction with a metal that is to be a carrier ion, a material that can dissolve and precipitate a metal that is to be a carrier ion, or the like.

Examples of a carrier ion of a secondary battery include an alkali metal ion such as a lithium ion, a sodium ion, and a potassium ion and an alkaline earth metal ion such as a calcium ion, a strontium ion, a barium ion, a beryllium ion, and a magnesium ion.

In addition, as the first material 801, a metal, a material, or a compound including one or more elements selected from silicon, tin, gallium, aluminum, germanium, lead, antimony, bismuth, silver, zinc, cadmium, and indium can be used, for example.

Nanosilicon can be used as silicon. The average diameter of nanosilicon is, for example, preferably greater than or equal to 5 nm and less than 1 µm, further preferably greater than or equal to 10 nm and less than or equal to 300 nm, still further preferably greater than or equal to 10 nm and less than or equal to 100 nm.

Nanosilicon may have a spherical shape, a flat spherical shape, or a cuboid shape with rounded corners. As the size of nanosilicon, for example, D50 of laser diffraction particle size distribution measurement is preferably greater than or equal to 5 nm and less than 1 µm, further preferably greater than or equal to 10 nm and less than or equal to 300 nm, still further preferably greater than or equal to 10 nm and less than or equal to 100 nm.

Nanosilicon may have crystallinity. Nanosilicon may include a region with crystallinity and an amorphous region.

Nitrogen, phosphorus, arsenic, boron, aluminum, gallium, or the like may be added to silicon as an additive element so that silicon is lowered in resistance.

As a material containing silicon, a material represented by SiOₓ (x is preferably less than 2, further preferably greater than or equal to 0.5 and less than or equal to 1.6) can be used, for example.

A material containing silicon, which has a plurality of crystal grains in a single particle, for example, can be used. For example, a configuration where a single particle includes one or more silicon crystal grains can be used. The single particle may also include silicon oxide around the silicon crystal grain(s). The silicon oxide may include an amorphous region.

As the particle containing silicon, Li₂SiO₃ and Li₄SiO₄ can be used, for example. Each of Li₂SiO₃ and Li₄SiO₄ may have crystallinity, or may be amorphous.

Analysis of the particle containing silicon can be performed by NMR, XRD, Raman spectroscopy, or the like.

As the first material 801, a carbon material such as graphite, graphitizing carbon, non-graphitizing carbon, carbon nanotube, carbon black, or graphene can be used, for example.

Furthermore, as the first material 801, an oxide including one or more elements selected from titanium, niobium, tungsten, and molybdenum can be used, for example.

As the first material 801, a plurality of the above-described metal, material, compound, and the like can be combined to be used.

When the first material 801 is heated, reaction with oxygen in an atmosphere occurs in the heating, whereby an oxide film is formed on the surface in some cases.

Here, silicon is prepared as the first material 801. Single crystal silicon, polycrystalline silicon, amorphous silicon, or the like can be used as silicon. Silicon may include a region with crystallinity and an amorphous region. Nitrogen, phosphorus, arsenic, boron, aluminum, gallium, or the like may be added to silicon as an additive element so that silicon is lowered in resistance.

Silicon nanoparticles can be used as silicon. The average diameter of silicon nanoparticles is, for example, preferably greater than or equal to 5 nm and less than 1 µm, further preferably greater than or equal to 10 nm and less than or equal to 300 nm, still further preferably greater than or equal to 10 nm and less than or equal to 100 nm.

The silicon particle preferably contains oxygen in the surface portion. The surface of the silicon particle is terminated with O or OH in some cases due to the effect of adsorbed water.

In Step S22, the material 802 containing halogen is prepared as the second material. As the material containing halogen, a halogen compound containing the metal A1 can be used. As the metal A1, one or more elements selected from lithium, magnesium, aluminum, sodium, potassium, calcium, barium, lanthanum, cerium, chromium, manganese, iron, cobalt, nickel, zinc, zirconium, titanium, vanadium, and niobium can be used, for example. As the halogen compound, for example, a fluoride or a chloride can be used. Here, lithium fluoride is prepared as an example.

In Step S23, the material 803 containing oxygen and carbon is prepared as the third material. As the material containing oxygen and carbon, a carbonate containing the metal A2 can be used, for example. As the metal A2, one or more elements selected from lithium, magnesium, aluminum, sodium, potassium, calcium, barium, lanthanum, cerium, chromium, manganese, iron, cobalt, and nickel can be used, for example. Here, lithium carbonate is prepared as an example.

Next, in Step S31, the first material 801, the material 802 containing halogen, and the material 803 containing oxygen and carbon are mixed. In Step S32, a mixture is collected. In Step S33, a mixture 804 is obtained.

The material 802 containing halogen and the material 803 containing oxygen and carbon are preferably mixed to have a ratio such that (the material 802 containing halogen):(the material 803 containing oxygen and carbon) = a1:(1-a1) [unit: mol.] where a1 is preferably larger than 0.2 and smaller than 0.9, further preferably larger than or equal to 0.3 and smaller than or equal to 0.8.

Furthermore, the first material 801 and the material 802 containing halogen are preferably mixed to have a ratio such that (the first material 801):(the material 802 containing halogen) = 1:b1 [unit: mol.] where b1 is preferably larger than or equal to 0.001 and smaller than or equal to 0.2.

Next, in Step S51, the mixture 804 is heated.

It is preferable that the heating be performed in a reduction atmosphere because the oxidation of the surface of the first material 801 and the reaction of the first material 801 with oxygen can be inhibited. The reduction atmosphere may be a nitrogen atmosphere or a rare gas atmosphere, for example. Furthermore, two or more types of gases selected from nitrogen and a rare gas may be mixed and used. The heating may be performed under reduced pressure.

In the case where the melting point of the material 802 containing halogen is represented by M₂ [K], the temperature at heating is preferably higher than (M₂-550) [K] and lower than (M₂+50) [K], further preferably higher than or equal to (M₂-400) [K] and lower than or equal to (M₂) [K].

Moreover, in a compound, solid-phase diffusion occurs easily at a temperature higher than or equal to the Tamman temperature. The Tamman temperature of an oxide, for example, is 0.757 times of the melting point. Thus, the temperature at heating is preferably higher than or equal to 0.757 times of the melting point or the eutectic point or higher than its vicinity, for example.

In the case of lithium fluoride that is a typical example of the material containing halogen, the amount of evaporation increases rapidly at a temperature higher than or equal to the melting point. Thus, the temperature at heating is preferably lower than or equal to the melting point of the material containing halogen, for example.

In the case where the eutectic point of the material 802 containing halogen and the material 803 containing oxygen and carbon is represented by M₂₃ [K], the temperature at heating is, for example, preferably higher than (M₂₃×0.7) [K] and lower than (M₂+50) [K], preferably higher than or equal to (M₂₃×0.75) [K] and lower than or equal to (M₂+20) [K], preferably higher than or equal to (M₂₃×0.75) [K] and lower than or equal to (M₂+20) [K], preferably higher than M₂₃ [K] and lower than (M₂+10) [K], further preferably higher than or equal to (M₂₃×0.8) [K] and lower than or equal to M₂ [K], and further preferably higher than or equal to (M₂₃) [K] and lower than or equal to M₂ [K].

In the case where lithium fluoride is used as the material 802 containing halogen, and lithium carbonate is used as the material 803 containing oxygen and carbon, the temperature at heating is, for example, preferably higher than 350° C. and lower than 900° C., further preferably higher than or equal to 390° C. and lower than or equal to 850° C., still further preferably higher than or equal to 520° C. and lower than or equal to 910° C., still further preferably higher than or equal to 570° C. and lower than or equal to 860° C., yet still further preferably higher than or equal to 610° C. and lower than or equal to 860° C.

The heating time is preferably longer than or equal to 1 hour and shorter than or equal to 60 hours, further preferably longer than or equal to 3 hours and shorter than or equal to 20 hours, for example.

In the case where the silicon particle is used as the first material 801, lithium fluoride is used as the material 802 containing halogen, and lithium carbonate is used as the material 803 containing oxygen and carbon, a reaction of the following chemical reaction formula (1) is probably caused at the surface portion of the silicon particle at the time of heating. Note that it is known that in the normal air atmosphere, a native oxide film is formed on the surface of a silicon particle and the surface is terminated with 0 or OH due to the effect of adsorbed water on the surface, and the notation SiOₓ(OH)_{y} is used in the chemical reaction formula (1)_{.}

$$\begin{matrix}a {\text{SiO}}_{x} {\left(\text{OH}\right)}_{y} + b \text{LiF} + c {\text{Li}}_{2} {\text{CO}}_{3} \\ \to {\text{Li}}_{b + 2 c} {\text{Si}}_{a} {\text{O}}_{\left(a x + \frac{1}{2} a y + c\right)} {\text{F}}_{b} + \frac{1}{2} a y {\text{H}}_{2} \text{O} + c {\text{CO}}_{2} \left(1\right)\end{matrix} \qquad \text{[Formula 1]}$$

By the heating, one or more of halogen, oxygen, carbon, the metal A1, and the metal A2 diffuse in the surface portion of the first material 801 in some cases. When the first material contains the element(s), carrier ions are likely to be inserted into and extracted from the first material 801 in some cases. Furthermore, the desolvation of carrier ions is facilitated in some cases. Alternatively, the deformation of the crystal structure of the first material 801 caused by the repetition of insertion and extraction of carrier ions can be inhibited in some cases.

Fluorine is particularly preferably contained as halogen.

In the case where silicon and lithium fluoride are used as the first material 801 and the material 802 containing halogen, respectively, a compound containing lithium, silicon, and oxygen is formed in the surface portion of the first material 801 by heating in some cases. The whole of the first material 801 becomes the compound containing lithium, silicon, and oxygen in some cases depending on the heating conditions. As the compound containing lithium, silicon, and oxygen, Li₂SiO₃ and Li₄SiO₄ are included in some cases, for example. Each of Li₂SiO₃ and Li₄SiO₄ may have crystallinity, or may be amorphous. The compound containing lithium, silicon, and oxygen may further contain fluorine. A region that is terminated with a functional group containing oxygen and carbon, a functional group containing an oxygen atom, or a fluorine atom is sometimes included in the surface.

The compound containing lithium, silicon, and oxygen further contains fluorine in some cases. A compound containing lithium, silicon, oxygen, and fluorine may be a composite oxide represented by a general formula LiₓSi₍₁₋ₓ)O(_{2-y})F_{y}, for example.

Next, in Step S52, the heated mixture is collected, whereby a particle 805 is obtained in Step S53. The particle 805 can be used as the particle 582 included in the negative electrode active material layer.

Through the steps described above, the negative electrode active material of one embodiment of the present invention can be obtained.

In the case where the particle 805 includes the compound containing lithium, silicon, and oxygen in the surface portion, carrier ions are easily inserted into and extracted from the particle 805 in some cases. Furthermore, the desolvation of carrier ions is facilitated in some cases. Alternatively, the deformation of the crystal structure of the particle 805 caused by the repetition of insertion and extraction of carrier ions can be inhibited in some cases.

In the case where, in the surface of the particle 805, a region that is terminated with a functional group containing oxygen and carbon, a functional group containing an oxygen atom, or a fluorine atom is included and a hydrogen bond region is formed by a hydrogen atom included in a functional group included in the graphene compound, the graphene compound can closely cling to the particle 805 owing to the action of an intermolecular force or the like.

### Manufacturing Method 2 of Negative Electrode Active Material

The negative electrode active material of one embodiment of the present invention can be manufactured, for example, in a manner such that the first material 801 that can contribute to reaction of a secondary battery and the material 803 containing oxygen and carbon are mixed and subjected to heat treatment. In this manner, the negative electrode active material described in <Example 2 of electrode> can be formed.

As the material 803 containing oxygen and carbon, a material containing a metal whose ion functions as a carrier ion in the reaction of a secondary battery is used, whereby such a metal can contribute to charging and discharging using its carrier ion, in some cases, when the metal is included in a negative electrode active material.

As the material 803 containing oxygen and carbon, for example, carbonate can be used, for example. Alternatively, as the material containing oxygen and carbon, an organic compound can be used, for example.

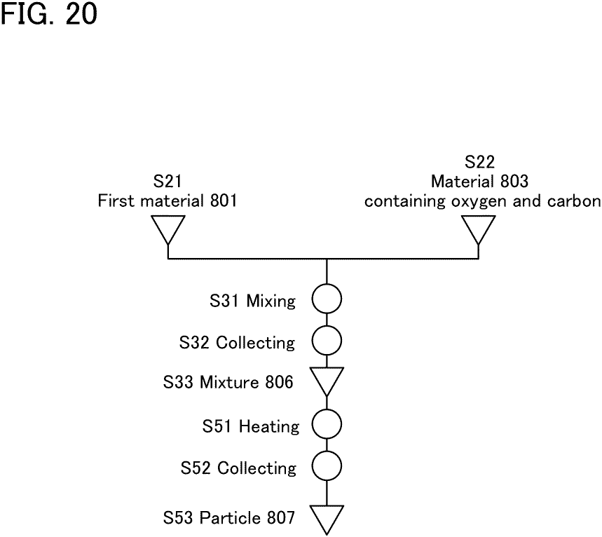

An example of a manufacturing method of the negative electrode active material of one embodiment of the present invention is described with reference to a flowchart shown in FIG. 20.

In Step S21, the first material 801 is prepared.

Any of the aforementioned materials can be used as the first material 801.

Here, silicon is prepared as the first material 801. Single crystal silicon, polycrystalline silicon, amorphous silicon, or the like can be used as silicon. Silicon may include a region with crystallinity and an amorphous region. Nitrogen, phosphorus, arsenic, boron, aluminum, gallium, or the like may be added to silicon as an additive element so that silicon is lowered in resistance.

Nanosilicon can be used as silicon. The average diameter of nanosilicon is, for example, preferably greater than or equal to 5 nm and less than 1 µm, further preferably greater than or equal to 10 nm and less than or equal to 300 nm, still further preferably greater than or equal to 10 nm and less than or equal to 100 nm.

Silicon preferably contains oxygen in the surface portion. The surface of silicon is terminated with O or OH in some cases due to the effect of adsorbed water.

In Step S22, the material 803 containing oxygen and carbon is prepared. As the material 803 containing oxygen and carbon, a carbonate containing the metal Al can be used, for example. As the metal Al, one or more elements selected from lithium, magnesium, aluminum, sodium, potassium, calcium, barium, lanthanum, cerium, chromium, manganese, iron, cobalt, and nickel can be used, for example.

Here, lithium carbonate is prepared as the material 803 containing oxygen and carbon.

Next, in Step S31, the first material 801 and the material 803 containing oxygen and carbon are mixed. In Step 32, a mixture is collected. In Step S33, a mixture 856 is obtained. At the time of the collection, the mixture may be crushed and made to pass through a sieve as needed.

Furthermore, the first material 801 and the material 803 containing oxygen and carbon are preferably mixed to have a ratio such that (the first material 801):(the material 803 containing oxygen and carbon) = 1:a1 [unit: mol.] where a1 is preferably larger than or equal to 0.001 and smaller than or equal to 0.2.

Next, in Step S51, the mixture 856 is heated.

It is preferable that the heating be performed in a reduction atmosphere because the oxidation of the surface of the first material 801 and the reaction of the first material 801 with oxygen can be inhibited. The reduction atmosphere may be a nitrogen atmosphere or a rare gas atmosphere, for example. Furthermore, two or more types of gases selected from nitrogen and a rare gas may be mixed and used. The heating may be performed under reduced pressure.

Moreover, in a compound, solid-phase diffusion occurs easily at a temperature higher than or equal to the Tamman temperature. The Tamman temperature of an oxide, for example, is 0.757 times of the melting point. Thus, the temperature at heating is preferably higher than or equal to 0.757 times of the melting point or the eutectic point or higher than its vicinity, for example.

In the case where lithium carbonate is used as the material 803 containing oxygen and carbon, the temperature at heating is, for example, preferably higher than 350° C. and lower than 900° C., further preferably higher than or equal to 390° C. and lower than or equal to 850° C., still further preferably higher than or equal to 520° C. and lower than or equal to 910° C., still further preferably higher than or equal to 570° C. and lower than or equal to 860° C., yet still further preferably higher than or equal to 610° C. and lower than or equal to 860° C.

The heating time is preferably longer than or equal to 1 hour and shorter than or equal to 60 hours, further preferably longer than or equal to 3 hours and shorter than or equal to 20 hours, for example.

Next, in Step S52, the heated mixture is collected, whereby a particle is obtained in Step S53. The particle 807 can be referred to as a negative electrode active material. In the case where silicon is used as the first material 801 and lithium carbonate is used as the material 803 containing oxygen and carbon, the particle 807 can be referred to as silicon subjected to lithium carbonate treatment. The particle 807 can be used as the particle 582 included in the negative electrode active material layer.

One or more of the metal Al, oxygen, and carbon are diffused to the surface portion of the particle 582 by heating in some cases. When the particle 582 includes the element(s), carrier ions are likely to be inserted into and extracted from the particle 582 in some cases. Furthermore, the desolvation of carrier ions is facilitated in some cases. Alternatively, the deformation of the particle 582 caused by the repetition of insertion and extraction of carrier ions can be inhibited in some cases. Alternatively, in some cases, a plurality of particles can easily aggregate and a sheet-like material can easily cling to the particle.

Through the steps described above, the negative electrode active material of one embodiment of the present invention can be obtained.

In the case where the particle 582 includes the compound containing one or more of lithium, silicon, oxygen, and carbon in the surface portion, carrier ions are easily inserted into and extracted from the particle 582 in some cases. Furthermore, the desolvation of carrier ions is facilitated in some cases. Alternatively, the deformation of the particle 582 caused by the repetition of insertion and extraction of carrier ions can be inhibited in some cases. Alternatively, in some cases, a plurality of particles 582 can easily aggregate and the sheet-like graphene compound 583 can easily cling to the particle 582.

In the case where, in the surface of the particle 582, a region that is terminated with a functional group containing oxygen and carbon, a functional group containing an oxygen atom, or a fluorine atom is included and a hydrogen bond region is formed by a hydrogen atom included in a functional group included in the graphene compound 583, the graphene compound 583 can closely cling to the particle 582 owing to the action of an intermolecular force or the like.

### Formation Method of Electrode

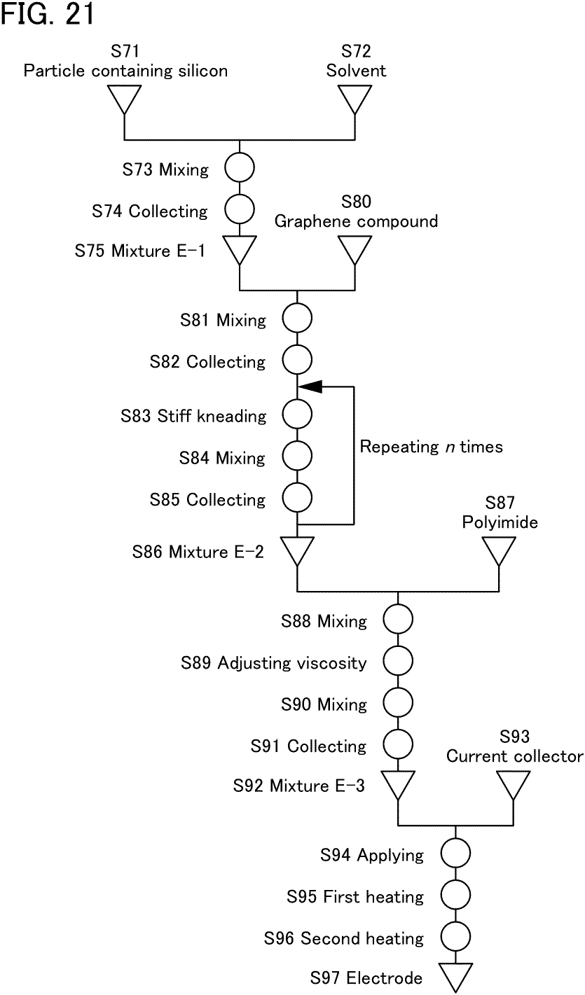

FIG. 21 is a flowchart showing an example of a formation method of an electrode of one embodiment of the present invention.

First, in Step S71, a particle containing silicon is prepared. The particle described as the particle 582 can be used as the particle containing silicon. For example, the particle 805 described in <Manufacturing method 1 of negative electrode active material> above, and/or the particle 807 described in <Manufacturing method 2 of negative electrode active material> above can be used.

In Step S72, a solvent is prepared. For example, one of water, methanol, ethanol, acetone, tetrahydrofuran (THF), dimethylformamide (DMF), N-methylpyrrolidone (NMP), and dimethyl sulfoxide (DMSO), or a mixed solution of two or more of the above can be used as the solvent.

Next, in Step S73, the particle containing silicon prepared in Step S71 and the solvent prepared in Step S72 are mixed, a mixture is collected in Step S74, and a mixture E-1 is obtained in Step S75. A kneader or the like can be used for the mixing. As the kneader, a planetary centrifugal mixer can be used, for example.

Next, a graphene compound is prepared in Step S80.

Next, in Step S81, the mixture E-1 and the graphene compound prepared in Step S80 are mixed and a mixture is collected in Step S82. The collected mixture preferably has a high viscosity. Because of the high viscosity, stiff kneading (kneading in high viscosity) can be performed in the following Step S83

Next, stiff kneading is performed in Step S83. The stiff kneading can be performed with the use of a spatula for example. By performing the stiff kneading, a mixture with high dispersibility of the graphene compound, in which the particle containing silicon and the graphene compound are mixed well, can be formed.

Next, mixing of the stiff-kneaded mixture is performed in Step S84. A kneader or the like can be used for the mixing, for example. The mixture subjected to the mixing is collected in Step S85.

The steps of Step S83 to Step S85 are preferably repeated n times on the mixture collected in Step S85. For example, n is a natural number of greater than or equal to 2 and less than or equal to 10. In the step of Step S83, when the mixture is dried, a solvent is preferably added thereto. However, when a solvent is added too much, the viscosity is lowered and the effect of stiff kneading is decreased.

Step S83 to Step S85 are repeated n times, and then a mixture E-2 is obtained (Step S86).

Next, a binder is prepared in Step S87. As the binder, any of the above-described materials can be used, and especially polyimide is preferred. Note that in Step S87, a precursor of a material used as the binder is prepared in some cases. For example, a precursor of polyimide is prepared.

Next, in Step S88, the mixture E-2 is mixed with the binder prepared in Step S87. Next, in Step S89, the viscosity is adjusted. Specifically, for example, a solvent of the same kind as the solvent prepared in Step S72 is prepared and is added to a mixture obtained in Step S88. By adjusting the viscosity, for example, the thickness, density, and the like of an electrode obtained in Step S97 can be adjusted in some cases.

Next, the mixture whose viscosity is adjusted in Step S89 is mixed in Step S90 and collected in Step S91, whereby a mixture E-3 is obtained (Step S92). The mixture E-3 obtained in Step S92 is referred to as a slurry, for example.

Next, a current collector is prepared in Step S93.

Next, in Step S94, the mixture E-3 is applied onto the current collector prepared in Step S93. For the application, a slot die method, a gravure method, a blade method, or combination of any of the methods can be used, for example. Furthermore, a continuous coater or the like may be used for the application.

Next, first heating is performed in Step S95. By the first heating, the solvent is volatilized. The first heating is preferably performed at a temperature in the range from 50° C. to 200° C. inclusive, further preferably from 60° C. to 150° C. inclusive.

For example, heat treatment may be performed using a hot plate at 30° C. or higher and 70° C. or lower in an air atmosphere for 10 minutes or longer, and then, for example, heat treatment may be performed at room temperature or higher and 100° C. or lower in a reduced-pressure environment for 1 hour to 10 hours inclusive.

Alternatively, heat treatment may be performed using a drying furnace or the like. In the case of using a drying furnace, for example, heat treatment at 30° C. or higher and 120° C. or lower for 30 seconds to 2 hours inclusive may be performed.

In addition, the temperature may be increased stepwise. For example, after heat treatment is performed at 60° C. or lower for 10 minutes or shorter, heat treatment may further be performed at 65° C. or higher for 1 minute or longer.

Next, second heating is performed in Step S96. When polyimide is used as a binder, a cycloaddition reaction of polyimide is preferably caused by the second heating. In addition, a dehydration reaction of polyimide is caused by the second heating in some cases. Alternatively, the dehydration reaction is caused by the first heating in some cases. In the first heating, a cycloaddition reaction of polyimide may be caused. Moreover, a reduction reaction of the graphene compound is preferably caused by the second heating.

The second heating is preferably performed at a temperature in the range from 150° C. to 500° C. inclusive, further preferably from 200° C. to 450° C. inclusive.

For example, heat treatment may be performed at 200° C. to 450° C. inclusive for 1 hour to 10 hours inclusive in a reduced-pressure environment of 10 Pa or lower or an inert atmosphere of nitrogen, argon, or the like.

In Step S97, an electrode provided with an active material layer over the current collector is obtained.

The thickness of the active material layer formed in this manner is preferably greater than or equal to 5 µm and less than or equal to 300 µm, further preferably greater than or equal to 10 µm and less than or equal to 150 µm, for example. The amount of the active material carried in the active material layer is preferably greater than or equal to 2 mg/cm² and less than or equal to 50 mg/cm², for example.

The active material layer may be formed on both surfaces of the current collector or on only one surface of the current collector. Alternatively, there may be regions of both surfaces where the active material layer is partly formed.

After the solvent is volatilized from the active material layer, pressing may be performed by a compression method such as a roll press method or a flat plate press method. In the pressing, heat may be applied.

### Example of Positive Electrode Active Material

Examples of a positive electrode active material include a lithium-containing composite oxide with an olivine crystal structure, a lithium-containing composite oxide with a layered rock-salt crystal structure, and a lithium-containing composite oxide with a spinel crystal structure.

As the positive electrode active material of one embodiment of the present invention, a positive electrode active material with a layered crystal structure is preferably used.

As a layered crystal structure, for example, a layered rock-salt crystal structure is given. As a lithium-containing composite oxide with a layered rock-salt crystal structure, for example, it is possible to use a lithium-containing composite oxide represented by LiMₓO_{y} (x > 0 and y > 0, specifically y = 2 and 0.8 < x < 1.2, for example). Here, the metal M may contain one or more kinds of metals (here, represented by the metal M) selected from cobalt, nickel, manganese, aluminum, iron, vanadium, chromium, and niobium.

The metal M can contain a metal X in addition to any of the metals given above. The metal X is a metal other than cobalt, and for example, one or a plurality of kinds of metals such as magnesium, calcium, zirconium, lanthanum, barium, copper, potassium, sodium, and zinc can be used as the metal X. In particular, magnesium is preferably used as the metal X.

The metal M can contain a metal Z in addition to any of the metals given above. The metal Z is a metal other than cobalt, and one or a plurality of kinds of metals selected from nickel, aluminum, manganese, titanium, vanadium, and chromium can be used as the metal Z, for example. One or both of nickel and aluminum are particularly preferably added as the metal Z.

Examples of the lithium-containing composite oxide represented by LiMₓO_{y} include LiCoO₂, LiNiO₂, and LiMnO₂. As examples of a NiCo-based lithium-containing composite oxide represented by LiNiₓCo₁₋ₓO₂ (0 < x < 1) and the lithium-containing composite oxide represented by LiMₓO_{y}, a NiMn-based lithium-containing composite oxide represented by LiNiₓMn₁₋ₓO₂ (0 < x < 1) and the like can be given.

As a lithium-containing composite oxide represented by LiMO₂, for example, a NiCoMn-based material (also referred to as NCM) represented by LiNiₓCo_{y}Mn_{z}O₂ (x > 0, y > 0, and 0.8 < x+y+z < 1.2) is given. Specifically, 0.1x < y < 8x and 0.1x < z < 8x are preferably satisfied, for example. For example, x, y, and z preferably satisfy x:y:z = 1:1:1 or the neighborhood thereof. Alternatively, for example, x, y, and z preferably satisfy x:y:z = 5:2:3 or the neighborhood thereof. Alternatively, for example, x, y, and z preferably satisfy x:y:z = 8:1:1 or the neighborhood thereof. Alternatively, for example, x, y, and z preferably satisfy x:y:z = 6:2:2 or the neighborhood thereof. Alternatively, for example, x, y, and z preferably satisfy x:y:z = 1:4:1 or the neighborhood thereof.

As a lithium-containing composite oxide with a layered rock-salt crystal structure, Li₂MnO₃ and Li₂MnO₃-LiMeO₂ (Me represents Co, Ni, or Mn) are given, for example.

With the use of a positive electrode active material with a layered crystal structure typified by the above-described lithium-containing composite oxide, a secondary battery with a high lithium content per volume and high capacity per volume can be provided in some cases. In such a positive electrode active material, the amount of lithium extracted during charging per volume is large; thus, in order to perform stable charging and discharging, the crystal structure after the extraction needs to be stabilized. Collapse of the crystal structure in charging and discharging may hinder fast charging and fast discharging.

As the positive electrode active material, it is preferable to mix lithium nickel oxide (LiNiO₂ or LiNi₁₋ₓMₓO₂ (0 < x < 1) (M = Co, Al, or the like)) with a lithium-containing material that has a spinel crystal structure and contains manganese, such as LiMn₂O₄. This composition can improve the characteristics of the secondary battery.

As the positive electrode active material, a lithium-manganese composite oxide represented by a composition formula LiₐMn_{b}M_{c}O_{d} can be used. Here, the element M is preferably silicon, phosphorus, or a metal element other than lithium and manganese, further preferably nickel. In the case where the whole particle of a lithium-manganese composite oxide is measured, it is preferable to satisfy the following at the time of discharging: 0 < a/(b+c) < 2; c > 0; and 0.26 ≤ (b+c)/d < 0.5. Note that the proportions of metals, silicon, phosphorus, and the like in the whole particle of a lithium-manganese composite oxide can be measured with, for example, an ICP-MS (inductively coupled plasma mass spectrometer). The proportion of oxygen in the whole particle of a lithium-manganese composite oxide can be measured by, for example, EDX (energy dispersive X-ray spectroscopy). Alternatively, the proportion of oxygen can be measured by ICPMS combined with fusion gas analysis and valence evaluation of XAFS (X-ray absorption fine structure) analysis. Note that the lithium-manganese composite oxide is an oxide containing at least lithium and manganese, and may contain at least one selected from chromium, cobalt, aluminum, nickel, iron, magnesium, molybdenum, zinc, indium, gallium, copper, titanium, niobium, silicon, phosphorus, and the like.

### Structure of Positive Electrode Active Material

A material with a layered rock-salt crystal structure, such as lithium cobalt oxide (LiCoO₂), is known to have a high discharge capacity and excel as a positive electrode active material of a secondary battery. As an example of the material with a layered rock-salt crystal structure, a composite oxide represented by LiMO₂ is given.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when charging and discharging with high voltage are performed on LiNiO₂, the crystal structure might be broken because of the distortion. The influence of the Jahn-Teller effect is suggested to be small in LiCoO₂; hence, LiCoO₂ is preferable because the resistance to charging and discharging with high voltage is higher in some cases.

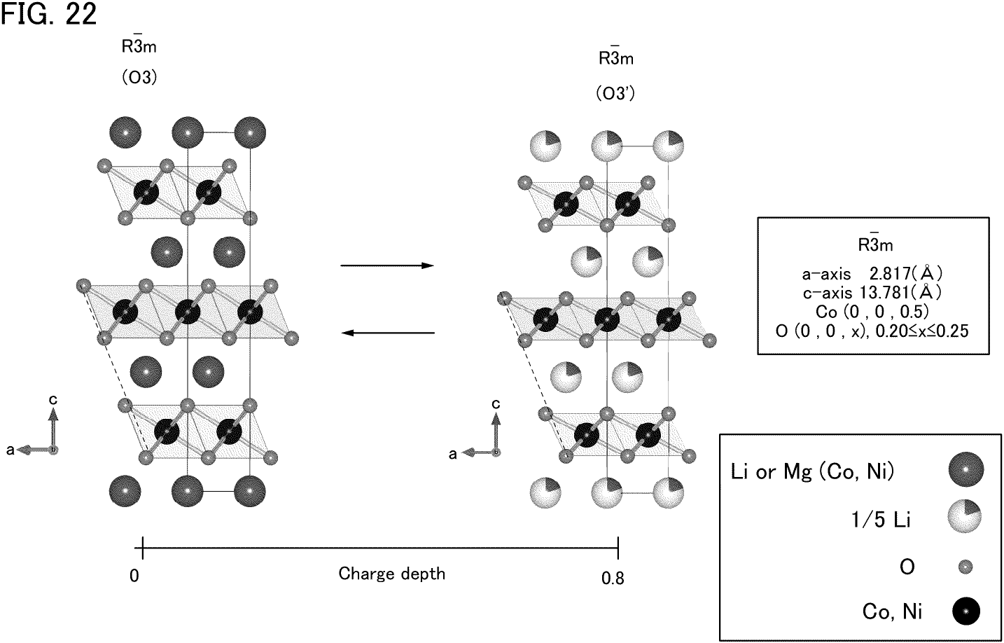

Positive electrode active materials are described with reference to FIG. 22 to FIG. 25. In FIG. 22 to FIG. 25, the case where cobalt is used as the metal M contained in the positive electrode active material is described.

### Conventional Positive Electrode Active Material

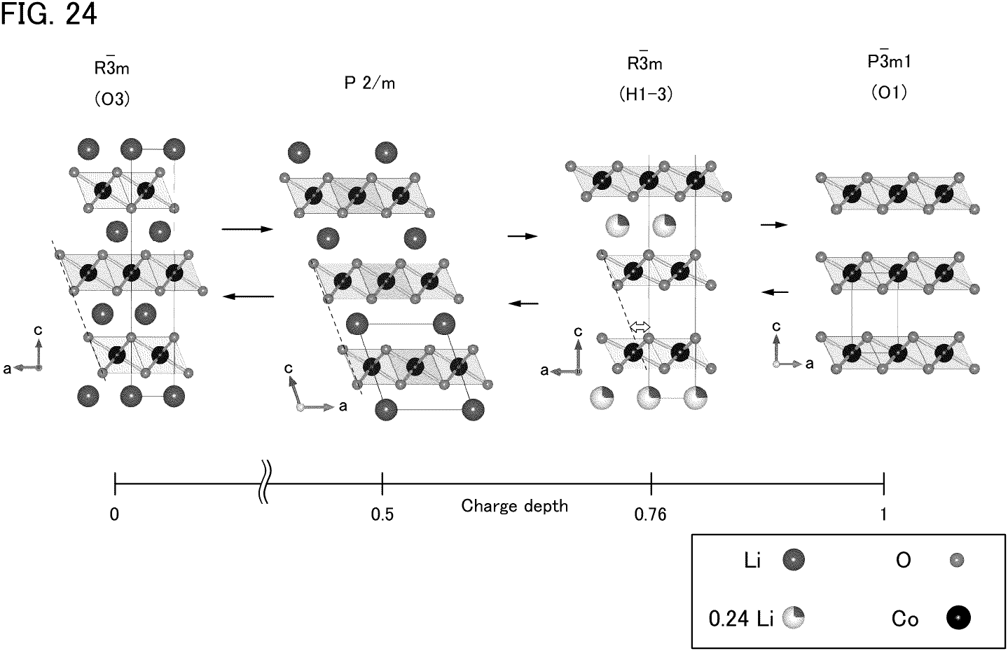

A positive electrode active material illustrated in FIG. 24 is lithium cobalt oxide (LiCoO₂) to which halogen and magnesium are not added in a manufacturing method to be described later. As illustrated in FIG. 24, the crystal structure of lithium cobalt oxide is changed depending on a charge depth.

As illustrated in FIG. 24, lithium cobalt oxide with a charge depth of 0 (the discharged state) includes a region having the crystal structure of the space group R-3m, and includes three CoO₂ layers in a unit cell. Thus, this crystal structure is referred to as an O3 type crystal structure in some cases. Note that the CoO₂ layer has a structure in which an octahedral structure with cobalt coordinated to six oxygen atoms continues on a plane in an edge-sharing state.

Lithium cobalt oxide with a charge depth of 1 has the crystal structure of the space group P-3m1 and includes one CoO₂ layer in a unit cell. Hence, this crystal structure is referred to as an O1 type crystal structure in some cases.

Lithium cobalt oxide with a charge depth of approximately 0.8 has the crystal structure of the space group R-3m. This structure can also be regarded as a structure in which CoO₂ structures such as a structure belonging to P-3m1 (O1) and LiCoO₂ structures such as a structure belonging to R-3m (O3) are alternately stacked. Thus, this crystal structure is referred to as an H1-3 type crystal structure in some cases. Note that the number of cobalt atoms per unit cell in the actual H1-3 type crystal structure is twice that in other structures. However, in this specification including FIG. 24, the c-axis of the H1-3 type crystal structure is half that of the unit cell for easy comparison with the other structures.

For the H1-3 type crystal structure, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). O₁ and O₂ are each an oxygen atom. In this manner, the H1-3 type crystal structure is represented by a unit cell containing one cobalt and two oxygen. Meanwhile, the O3′ type crystal structure of one embodiment of the present invention is preferably represented by a unit cell containing one cobalt and one oxygen, as described later. This means that the symmetry of cobalt and oxygen differs between the O3′ type crystal structure and the H1-3 type structure, and the amount of change from the O3 structure is smaller in the O3′ type crystal structure than in the H1-3 type structure. A unit cell that should be used for representing a crystal structure in a positive electrode active material can be judged by the Rietveld analysis of XRD, for example. In this case, a unit cell is selected such that the value of GOF (goodness of fit) is small.

When charging with a high charge voltage of 4.6 V or higher with reference to the redox potential of a lithium metal or charging with a large charge depth of 0.8 or more and discharging are repeated, a change of the crystal structure of lithium cobalt oxide between the H1-3 type crystal structure and the R-3m (O3) structure in a discharged state (i.e., a nonequilibrium phase change) occurs repeatedly

However, there is a large deviation in the position of the CoO₂ layer between these two crystal structures. As indicated by dotted lines and an arrow in FIG. 24, the CoO₂ layer in the H1-3 type crystal structure greatly shifts from that in the R-3m (O3) structure. Such a dynamic structural change might adversely affect the stability of the crystal structure.

A difference in volume is also large. The H1-3 type crystal structure and the O3 type crystal structure in a discharged state that contain the same number of cobalt atoms have a difference in volume of 3.0 % or more.

In addition, a structure in which CoO₂ layers are continuous, such as P-3m1 (O1), included in the H1-3 type crystal structure is highly likely to be unstable.

Thus, the repeated high-voltage charging and discharging breaks the crystal structure of lithium cobalt oxide. The break of the crystal structure degrades the cycle performance. This is probably because the break of the crystal structure reduces sites where lithium can stably exist and makes it difficult to insert and extract lithium.

### Positive Electrode Active Material

In the positive electrode active material of one embodiment of the present invention, a deviation in the CoO₂ layers can be small in repeated high-voltage charging and discharging. Furthermore, the change in volume can be small. Thus, the positive electrode active material of one embodiment of the present invention can have excellent cycle performance. In addition, the positive electrode active material of one embodiment of the present invention can have a stable crystal structure in a high-voltage charged state. Thus, in the positive electrode active material of one embodiment of the present invention, a short circuit is unlikely to occur while the high-voltage charged state is maintained, in some cases. This is preferable because the safety is further improved.

The positive electrode active material of one embodiment of the present invention has a small crystal-structure change and a small volume difference per the same number of atoms of the transition metal between a sufficiently discharged state and a high-voltage charged state.

FIG. 22 illustrates the crystal structures of the positive electrode active material before and after being charged and discharged. The positive electrode active material is a composite oxide containing lithium, cobalt as the metal M, and oxygen. It is preferable to contain magnesium, aluminum, nickel, titanium, or zirconium as an additive in addition to the above. Furthermore, halogen such as fluorine, chlorine, or bromine is preferably contained as the additive.

The crystal structure with a charge depth of 0 (the discharged state) in FIG. 22 belongs to R-3m (O3) as in FIG. 24. Meanwhile, the positive electrode active material with a charge depth in a sufficiently charged state includes a crystal that has a structure different from the H1-3 type crystal structure. This structure belongs to the space group R-3m, and is not a spinel crystal structure but a structure in which an ion of cobalt, magnesium, or the like occupies a site coordinated to six oxygen atoms and the cation arrangement has symmetry similar to that of the spinel structure. Furthermore, the periodicity of CoO₂ layers in this structure is the same as that in the O3 type structure. This structure is thus referred to as the O3′ type crystal structure or the pseudo-spinel crystal structure in this specification and the like. Accordingly, the O3′ type crystal structure may be rephrased as the pseudo-spinel crystal structure. Note that although the indication of lithium is omitted in the diagram of the O3′ type crystal structure shown in FIG. 22 to explain the symmetry of cobalt atoms and the symmetry of oxygen atoms, lithium of 20 atomic % or less, for example, with respect to cobalt practically exists between the CoO₂ layers. In both the O3 type crystal structure and the O3′ type crystal structure, a slight amount of magnesium preferably exists between the CoO₂ layers, i.e., in lithium sites. In addition, a slight amount of halogen such as fluorine preferably exists in oxygen sites at random.

Note that in the O3′ type crystal structure, a light element such as lithium sometimes occupies a site coordinated to four oxygen atoms. Also in that case, the ion arrangement has symmetry similar to that of the spinel structure.

The O3′ type crystal structure can also be regarded as a crystal structure that includes Li between layers at random but is similar to a CdCl₂ type crystal structure. The crystal structure similar to the CdCl₂ type structure is close to a crystal structure of lithium nickel oxide that is charged up to a charge depth of 0.94 (Li_{0.06}NiO₂); however, pure lithium cobalt oxide or a layered rock-salt positive electrode active material containing a large amount of cobalt is known not to have this crystal structure generally.

In the positive electrode active material of one embodiment of the present invention, a change in the crystal structure caused when a large amount of lithium is extracted by charging with high voltage is smaller than that in a conventional positive electrode active material. As indicated by dotted lines in FIG. 22, for example, there is a very little deviation in the CoO₂ layers between the crystal structures.

More specifically, the structure of the positive electrode active material of one embodiment of the present invention is highly stable even when a charge voltage is high. For example, at charge voltage that makes the conventional positive electrode active material have the H1-3 type crystal structure, for example, at a voltage of approximately 4.6 V with reference to the potential of lithium metal, there is a charge voltage region where the positive electrode active material can maintain the R-3m (O3) crystal structure. Moreover, in a higher charge voltage region, for example, at voltages of approximately 4.65 V to 4.7 V with reference to the potential of lithium metal, there is a region within which the O3′ type crystal structure can be obtained. At a much higher charge voltage, the H1-3 type crystal is eventually observed in some cases. In the case where graphite, for instance, is used as a negative electrode active material in a secondary battery, a charge voltage region where the R-3m (O3) crystal structure can be maintained exists when the voltage of the secondary battery is, for example, higher than or equal to 4.3 V and lower than or equal to 4.5 V. In a higher charge voltage region, for example, at a voltage higher than or equal to 4.35 V and lower than or equal to 4.55 V with reference to the potential of lithium metal, there is a region within which the O3′ type crystal structure can be obtained.

Thus, in the positive electrode active material of one embodiment of the present invention, the crystal structure is less likely to be broken even when charging and discharging are repeated at high voltage.

In addition, in the positive electrode active material, a difference in the volume per unit cell between the O3 type crystal structure with a charge depth of 0 and the O3′ type crystal structure with a charge depth of 0.8 is less than or equal to 2.5 %, specifically, less than or equal to 2.2 %.

In the unit cell of the O3′ type crystal structure, the coordinates of cobalt and oxygen can be represented by Co (0, 0, 0.5) and O (0, 0, x) within the range of 0.20 ≤ x ≤ 0.25.

A slight amount of an additive, e.g., magnesium, existing between the CoO₂ layers, i.e., in lithium sites at random has an effect of inhibiting deviation in the CoO₂ layers. Thus, when magnesium exists between the CoO₂ layers, the O3′ type crystal structure is likely to be formed. Therefore, magnesium preferably exists in at least part of the surface portion of the particle of the positive electrode active material of one embodiment of the present invention, further preferably in a region of half or more of the surface portion of the particle, still further preferably in the entire region of the surface portion of the particle. To distribute magnesium into the entire region of the surface portion of the particle, heat treatment is preferably performed in the manufacturing process of the positive electrode active material of one embodiment of the present invention.

However, cation mixing occurs when the heat treatment temperature is excessively high, so that the additive, e.g., magnesium, is highly likely to enter the cobalt sites. Magnesium in the cobalt sites does not have the effect of maintaining the R-3m structure in the high-voltage charged state. Furthermore, when the heat treatment temperature is excessively high, adverse effects such as reduction of cobalt to have a valence of two and transpiration or sublimation of lithium are also concerned.

In view of the above, a halogen compound such as a fluorine compound is preferably added to lithium cobalt oxide before the heat treatment for distributing magnesium over the entire surface portion of the particle. The addition of the halogen compound depresses the melting point of lithium cobalt oxide. The depression of the melting point facilitates distribution of magnesium over the entire surface portion of the particle at a temperature at which the cation mixing is less likely to occur. Furthermore, it is expected that the existence of the fluorine compound can improve corrosion resistance to hydrofluoric acid generated by decomposition of an electrolyte solution.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material of one embodiment of the present invention is preferably greater than or equal to 0.001 times and less than or equal to 0.1 times, further preferably greater than 0.01 times and less than 0.04 times, still further preferably approximately 0.02 times the number of atoms of the metal M. The magnesium concentration described here may be a value obtained by element analysis on all the particles of the positive electrode active material using ICP-MS or the like, or may be a value based on the ratio of the raw materials mixed in the forming process of the positive electrode active material, for example.

As a metal other than cobalt (hereinafter, the metal Z), one or more metals selected from nickel, aluminum, manganese, titanium, vanadium, and chromium may be added to lithium cobalt oxide, for example, and in particular, one or both of nickel and aluminum are preferably added. In some cases, manganese, titanium, vanadium, and chromium are stable when having a valence of four, and thus highly contribute to structure stability. The addition of the metal Z may enable the positive electrode active material of one embodiment of the present invention to have a more stable crystal structure in a high-voltage charged state, for example. Here, in the positive electrode active material of one embodiment of the present invention, the metal Z is preferably added at a concentration that does not greatly change the crystallinity of lithium cobalt oxide. For example, the metal Z is preferably added at such an amount with which the aforementioned Jahn-Teller effect or the like is not exhibited.

As shown in introductory remarks in FIG. 22, aluminum and the transition metal typified by nickel and manganese preferably exist in cobalt sites, but part of them may exist in lithium sites. Magnesium preferably exists in lithium sites. Fluorine may be substituted for part of oxygen.

As the magnesium concentration in the positive electrode active material of one embodiment of the present invention increases, the capacity of the positive electrode active material decreases in some cases. As an example, one possible reason is that the amount of lithium that contributes to charging and discharging decreases when magnesium enters the lithium sites. Another possible reason is that excess magnesium generates a magnesium compound that does not contribute to charging and discharging. When the positive electrode active material of one embodiment of the present invention contains nickel as the metal Z in addition to magnesium, the capacity per weight and per volume can be increased in some cases. When the positive electrode active material of one embodiment of the present invention contains aluminum as the metal Z in addition to magnesium, the capacity per weight and per volume can be increased in some cases. When the positive electrode active material of one embodiment of the present invention contains nickel and aluminum in addition to magnesium, the capacity per weight and per volume can be increased in some cases.

The concentrations of the elements contained in the positive electrode active material of one embodiment of the present invention, such as magnesium and the metal Z, are described below using the number of atoms.

The number of nickel atoms in the positive electrode active material of one embodiment of the present invention is preferably 10 % or less, further preferably 7.5 % or less, still further preferably 0.05 % or more and 4 % or less, yet still further preferably 0.1 % or more and 2 % or less of the number of cobalt atoms. The nickel concentration described here may be a value obtained by element analysis on all the particles of the positive electrode active material using ICP-MS or the like, or may be a value based on the ratio of the raw materials mixed in the process of forming the positive electrode active material, for example.

When a state being charged with high voltage is held for a long time, the constitution element of the positive electrode active material dissolves in an electrolyte solution, and the crystal structure might be broken. However, when nickel is included at the above-described proportion, dissolution of the constitution element from the positive electrode active material can be inhibited in some cases.

The number of aluminum atoms in the positive electrode active material of one embodiment of the present invention is preferably 0.05 % or more and 4 % or less, further preferably 0.1 % or more and 2 % or less of the number of cobalt atoms. The aluminum concentration described here may be a value obtained by element analysis on all the particles of the positive electrode active material using ICP-MS or the like, or may be a value based on the ratio of the raw materials mixed in the process of forming the positive electrode active material, for example.

In the case where the electrolyte solution contains LiPF₆, hydrogen fluoride may be generated by hydrolysis. In some cases, hydrogen fluoride is generated by the reaction of PVDF used as a component of the positive electrode and alkali. The decrease in hydrogen fluoride concentration in the electrolyte solution can inhibit corrosion and/or coating film separation of a current collector in some cases. Furthermore, the decrease in hydrogen fluoride concentration in the electrolyte solution can inhibit a reduction in adhesion properties due to gelling and/or insolubilization of PVDF in some cases.

When containing magnesium, the positive electrode active material of one embodiment of the present invention is extremely stable in a high-voltage charged state. When the positive electrode active material of one embodiment of the present invention contains phosphorus, the number of phosphorus atoms is preferably 1 % or more and 20 % or less, further preferably 2 % or more and 10 % or less, still further preferably 3 % or more and 8 % or less of the number of cobalt atoms. In addition, the number of magnesium atoms is preferably 0.1 % or more and 10 % or less, further preferably 0.5 % or more and 5 % or less, still further preferably 0.7 % or more and 4 % or less of the number of cobalt atoms. The phosphorus concentration and the magnesium concentration described here may each be a value obtained by element analysis on all the particles of the positive electrode active material using ICP-MS or the like, or may be a value based on the ratio of the raw materials mixed in the process of manufacturing the positive electrode active material, for example.

In the case where the positive electrode active material has a crack, phosphorus, more specifically, a compound containing phosphorus and oxygen, in the inner portion of the crack may inhibit crack development, for example.

### Surface Portion

Magnesium is preferably distributed over the entire surface portion of the particle of the positive electrode active material of one embodiment of the present invention, and further preferably, the magnesium concentration in a surface portion a is higher than the average in the whole particle. For example, the magnesium concentration in the surface portion that is measured by XPS or the like is preferably higher than the average magnesium concentration in all the particles measured by ICP-MS or the like.

In the case where the positive electrode active material of one embodiment of the present invention contains an element other than cobalt, for example, one or more metals selected from nickel, aluminum, manganese, iron, and chromium, the concentration of the metal in the vicinity of the particle surface is preferably higher than the average concentration of the metal in the whole particle. For example, the concentration of the element other than cobalt in the surface portion measured by XPS or the like is preferably higher than the average concentration of the element in all the particles measured by ICP-MS or the like.

The surface of the particle is a kind of crystal defects and lithium is extracted from the surface during charging; thus, the lithium concentration in the surface of the particle tends to be lower than that inside the particle. Therefore, the surface portion tends to be unstable and its crystal structure is likely to be broken. The higher the magnesium concentration in the surface portion is, the more effectively the change in the crystal structure can be inhibited. In addition, when the magnesium concentration in the surface portion is high, it is expected that the corrosion resistance to hydrofluoric acid generated by the decomposition of the electrolyte solution is improved.

In addition, the concentration of halogen such as fluorine in the surface portion of the positive electrode active material of one embodiment of the present invention is preferably higher than the average concentration in the whole particle. When halogen exists in the surface portion that is a region in contact with an electrolyte solution, the corrosion resistance to hydrofluoric acid can be effectively improved.

In this manner, the surface portion of the positive electrode active material of one embodiment of the present invention preferably has higher concentrations of additives such as magnesium and fluorine than those in the inner portion and a composition different from that in the inner portion. In addition, the composition preferably has a crystal structure stable at normal temperature. Thus, the surface portion may have a crystal structure different from that of the inner portion. For example, at least part of the surface portion a of the positive electrode active material of one embodiment of the present invention may have a rock-salt crystal structure. Furthermore, in the case where the surface portion and the inner portion have different crystal structures, the orientations of crystals in the surface portion and the inner portion are preferably substantially aligned.

Anions of a layered rock-salt crystal and anions of a rock-salt crystal have a cubic close-packed structure (face-centered cubic lattice structure). Anions of an O3′ type crystal are also presumed to form a cubic close-packed structure. Note that in this specification and the like, a structure is referred to as cubic close-packed when three layers of anions are shifted and stacked like “ABCABC” in the structure. Accordingly, anions do not necessarily form a cubic lattice structure. At the same time, actual crystals always have a defect and thus, analysis results are not necessarily consistent with the theory. For example, in electron diffraction or FFT (fast Fourier transform) of a TEM image or the like, a spot may appear in a position slightly different from a theoretical position. For example, anions may be regarded as forming a cubic close-packed structure when a difference in orientation from a theoretical position is 5° or less or 2.5° or less.

When a layered rock-salt crystal and a rock-salt crystal are in contact with each other, there is a crystal plane at which orientations of cubic close-packed structures composed of anions are aligned with each other.

The description can also be made as follows. Anions on the (111) plane of a cubic crystal structure has a triangular arrangement. A layered rock-salt structure, which belongs to a space group R-3m and is a rhombohedral structure, is generally represented by a composite hexagonal lattice for easy understanding of the structure, and the (0001) plane of the layered rock-salt structure has a hexagonal lattice. The triangular lattice on the (111) plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other.”

Note that a space group of the layered rock-salt crystal and the O3′ type crystal is R-3m, which is different from the space group Fm-3m of a rock-salt crystal (a space group of a general rock-salt crystal) and the space group Fd-3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, a state where the orientations of the cubic close-packed structures composed of anions in the layered rock-salt crystal, the O3′ type crystal, and the rock-salt crystal are aligned with each other is referred to as a state where crystal orientations are substantially aligned with each other in some cases.

The orientations of crystals in two regions being substantially aligned with each other can be judged, for example, from a TEM (transmission electron microscope) image, a STEM (scanning transmission electron microscope) image, a HAADF-STEM (high-angle annular dark-field scanning transmission electron microscope) image, an ABF-STEM (annular bright-field scanning transmission electron microscope) image, or the like. X-ray diffraction (XRD), electron diffraction, neutron diffraction, and the like can also be used for judging. When the crystal orientations are substantially aligned with each other, a state where an angle between the orientations of lines in each of which cations and anions are alternately arranged is less than or equal to 5°, preferably less than or equal to 2.5° is observed from a TEM image and the like. Note that in a TEM image and the like, a light element typified by oxygen or fluorine cannot be clearly observed in some cases; in such a case, alignment of orientations can be judged by arrangement of metal elements.

Only with the structure where the surface portion includes only MgO or MgO and CoO(II) form a solid solution, it is difficult to insert and extract lithium. Thus, the surface portion should contain at least cobalt, and further contain lithium in the discharged state to have a path through which lithium is inserted and extracted. The cobalt concentration is preferably higher than the magnesium concentration.

### Particle Diameter

Too large a particle diameter of the positive electrode active material of one embodiment of the present invention causes problems such as difficulty in lithium diffusion and too much surface roughness of an active material layer in coating to a current collector. By contrast, too small a particle diameter causes problems such as difficulty in supporting the active material layer at the time when the material is applied to the current collector and overreaction with the electrolyte solution. Therefore, an average particle diameter (D50, also referred to as median diameter) is preferably more than or equal to 1 µm and less than or equal to 100 µm, further preferably more than or equal to 2 µm and less than or equal to 40 µm, still further preferably more than or equal to 5 µm and less than or equal to 30 µm.

### Analysis Method

Whether or not a positive electrode active material is the positive electrode active material of one embodiment of the present invention that has an O3′ type crystal structure when charged with high voltage can be determined by analyzing a high-voltage charged positive electrode using XRD, electron diffraction, neutron diffraction, electron spin resonance (ESR), nuclear magnetic resonance (NMR), or the like. The XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode obtained by disassembling a secondary battery can be measured without any change with sufficient accuracy, for example.

As described above, the positive electrode active material of one embodiment of the present invention features a small change in the crystal structure between a high-voltage charged state and a discharged state. A material where 50 wt% or more of the crystal structure largely changes between the high-voltage charged state and the discharged state is not preferable because the material can withstand neither high-voltage charging nor high-voltage discharging. It should be noted that the intended crystal structure is not obtained in some cases only by addition of the additive. For example, although the positive electrode active material that is lithium cobalt oxide containing magnesium and fluorine is a commonality, the positive electrode active material has the O3′ type crystal structure at 60 wt% or more in some cases, and has the H1-3 type crystal structure at 50 wt% or more in other cases, when charged with a high voltage. Furthermore, at a predetermined charge voltage, the positive electrode active material has the O3′ type crystal structure at almost 100 wt%, and with an increase in the predetermined voltage, the H1-3 type crystal structure is generated in some cases. Thus, to determine whether or not a positive electrode active material is the positive electrode active material of one embodiment of the present invention, the crystal structure should be analyzed by XRD and other methods.

Note that a positive electrode active material in the high-voltage charged state or the discharged state sometimes causes a change in the crystal structure when exposed to air. For example, the O3′ type crystal structure changes into the H1-3 type crystal structure in some cases. For that reason, all samples are preferably handled in an inert atmosphere such as an argon atmosphere.

### Charging Method

High-voltage charging for determining whether or not a composite oxide is the positive electrode active material of one embodiment of the present invention can be performed on a coin cell (CR2032 type with a diameter of 20 mm and a height of 3.2 mm) with a lithium counter electrode, for example.

More specifically, a positive electrode can be formed by application of a slurry in which the positive electrode active material, a conductive agent, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) at EC:DEC = 3:7 (volume ratio) and vinylene carbonate (VC) at 2 wt% are mixed can be used.

As a separator, 25 \-µm-thick polypropylene can be used.

Stainless steel (SUS) can be used for a positive electrode can and a negative electrode can.

The coin cell fabricated under the above conditions is subjected to constant current charging at 4.6 V and 0.5 C and then constant voltage charging until the current value reaches 0.01 C. Note that here, 1 C is set to 137 mA/g. The temperature is set to 25° C. After the charging is performed in this manner, the coin cell is disassembled in a glove box with an argon atmosphere to take out the positive electrode, whereby the positive electrode active material charged with high voltage can be obtained. In order to inhibit a reaction with components in the external environment, the taken positive electrode is preferably enclosed in an argon atmosphere in performing various analyses later. For example, XRD can be performed on the positive electrode enclosed in an airtight container with an argon atmosphere.

### Xrd

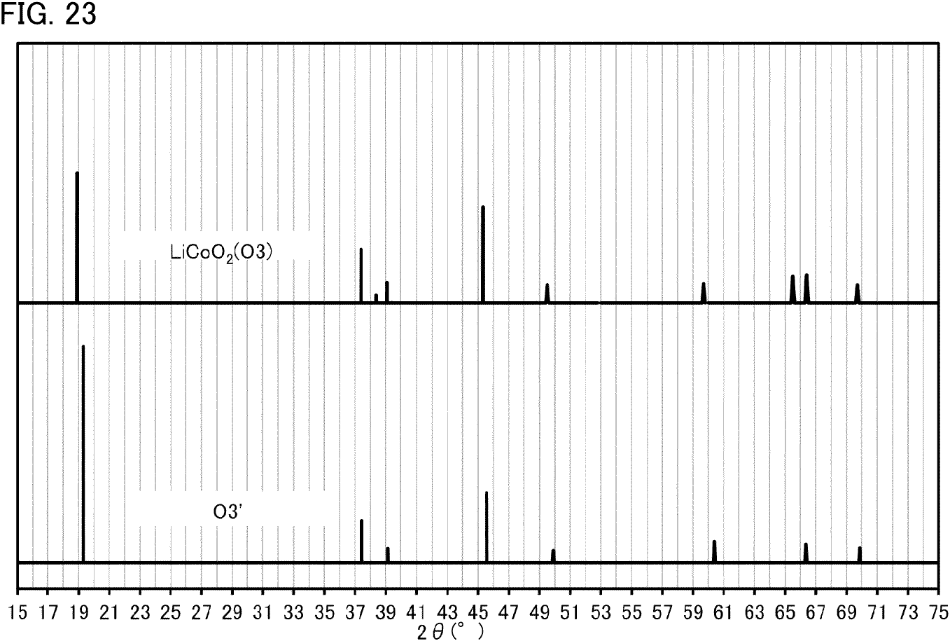

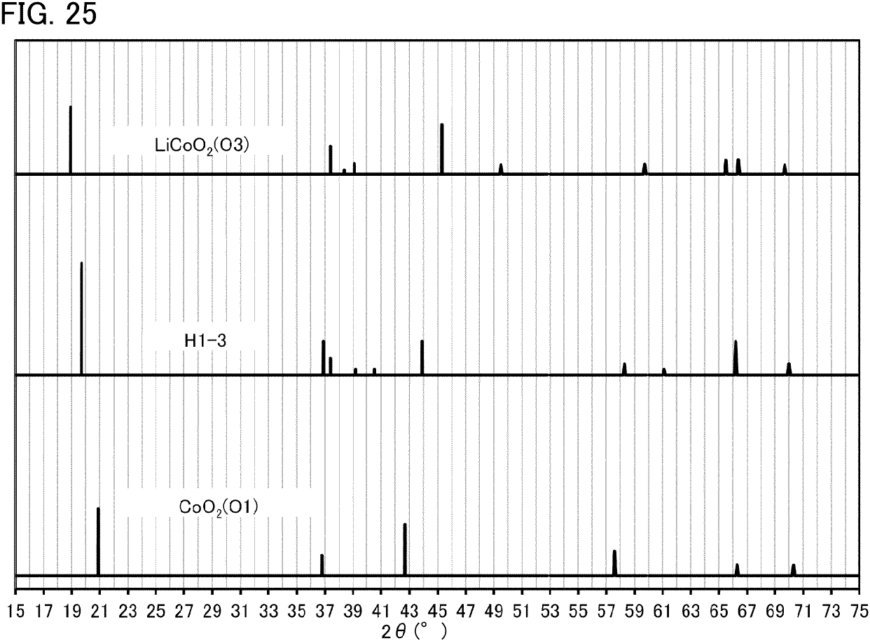

FIG. 23 and FIG. 25 show ideal powder XRD patterns with CuKα1 radiation that are calculated from models of the O3′ type crystal structure and the H1-3 type crystal structure. For comparison, ideal XRD patterns calculated from the crystal structure of LiCoO₂ (O3) with a charge depth of 0 and the crystal structure of CoO₂ (O1) with a charge depth of 1 are also shown. Note that the patterns of LiCoO₂ (O3) and CoO₂ (O1) are made from crystal structure data obtained from ICSD (Inorganic Crystal Structure Database) using Reflex Powder Diffraction, which is a module of Materials Studio (BIOVIA). The range of 2θ is from 15° to 75°, the step size is 0.01, the wavelength λ1 is 1.540562 × 10⁻¹⁰ m, the wavelength 12 is not set, and a single monochromator is used. The pattern of the H1-3 type crystal structure is similarly formed from the above-described crystal structure data of the H1-3 type crystal structure. The pattern of the O3′ type crystal structure is estimated from the XRD pattern of the positive electrode active material of one embodiment of the present invention, the crystal structure is fitted with TOPAS ver. 3 (crystal structure analysis software manufactured by Bruker Corporation), and XRD patterns are made in a manner similar to those of other structures.

As shown in FIG. 23, the O3′ type crystal structure exhibits diffraction peaks at 2θ of 19.30±0.20° (greater than or equal to 19.10° and less than or equal to 19.50°) and 2θ of 45.55±0.10° (greater than or equal to 45.45° and less than or equal to 45.65°). More specifically, sharp diffraction peaks appear at 2θ of 19.30±0.10° (greater than or equal to 19.20° and less than or equal to 19.40°) and 2θ of 45.55±0.05° (greater than or equal to 45.50° and less than or equal to 45.60). By contrast, as shown in FIG. 25, the H1-3 type crystal structure and CoO₂ (P-3ml, O1) do not exhibit peaks at these positions. Thus, the peaks at 2θ of 19.30±0.20° and 2θ of 45.55±0.10° in a high-voltage charged state can be the features of the positive electrode active material of one embodiment of the present invention.

It can be said that the positions of the XRD diffraction peaks exhibited by the crystal structure with a charge depth of 0 are close to those of the XRD diffraction peaks exhibited by the crystal structure at the time of high-voltage charging. More specifically, it can be said that a difference in the positions of two or more, preferably three or more of the main diffraction peaks between the crystal structures is 2θ= 0.7 or less, preferably 2θ= 0.5 or less.

Although the positive electrode active material of one embodiment of the present invention has the O3′ type crystal structure at the time of high-voltage charging, not all the particles necessarily have the O3′ type crystal structure. Some of the particles may have another crystal structure or be amorphous. Note that when the XRD patterns are analyzed by the Rietveld analysis, the O3′ type crystal structure preferably accounts for more than or equal to 50 wt%, further preferably more than or equal to 60 wt%, and still further preferably more than or equal to 66 wt%. The positive electrode active material in which the O3′ type crystal structure accounts for more than or equal to 50 wt%, further preferably more than or equal to 60 wt%, still further preferably more than or equal to 66 wt% can have sufficiently good cycle performance.

Furthermore, even after 100 or more cycles of charging and discharging after the measurement starts, the O3′ type crystal structure preferably accounts for more than or equal to 35 wt%, further preferably more than or equal to 40 wt%, still further preferably more than or equal to 43 wt% when the Rietveld analysis is performed.

The crystallite size of the O3′ type crystal structure included in the positive electrode active material particle does not decrease to less than approximately one-tenth that of LiCoO₂ (O3) in the discharged state. Thus, a clear peak of the O3′ type crystal structure can be observed after the high-voltage charging even under the same XRD measurement conditions as those of a positive electrode before charging and discharging. In contrast, simple LiCoO₂ has a small crystallite size and a broad small peak even when it can have a structure part of which is similar to the O3′ type crystal structure. The crystallite size can be calculated from the half width of the XRD peak.

As described above, the influence of the Jahn-Teller effect is preferably small in the positive electrode active material of one embodiment of the present invention. It is preferable that the positive electrode active material of one embodiment of the present invention have a layered rock-salt crystal structure and mainly contain cobalt as a transition metal. The positive electrode active material of one embodiment of the present invention may contain the above-described metal Z in addition to cobalt as long as the influence of the Jahn-Teller effect is small.

### Manufacturing Method of Positive Electrode Active Material

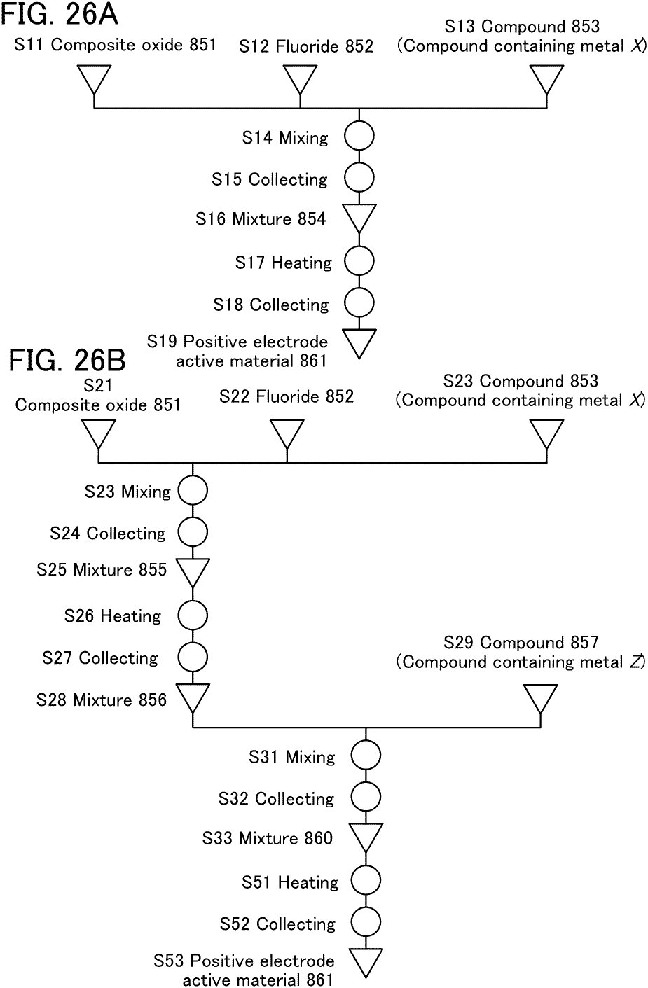

Next, an example of a manufacturing method of LiMO₂, which is one embodiment of a material that can be used as the positive electrode active material, is described with reference to FIG. 26A and FIG. 26B. Any of the metals described above can be used as the metal M. The above-described metal X and/or metal Z can be contained in addition to the metal M. In particular, magnesium is preferably used as the metal X. Nickel and aluminum are preferably used as the metal Z. A cobalt-containing material in which the metal X is Mg is described as an example in FIG. 26A. A cobalt-containing material in which the metal X is Mg and the metal Z is nickel and aluminum is described as an example in FIG. 26B. Note that the positive electrode active material of one embodiment of the present invention has a crystal structure of the lithium composite oxide represented by LiMO₂, but the composition is not limited to Li:M:O = 1:1:2.

First, in Step S11, a composite oxide containing lithium, a transition metal, and oxygen is used as a composite oxide 851. Here, one or more transition metals including cobalt are preferably used as the metal M.

The composite oxide containing lithium, a transition metal, and oxygen can be synthesized by heating a lithium source and a transition metal source in an oxygen atmosphere. As the transition metal source, a metal that can form, together with lithium, a layered rock-salt composite oxide belonging to the space group R-3m is preferably used. For example, at least one of manganese, cobalt, and nickel can be used. Aluminum may be used in addition to these transition metals. That is, as the transition metal source, only a cobalt source may be used; only a nickel source may be used; two types of cobalt and manganese sources or two types of cobalt and nickel sources may be used; or three types of cobalt, manganese, and nickel sources may be used. Furthermore, an aluminum source may be used in addition to these metal sources. The heating temperature at this time is preferably higher than a temperature in Step S17 described later. For example, the heating can be performed at 1000° C. This heating step is referred to as baking in some cases.

In the case where a composite oxide containing lithium, a transition metal, and oxygen that is synthesized in advance is used, a composite oxide with few impurities is preferably used. In this specification and the like, lithium, cobalt, nickel, manganese, aluminum, and oxygen are the main components of the composite oxide containing lithium, a transition metal, and oxygen, the cobalt-containing material, and the positive electrode active material, and elements other than the main components are regarded as impurities. For example, when analyzed with a glow discharge mass spectroscopy method, the total impurity concentration is preferably less than or equal to 10,000 ppmw (parts per million weight), further preferably less than or equal to 5000 ppmw. In particular, the total impurity concentration of transition metals such as titanium and arsenic is preferably less than or equal to 3000 ppmw, further preferably less than or equal to 1500 ppmw.

For example, as lithium cobalt oxide synthesized in advance, lithium cobalt oxide particles (product name: CELLSEED C-10N) formed by NIPPON CHEMICAL INDUSTRIAL CO., LTD. can be used. This is lithium cobalt oxide in which the average particle diameter (D50) is approximately 12 µm, and in the impurity analysis by a glow discharge mass spectroscopy method (GD-MS), the magnesium concentration and the fluorine concentration are less than or equal to 50 ppmw, the calcium concentration, the aluminum concentration, and the silicon concentration are less than or equal to 100 ppmw, the nickel concentration is less than or equal to 150 ppmw, the sulfur concentration is less than or equal to 500 ppmw, the arsenic concentration is less than or equal to 1100 ppmw, and the concentrations of elements other than lithium, cobalt, and oxygen are less than or equal to 150 ppmw.

The composite oxide 851 in Step S11 preferably has a layered rock-salt crystal structure with few defects and distortions. Therefore, the composite oxide is preferably a composite oxide with few impurities. In the case where the composite oxide containing lithium, the transition metal, and oxygen includes a large number of impurities, the crystal structure is highly likely to have a large number of defects or distortions.

Furthermore, a fluoride 852 is prepared in Step S12. As the fluoride, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), or sodium aluminum hexafluoride (Na₃AlF₆) can be used. As the fluoride 852, any material that functions as a fluorine source can be used. Thus, in place of the fluoride 852 or as part thereof, fluorine (F₂), carbon fluoride, sulfur fluoride, oxygen fluoride (OF₂, O₂F₂, O₃F₂, O₄F₂, or O₂F), or the like may be used and mixed in an atmosphere.

In the case where the fluoride 852 is a compound containing the metal X, a compound 853 (a compound containing the metal X) to be described later can also serve as the fluoride 852.

In this embodiment, lithium fluoride (LiF) is prepared as the fluoride 852. LiF is preferable because it has a cation common with LiCoO₂. LiF, which has a relatively low melting point of 848° C., is preferable because it is easily melted in an annealing process described later.

In the case where LiF is used as the fluoride 852, the compound 853 (the compound containing the metal X) is preferably prepared in addition to the fluoride 852 in Step S13. The compound 853 is the compound containing the metal X.

In Step S13, the compound 853 is prepared. As the compound 853, a fluoride, an oxide, a hydroxide, or the like of the metal X can be used, and in particular, a fluoride is preferably used.

In the case where magnesium is used as the metal X, MgF₂ or the like can be used as the compound 853. Magnesium can be distributed in the vicinity of the surface of the cobalt-containing material at a high concentration.

In addition to the fluoride 852 and the compound 853, a material containing a metal that is neither cobalt nor the metal X may be used as the metal Z. As the material containing the metal Z, a nickel source, a manganese source, an aluminum source, an iron source, a vanadium source, a chromium source, a niobium source, a titanium source, or the like can be mixed, for example. For example, a hydroxide, a fluoride, an oxide, or the like of each metal is preferably pulverized and mixed. The pulverization can be performed by a wet method, for example.

The sequence of Step S11, Step S12, and Step S13 may be freely determined.

Next, in Step S14, the materials prepared in Step S11, Step S12, and Step S13 are mixed and ground. Although the mixing can be performed by a dry method or a wet method, a wet method is preferable because the materials can be ground to a smaller size. When the mixing is performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, acetone is used.

For example, a ball mill, a bead mill, or the like can be used for the mixing. When a ball mill is used, zirconia balls are preferably used as media, for example. The mixing and grinding steps are preferably performed sufficiently to pulverize a mixture 854.

The materials mixed and ground in the above manner are collected in Step S15, whereby the mixture 854 is obtained in Step S16.

For example, the D50 of the mixture 854 is preferably greater than or equal to 600 nm and less than or equal to 20 µm, further preferably greater than or equal to 1 µm and less than or equal to 10 µm.

The temperature is further preferably higher than or equal to the temperature at which the mixture 854 melts. The annealing temperature is preferably lower than or equal to a decomposition temperature of LiCoO₂ (1130° C.).

LiF is used as the fluoride 852 and the annealing in S16 is performed with a lid put on, whereby a positive electrode active material 861 with favorable cycle performance and the like can be manufactured. It is considered that when LiF and MgF₂ are used as the fluoride 852, the reaction with LiCoO₂ is promoted with the annealing temperature in S16 set to higher than or equal to 742° C. to generate LiMO₂ because the eutectic point of LiF and MgF₂ is around 742° C.

Furthermore, an endothermic peak of LiF, MgF₂, and LiCoO₂ is observed at around 820° C. by differential scanning calorimetry (DSC measurement). Thus, the annealing temperature is preferably higher than or equal to 742° C., further preferably higher than or equal to 820° C.

Accordingly, the annealing temperature is preferably higher than or equal to 742° C. and lower than or equal to 1130° C., further preferably higher than or equal to 742° C. and lower than or equal to 1000° C. Moreover, the annealing temperature is preferably higher than or equal to 820° C. and lower than or equal to 1130° C., further preferably higher than or equal to 820° C. and lower than or equal to 1000° C.

In this embodiment, LiF, which is a fluoride, is considered to function as flux. Accordingly, since the capacity of the heating furnace is larger than the capacity of the container and LiF is lighter than oxygen, it is expected that LiF is volatilized and the reduction of LiF in the mixture 854 inhibits generation of LiMO₂. Therefore, heating needs to be performed while volatilization of LiF is inhibited.

Thus, when the mixture 854 is heated in an atmosphere including LiF, that is, the mixture 854 is heated in a state where the partial pressure of LiF in the heating furnace is high, volatilization of LiF in the mixture 854 is inhibited. By performing annealing using the fluoride (LiF or MgF) to form an eutectic mixture with the lid put on, the annealing temperature can be lowered to the decomposition temperature of LiCoO₂ (1130° C.) or lower, specifically, a temperature higher than or equal to 742° C. and lower than or equal to 1000° C., thereby enabling the generation of LiMO₂ to progress efficiently. Accordingly, a cobalt-containing material having favorable characteristics can be formed, and the annealing time can be reduced.

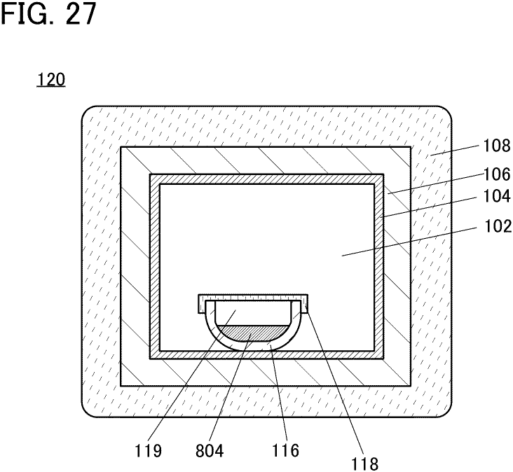

FIG. 27 illustrates an example of the annealing method in S17.

A heating furnace 120 illustrated in FIG. 27 includes a space 102 in the heating furnace, a hot plate 104, a heater unit 106, and a heat insulator 108. It is further preferable to put a lid 118 on a container 116 in annealing. With this structure, an atmosphere including a fluoride can be obtained in a space 119 enclosed by the container 116 and the lid 118. In the annealing, the state of the space 119 is maintained with the lid put on so that the concentration of the gasified fluoride inside the space 119 can be constant or cannot be reduced, in which case fluorine or magnesium can be contained in the vicinity of the particle surface. The atmosphere including a fluoride can be provided in the space 119, which is smaller in capacity than the space 102 in the heating furnace, by volatilization of a smaller amount of a fluoride. This means that an atmosphere including a fluoride can be provided in the reaction system without a significant reduction in the amount of a fluoride included in the mixture 854. Accordingly, LiMO₂ can be produced efficiently. In addition, the use of the lid 118 allows the annealing of the mixture 854 in an atmosphere including a fluoride to be simply and inexpensively performed.

Here, the valence number of Co (cobalt) in LiMO₂ formed according to one embodiment of the present invention is preferably approximately 3. The valence number of cobalt can be 2 or 3. Thus, to inhibit reduction of cobalt, it is preferable that the atmosphere in the space 102 in the heating furnace include oxygen, further preferable that the ratio of oxygen to nitrogen in the atmosphere in the space 102 in the heating furnace be higher than or equal to that in the air atmosphere, and still further preferable that the oxygen concentration in the atmosphere in the space 102 in the heating furnace be higher than or equal to that in the air atmosphere. Thus, an atmosphere including oxygen needs to be introduced into the space in the heating furnace. Note that since bivalent cobalt atoms existing near magnesium atoms are likely to be stable, not all the cobalt atoms may be trivalent.

Thus, in one embodiment of the present invention, before heating is performed, a step of providing an atmosphere including oxygen in the space 102 in the heating furnace and a step of placing the container 116 in which the mixture 854 is placed in the space 102 in the heating furnace are performed. The steps in this order enable the mixture 854 to be annealed (heated) in an atmosphere including oxygen and a fluoride. During the annealing, the space 102 in the heating furnace is preferably sealed to prevent any gas from being discharged to the outside. For example, it is preferable that no gas flows during the annealing.

Although there is no particular limitation on the method of providing an atmosphere including oxygen in the space 102 in the heating furnace, examples are a method of introducing an oxygen gas or a gas containing oxygen such as dry air after exhausting air from the space 102 in the heating furnace and a method of flowing an oxygen gas or a gas containing oxygen such as dry air into the space 102 in the heating furnace for a certain period of time. In particular, introducing an oxygen gas after exhausting air from the space 102 in the heating furnace (oxygen displacement) is preferably performed. Note that the atmosphere of the space 102 in the heating furnace may be regarded as an atmosphere including oxygen.

When the lid 118 is put on the container 116, an atmosphere containing oxygen is provided, and then heating is performed, an appropriate amount of oxygen enters the container 116 through a gap of the lid 118 put on the container 116 and an appropriate amount of fluoride can be kept within the container 116.

Furthermore, the fluoride or the like attached to inner walls of the container 116 and the lid 118 is likely to be fluttered again by the heating and attached to the mixture 854.

The heating in Step S17 is preferably performed at an appropriate temperature for an appropriate time. The appropriate temperature and time change depending on the conditions such as the particle size and the composition of the composite oxide 851 in Step S11. In the case where the particle size is small, the heating is preferably performed at a lower temperature or for a shorter time than heating in the case where the particle size is large, in some cases. After the heating in S17, a step of removing the lid is performed.

For example, in the case where the average particle diameter (D50) of particles in Step S11 is approximately 12 µm, the annealing time is preferably 3 hours or longer, further preferably 10 hours or longer.

By contrast, in the case where the average particle diameter (D50) of particles in Step S11 is approximately 5 µm, the annealing time is preferably longer than or equal to 1 hour and shorter than or equal to 10 hours, further preferably approximately 2 hours, for example.

The temperature decreasing time after the annealing is, for example, preferably longer than or equal to 10 hours and shorter than or equal to 50 hours.

Then, the materials annealed in the above manner are collected in Step S18, whereby the positive electrode active material 861 is obtained in Step S19.

FIG. 26B illustrates a manufacturing procedure of the cobalt-containing material in which the metal X is Mg and the metal Z is nickel and aluminum. Step S21 to Step S29 in FIG. 26B can be similar to Step S11 to Step S19 in FIG. 26A. That is, the positive electrode active material 861 in FIG. 26A can be used as the mixture 856 in Step S29 in FIG. 26B.

Next, in Step S23, a compound 857 (a compound containing the metal Z) is prepared.

As a nickel source contained in the compound 857, a compound containing nickel is preferably used. Nickel oxide, nickel hydroxide, nickel carbonate, or the like can be used as the compound containing nickel, for example.

As an aluminum source contained in the compound 857, a compound containing aluminum is preferably used. Aluminum hydroxide, aluminum oxide, aluminum sulfate, aluminum chloride, aluminum nitrate, or a hydrate thereof can be used as the compound containing aluminum, for example. Alternatively, aluminum alkoxide or an organoaluminum complex may be used as the compound containing aluminum. Further alternatively, organic acid of aluminum such as aluminum acetate, or a hydrate thereof may be used as the compound containing aluminum.

As the compound 857 in Step S23, for example, nickel hydroxide and aluminum hydroxide each ground by a wet method are preferably prepared. The above method described in Step S14 can be used for the condition of grinding by a wet method.

Next, in Step S31, the mixture 856 and the compound 857 are mixed and ground.

Next, in Step S32, the materials mixed and ground in the above manner are collected, whereby a mixture 860 is obtained in Step S33. Then, heating is performed in Step S51 and the heated materials are collected (S52), whereby the positive electrode active material 861 is obtained in Step S53. The heating temperature in Step S51 is lower than the heating temperature in S26.

Although the same reference numeral is used for the positive electrode active material 861 obtained through the procedure shown in FIG. 26A and the positive electrode active material 861 obtained through the procedure shown in FIG. 26B, these materials cannot be regarded as the same materials in some cases depending on the used materials, the heating conditions, and the like.

When the positive electrode active material 861 obtained in S19 is used instead of the composite oxide 851 in Step S21, a metal or an oxide thereof can be attached to the outer surface of the positive electrode active material 861 obtained in S19. For example, zirconium oxide can be attached to the positive electrode active material 861 containing cobalt and magnesium. Note that there is a case where a core-shell structure is formed by combining the above methods.

### Electrolyte

In the case of using a liquid electrolyte layer for a secondary battery, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more thereof can be used in an appropriate combination at an appropriate ratio as the electrolyte layer, for example.

Alternatively, the use of one or more ionic liquids (room temperature molten salts) that are less likely to burn and volatize as the solvent of the electrolyte can prevent a secondary battery from exploding or catching fire even when the secondary battery internally shorts out or the internal temperature increases owing to overcharging or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

The secondary battery of one embodiment of the present invention includes, as a carrier ion, an alkali metal ion such as a sodium ion or a potassium ion or an alkaline earth metal ion such as a calcium ion, a strontium ion, a barium ion, a beryllium ion, or a magnesium ion.

In the case where lithium ions are used as carrier ions, the electrolyte contains lithium salt, for example. As the lithium salt, LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, or the like can be used, for example.

In addition, the electrolyte preferably contains fluorine. As the electrolyte containing fluorine, an electrolyte including one kind or two or more kinds of fluorinated cyclic carbonates and lithium ions can be used, for example. The fluorinated cyclic carbonate can improve the nonflammability of the electrolyte and improve the safety of the lithium-ion secondary battery.

As the fluorinated cyclic carbonate, an ethylene fluoride carbonate such as monofluoroethylene carbonate (fluoroethylene carbonate, FEC or F1EC), difluoroethylene carbonate (DFEC or F2EC), trifluoroethylene carbonate (F3EC), or tetrafluoroethylene carbonate (F4EC) can be used. Note that DFEC includes an isomer such as cis-4,5 or trans-4,5. For operation at low temperatures, it is important that a lithium ion is solvated by using one kind or two or more kinds of fluorinated cyclic carbonates as the electrolyte and is transported in the electrolyte included in the electrode in charging and discharging. When the fluorinated cyclic carbonate is not used as a small amount of additive but is allowed to contribute to transportation of a lithium ion in charging and discharging, operation can be performed at low temperatures. In the secondary battery, a cluster of approximately several to several tens of lithium ions moves.

The use of the fluorinated cyclic carbonate for the electrolyte can reduce desolvation energy that is necessary for the solvated lithium ion in the electrolyte of the electrode to enter an active material particle. The reduction in the desolvation energy facilitates insertion or extraction of a lithium ion into/from the active material even in a low-temperature range. Although a lithium ion sometimes moves remaining in the solvated state, a hopping phenomenon in which coordinated solvent molecules are interchanged occurs in some cases. When desolvation of a lithium ion becomes easy, movement owing to the hopping phenomenon is facilitated and the lithium ion may easily move. A decomposition product of the electrolyte generated by charging and discharging of the secondary battery clings to the surface of the active material, which might cause deterioration of the secondary battery. However, since the electrolyte containing fluorine is smooth, the decomposition product of the electrolyte is less likely to attach to the surface of the active material. Therefore, the deterioration of the secondary battery can be suppressed.

In some cases, a plurality of solvated lithium ions form a cluster in the electrolyte and the cluster moves in the negative electrode, between the positive electrode and the negative electrode, or in the positive electrode, for example.

An example of the fluorinated cyclic carbonate is shown below.

Monofluoroethylene carbonate (FEC) is represented by Formula (1) below.

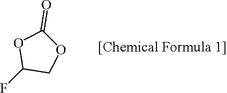

Tetrafluoroethylene carbonate (F4EC) is represented by Formula (2) below.

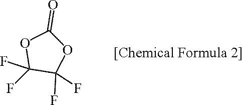

Difluoroethylene carbonate (DFEC) is represented by Formula (3) below.

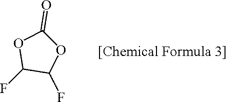

In this specification, an electrolyte is a general term of a solid material, a liquid material, a semi-solid-state material, and the like.

Deterioration is likely to occur at an interface existing in a secondary battery, e.g., an interface between an active material and an electrolyte. The secondary battery of one embodiment of the present invention includes the electrolyte containing fluorine, which can prevent deterioration that might occur at an interface between the active material and the electrolyte, typically, alteration of the electrolyte or a higher viscosity of the electrolyte. In addition, a structure may be employed in which a binder, a graphene compound, or the like clings to or is held by the electrolyte containing fluorine. This structure can maintain the state where the viscosity of the electrolyte is low, i.e., the state where the electrolyte is smooth, and can improve the reliability of the secondary battery. Note that DFEC to which two fluorine atoms are bonded and F4EC to which four fluorine atoms are bonded have lower viscosities, are smoother, and are coordinated to lithium more weakly than FEC to which one fluorine atom is bonded. Accordingly, it is possible to reduce attachment of a decomposition product with a high viscosity to an active material particle. When a decomposition product with a high viscosity is attached to or clings to an active material particle, a lithium ion is less likely to move at an interface between active material particles. The electrolyte containing fluorine that solvates lithium reduces generation of a decomposition product that is to be attached to the surface of the active material (the positive electrode active material or the negative electrode active material). Moreover, the use of the electrolyte containing fluorine can prevent attachment of a decomposition product, which can prevent generation and growth of a dendrite.

The use of the electrolyte containing fluorine as a main component is also a feature, and the amount of the electrolyte containing fluorine is higher than or equal to 5 volume%, or higher than or equal to 10 volume%, preferably higher than or equal to 30 volume% and lower than or equal to 100 volume%.

In this specification, a main component of an electrolyte occupies higher than or equal to 5 volume% of the whole electrolyte of a secondary battery. Here, “higher than or equal to 5 volume% of the whole electrolyte of a secondary battery” refers to the proportion in the whole electrolyte that is measured during manufacture of the secondary battery. In the case where a secondary battery is disassembled after manufactured, the proportions of a plurality of kinds of electrolytes are difficult to quantify, but it is possible to judge whether one kind of organic compound occupies higher than or equal to 5 volume% of the whole electrolyte.

With the use of the electrolyte containing fluorine, it is possible to provide a secondary battery that can operate in a wide temperature range, specifically, higher than or equal to -40° C. and lower than or equal to 150° C., preferably higher than or equal to -40° C. and lower than or equal to 85° C.

Furthermore, an additive such as vinylene carbonate, propane sultone (PS), tertbutylbenzene (TBB), lithium bis(oxalate)borate (LiBOB), or a dinitrile compound such as succinonitrile or adiponitrile may be added to the electrolyte. The concentration of the additive in the whole electrolyte is, for example, higher than or equal to 0.1 volume% and lower than 5 volume%.

The electrolyte may contain one or more of aprotic organic solvents such as γ-butyrolactone, acetonitrile, dimethoxyethane, and tetrahydrofuran, in addition to the above.

When a gelled high-molecular material is contained in the electrolyte, safety against liquid leakage and the like is improved. Typical examples of the gelled high-molecular material include a silicone gel, an acrylic gel, an acrylonitrile gel, a polyethylene oxide-based gel, a polypropylene oxide-based gel, and a gel of a fluorine-based polymer.

As the high-molecular material, for example, a polymer having a polyalkylene oxide structure, such as polyethylene oxide (PEO); PVDF; polyacrylonitrile; a copolymer containing any of them; and the like can be used. For example, PVDF-HFP, which is a copolymer of PVDF and hexafluoropropylene (HFP), can be used. The formed polymer may be porous.

Although the above structure is an example of a secondary battery using a liquid electrolyte, one embodiment of the present invention is not particularly limited thereto. For example, a semi-solid-state battery and an all-solid-state battery can be fabricated.

In this specification and the like, a layer provided between a positive electrode and a negative electrode is referred to as an electrolyte layer in both the case of a secondary battery using a liquid electrolyte and the case of a semi-solid-state battery. An electrolyte layer of a semi-solid-state battery is a layer formed by deposition, and can be distinguished from a liquid electrolyte layer.

In this specification and the like, a semi-solid-state battery refers to a battery in which at least one of an electrolyte layer, a positive electrode, and a negative electrode includes a semi-solid-state material. The semi-solid-state here does not mean that the proportion of the volume of a solid-state material is 50 %. The semi-solid-state means having properties of a solid, such as a small volume change, and also having some of properties close to those of a liquid, such as flexibility. A single material or a plurality of materials can be used as long as the above properties are satisfied. For example, a porous solid-state material infiltrated with a liquid material may be used.

In this specification and the like, a polymer electrolyte secondary battery refers to a secondary battery in which an electrolyte layer between a positive electrode and a negative electrode contains a polymer. Polymer electrolyte secondary batteries include a dry (or intrinsic) polymer electrolyte battery and a polymer gel electrolyte battery. A polymer electrolyte secondary battery may be referred to as a semi-solid-state battery.

A semi-solid-state battery fabricated using the negative electrode of one embodiment of the present invention is a secondary battery having high charge and discharge capacity. The semi-solid-state battery can have high charge and discharge voltages. In addition, a highly safe or reliable semi-solid-state battery can be provided.

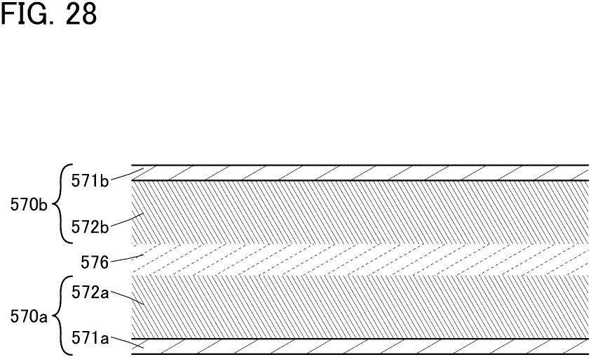

Here, an example in which a semi-solid-state battery is fabricated will be described with reference to FIG. 28.

FIG. 28 is a schematic cross-sectional view of a secondary battery of one embodiment of the present invention. The secondary battery of one embodiment of the present invention includes a negative electrode 570a and a positive electrode 570b. The negative electrode 570a includes at least a negative electrode current collector 571a and a negative electrode active material layer 572a formed in contact with the negative electrode current collector 571a, and the positive electrode 570b includes at least a positive electrode current collector 571b and a positive electrode active material layer 572b formed in contact with the positive electrode current collector 571b. The secondary battery includes an electrolyte 576 between the negative electrode 570a and the positive electrode 570b.

The electrolyte 576 contains a lithium-ion conductive polymer and a lithium salt.

In this specification and the like, the lithium-ion conductive polymer refers to a polymer having conductivity of cations such as lithium. More specifically, the lithium-ion conductive polymer is a high molecular compound containing a polar group to which cations can be coordinated. As the polar group, an ether group, an ester group, a nitrile group, a carbonyl group, siloxane, or the like is preferably included.

As the lithium-ion conductive polymer, for example, polyethylene oxide (PEO), a derivative containing polyethylene oxide as its main chain, polypropylene oxide, polyacrylic acid ester, polymethacrylic acid ester, polysiloxane, polyphosphazene, or the like can be used.

The lithium-ion conductive polymer may have a branched or cross-linking structure. Alternatively, the lithium-ion conductive polymer may be a copolymer. The molecular weight is preferably greater than or equal to ten thousand, further preferably greater than or equal to hundred thousand, for example.

In the lithium-ion conductive polymer, lithium ions move by changing polar groups to interact with, due to the local motion (also referred to as segmental motion) of polymer chains. In PEO, for example, lithium ions move by changing oxygen to interact with, due to the segmental motion of ether chains. When the temperature is close to or higher than the melting point or softening point of the lithium-ion conductive polymer, the crystal regions decrease and amorphous regions increase, so that the motion of the ether chains becomes active and the ion conductivity increases. Thus, in the case where PEO is used as the lithium-ion conductive polymer, charging and discharging are preferably performed at higher than or equal to 60° C.

According to the ionic radius of Shannon (Shannon et al., Acta A 32 (1976) 751.), the radius of a monovalent lithium ion is 0.590 Å in the case of tetracoordination, 0.76 Å in the case of hexacoordination, and 0.92 Å in the case of octacoordination. The radius of a bivalent oxygen ion is 1.35 Å in the case of bicoordination, 1.36 Å in the case of tricoordination, 1.38 Å in the case of tetracorrdination, 1.40 Å in the case of hexacoordination, and 1.42 Å in the case of octacoordination. The distance between polar groups included in adjacent lithium-ion conductive polymer chains is preferably greater than or equal to the distance that allows lithium ions and anions contained in the polar groups to exist stably while the above ionic radius is maintained. Furthermore, the distance between the polar groups is preferably close enough to cause interaction between the lithium ions and the polar groups. Note that the distance is not necessarily always kept constant because the segmental motion occurs as described above. The distance needs to be appropriate only when lithium ions are transferred.

As the lithium salt, for example, it is possible to use a compound containing lithium and at least one of phosphorus, fluorine, nitrogen, sulfur, oxygen, chlorine, arsenic, boron, aluminum, bromine, and iodine. For example, one of lithium salts such as LiPF₆, LiN(FSO₂)₂ (lithiumbis(fluorosulfonyl)imide, LiFSI), LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), LiN(C₂F₅SO₂)₂, and lithium bis(oxalate)borate (LiBOB) can be used, or two or more of these lithium salts can be used in an appropriate combination at an appropriate ratio.

It is particularly preferable to use LiFSI because favorable characteristics at low temperatures can be obtained. Note that LiFSI and LiTFSA are less likely to react with water than LiPF₆ or the like. This can relax the dew point control in fabricating an electrode and an electrolyte layer that use LiFSI. For example, the fabrication can be performed even in a normal air atmosphere, not only in an inert atmosphere of argon or the like in which moisture is excluded as much as possible or in a dry room in which a dew point is controlled. This is preferable because the productivity can be improved. When the segmental motion of ether chains is used for lithium conduction, it is particularly preferable to use a lithium salt that is highly dissociable and has a plasticizing effect, such as LiFSI and LiTFSA, in which case the operating temperature range can be wide.

In this specification and the like, a binder refers to a high molecular compound mixed only for binding an active material, a conductive agent, and the like onto a current collector. A binder refers to, for example, a rubber material such as poly vinylidene difluoride (PVDF), styrene-butadiene rubber (SBR), styrene-isoprene-styrene rubber, butadiene rubber, or ethylene-propylene-diene copolymer; or a material such as fluorine rubber, polystyrene, polyvinyl chloride, polytetrafluoroethylene, polyethylene, polypropylene, polyisobutylene, or an ethylene-propylene-diene polymer.

Since the lithium-ion conductive polymer is a high molecular compound, the active material and the conductive agent can be bound onto the current collector when the lithium-ion conductive polymer is sufficiently mixed in the active material layer. Thus, the electrode can be fabricated without a binder. A binder is a material that does not contribute to charge and discharge reactions. Thus, a smaller amount of the binder enables higher proportion of materials that contribute to charging and discharging, such as an active material and an electrolyte. As a result, the secondary battery can have higher discharge capacity, improved cycle performance, or the like.

When containing no or extremely little organic solvent, the secondary battery can be less likely to catch fire and ignite and thus can have higher level of safety, which is preferable. When the electrolyte 576 is an electrolyte layer containing no or extremely little organic solvent, the electrolyte layer can have enough strength and thus can electrically insulate the positive electrode from the negative electrode without a separator. Since a separator is not necessary, the secondary battery can have high productivity. When the electrolyte 576 is an electrolyte layer containing an inorganic filler, the secondary battery can have higher strength and higher level of safety.

The electrolyte layer is preferably dried sufficiently so that the electrolyte 576 can be an electrolyte layer containing no or extremely little organic solvent. In this specification and the like, the electrolyte layer can be regarded as being dried sufficiently when a change in the weight after drying at 90° C. under reduced pressure for one hour is within 5 %.

Note that materials contained in a secondary battery, such as a lithium-ion conductive polymer, a lithium salt, a binder, and an additive agent can be identified using nuclear magnetic resonance (NMR), for example. Analysis results of Raman spectroscopy, Fourier transform infrared spectroscopy (FT-IR), time-of-flight secondary ion mass spectrometry (TOF-SIMS), gas chromatography mass spectroscopy (GC/MS), pyrolysis gas chromatography mass spectroscopy (Py-GC/MS), liquid chromatography mass spectroscopy (LC/MS), or the like can also be used for the identification. Note that analysis by NMR or the like is preferably performed after the active material layer is subjected to suspension using a solvent to separate the active material from the other materials.

Moreover, in each of the above structures, a solid electrolyte material may be further contained in the negative electrode to increase incombustibility. As the solid electrolyte material, an oxide-based solid electrolyte is preferably used.

Examples of the oxide-based solid electrolyte are lithium composite oxides and lithium oxide materials such as LiPON, Li₂O, Li₂CO₃, Li₂MoO₄, Li₃PO₄, Li₃VO₄, Li₄SiO₄, LLT (La_{⅔}-ₓLi₃ₓTiO₃), and LLZ (Li₇La₃Zr₂O₁₂).

LLZ is a garnet-type oxide containing Li, La, and Zr and may be a compound containing Al, Ga, or Ta.

Alternatively, a polymer solid electrolyte such as PEO (polyethylene oxide) formed by an application method or the like may be used. Such a polymer solid electrolyte can also function as a binder; thus, in the case of using a polymer solid electrolyte, the number of components of the electrode can be reduced and the manufacturing cost can also be reduced.

This embodiment can be implemented in appropriate combination with any of the other embodiments.

### Embodiment 2

In this embodiment, an example of a secondary battery of one embodiment of the present invention is described.

### Structure Example of Secondary Battery

Hereinafter, a secondary battery in which a positive electrode, a negative electrode, and an electrolyte solution are wrapped in an exterior body is described as an example.

### Negative Electrode

The negative electrode described in the above embodiment can be used as the negative electrode.

### Current Collector

For each of a positive electrode current collector and a negative electrode current collector, it is possible to use a material which has high conductivity and is not alloyed with carrier ions such as lithium, e.g., a metal such as stainless steel, gold, platinum, zinc, iron, copper, aluminum, or titanium, an alloy thereof, or the like. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a sheet-like shape, a net-like shape, a punching-metal shape, an expanded-metal shape, or the like as appropriate. The current collector preferably has a thickness greater than or equal to 10 µm and less than or equal to 30 µm.

Note that a material that is not alloyed with carrier ions such as lithium is preferably used for the negative electrode current collector.

As the current collector, a titanium compound may be stacked over the above-described metal element. As a titanium compound, for example, it is possible to use one selected from titanium nitride, titanium oxide, titanium nitride in which oxygen is substituted for part of nitrogen, titanium oxide in which nitrogen is substituted for part of oxygen, and titanium oxynitride (TiOₓN_{y}, where 0 < x < 2 and 0 < y < 1), or a mixture or a stack of two or more of them. Titanium nitride is particularly preferable because it has high conductivity and has a high capability of inhibiting oxidation. Provision of a titanium compound over the surface of the current collector inhibits a reaction between a material contained in the active material layer formed over the current collector and the metal, for example. In the case where the active material layer contains a compound containing oxygen, an oxidation reaction between the metal element and oxygen can be inhibited. In the case where aluminum is used for the current collector and the active material layer is formed using graphene oxide described later, for example, an oxidation reaction between oxygen contained in the graphene oxide and aluminum might occur. In such a case, provision of a titanium compound over aluminum can inhibit an oxidation reaction between the current collector and graphene oxide.

### Positive Electrode

The positive electrode includes a positive electrode active material layer and the positive electrode current collector. The positive electrode active material layer includes a positive electrode active material, and may include a conductive agent and a binder. As the positive electrode active material, the positive electrode active material described in the above embodiment can be used.

For the conductive agent and the binder that can be included in the positive electrode active material layer, materials similar to those of the conductive agent and the binder that can be included in the negative electrode active material layer can be used.

### Separator

A separator is positioned between the positive electrode and the negative electrode. As the separator, for example, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably formed to have an envelope-like shape to wrap one of the positive electrode and the negative electrode.

The separator is a porous material having a pore with a size of approximately 20 nm, preferably a pore with a size of greater than or equal to 6.5 nm, further preferably a pore with a diameter of at least 2 nm. In the case of the above-described semi-solid-state secondary battery, the separator can be omitted.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at a high voltage can be inhibited and thus the reliability of the secondary battery can be improved. When the separator is coated with the fluorine-based material, the separator is easily in close contact with an electrode, resulting in high output characteristics. When the separator is coated with the polyamide-based material, especially, aramid, the safety of the secondary battery can be improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### Exterior Body

For an exterior body included in the secondary battery, a metal material such as aluminum and a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. As the film, a fluorine resin film is preferably used. The fluorine resin film has high stability to acid, alkali, an organic solvent, and the like and suppresses a side reaction, corrosion, or the like caused by a reaction of a secondary battery or the like, whereby an excellent secondary battery can be provided. Examples of the fluorine resin film include PTFE (polytetrafluoroethylene), PFA (perfluoroalkoxy alkane: a copolymer of tetrafluoroethylene and perfluoroalkyl vinyl ether), FEP (a perfluoroethylene-propene copolymer: a copolymer of tetrafluoroethylene and hexafluoropropylene), and ETFE (an ethylene-tetrafluoroethylene copolymer: a copolymer of tetrafluoroethylene and ethylene).

This embodiment can be implemented in appropriate combination with any of the other embodiments.

### Embodiment 3

This embodiment describes examples of shapes of several types of secondary batteries including a positive electrode or a negative electrode formed by the manufacturing method described in the foregoing embodiment.

### Coin-type Secondary Battery

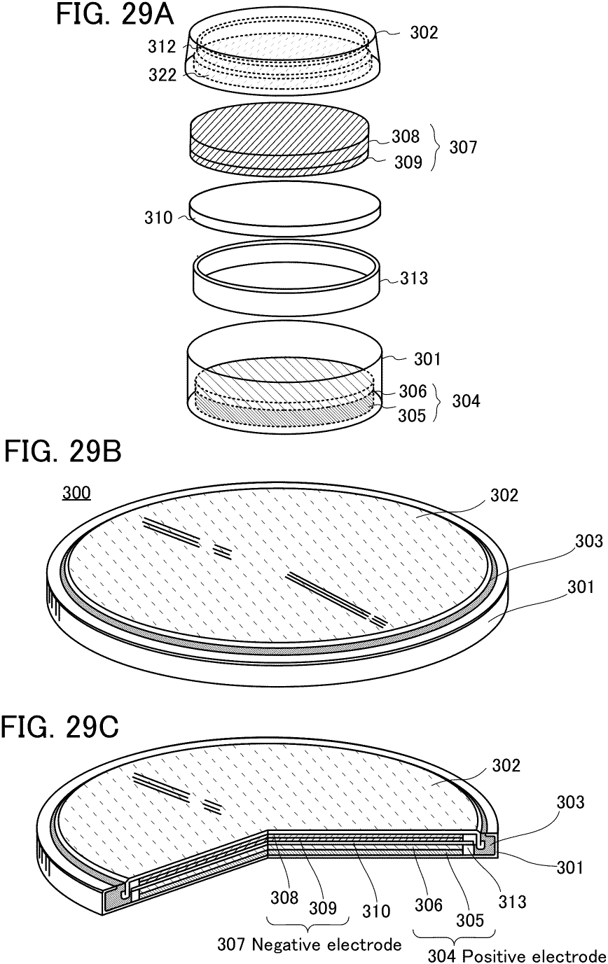

An example of a coin-type secondary battery is described. FIG. 29A is an exploded perspective view of a coin-type (single-layer flat type) secondary battery, FIG. 29B is an external view thereof, and FIG. 29C is a cross-sectional view thereof. Coin-type secondary batteries are mainly used in small electronic devices.

For easy understanding, FIG. 29A is a schematic view showing overlap (a vertical relation and a positional relation) between components. Thus, FIG. 29A and FIG. 29B do not completely correspond with each other.

In FIG. 29A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 29A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stack structure in which a positive electrode active material layer 306 is formed over a positive electrode current collector 305.

To prevent a short circuit between the positive electrode and the negative electrode, the separator 310 and a ring-shaped insulator 313 are provided to cover the side surface and top surface of the positive electrode 304. The separator 310 has a larger flat surface area than the positive electrode 304.

FIG. 29B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in the electrolyte; as illustrated in FIG. 29C, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

The secondary battery can be the coin-type secondary battery 300 having high capacity, high charge and discharge capacity, and excellent cycle performance. Note that in the case of a secondary battery, the separator 310 is not necessarily provided between the negative electrode 307 and the positive electrode 304.

### Cylindrical Secondary Battery

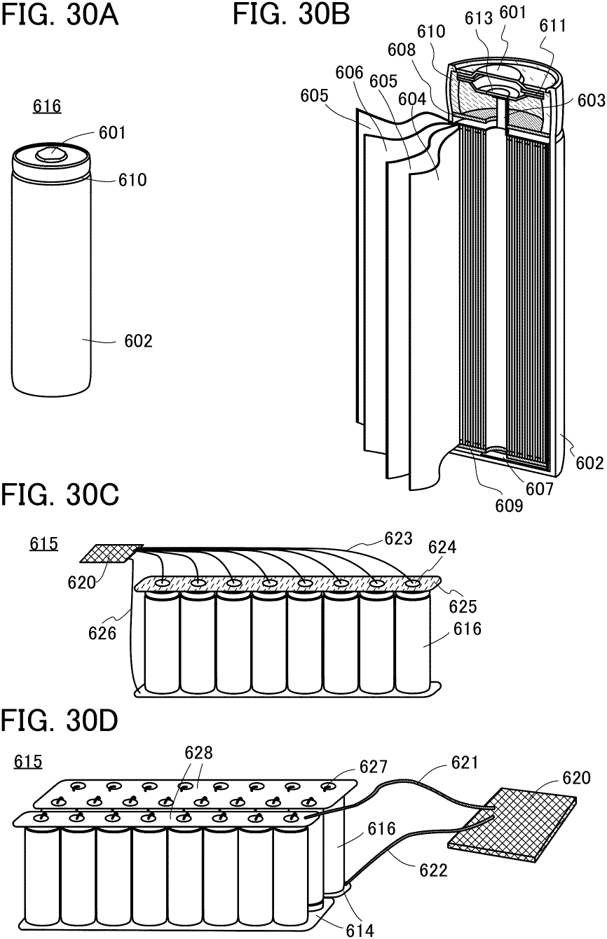

An example of a cylindrical secondary battery is described with reference to FIG. 30A. As illustrated in FIG. 30A, a cylindrical secondary battery 616 includes a positive electrode cap (battery cap) 601 on the top surface and a battery can (outer can) 602 on the side surface and bottom surface. The battery can (outer can) 602 is formed using a metal material and has an excellent barrier property against water permeation and an excellent gas barrier property. The positive electrode cap 601 and the battery can (outer can) 602 are insulated from each other by a gasket (insulating gasket) 610.

FIG. 30B schematically illustrates a cross section of a cylindrical secondary battery. The cylindrical secondary battery illustrated in FIG. 30B includes the positive electrode cap (battery cap) 601 on the top surface and the battery can (outer can) 602 on the side surface and the bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around a center pin. One end of the battery can 602 is close and the other end thereof is open. For the battery can 602, a metal having corrosion resistance to an electrolyte, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte. Inside the battery can 602, the battery element in which the positive electrode, the negative electrode, and the separator are wound is provided between a pair of insulating plates 608 and 609 that face each other. The inside of the battery can 602 provided with the battery element is filled with an electrolyte (not illustrated). An electrolyte similar to that for the coin-type secondary battery can be used.

Since a positive electrode and a negative electrode that are used for a cylindrical storage battery are wound, active materials are preferably formed on both surfaces of a current collector.

The negative electrode obtained in Embodiment 1 is used, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 30C shows an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charging and discharging control circuit for performing charging, discharging, and the like and a protection circuit for preventing overcharging and/or overdischarging can be used.

FIG. 30D shows an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 30D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### Other Structure Examples of Secondary Battery

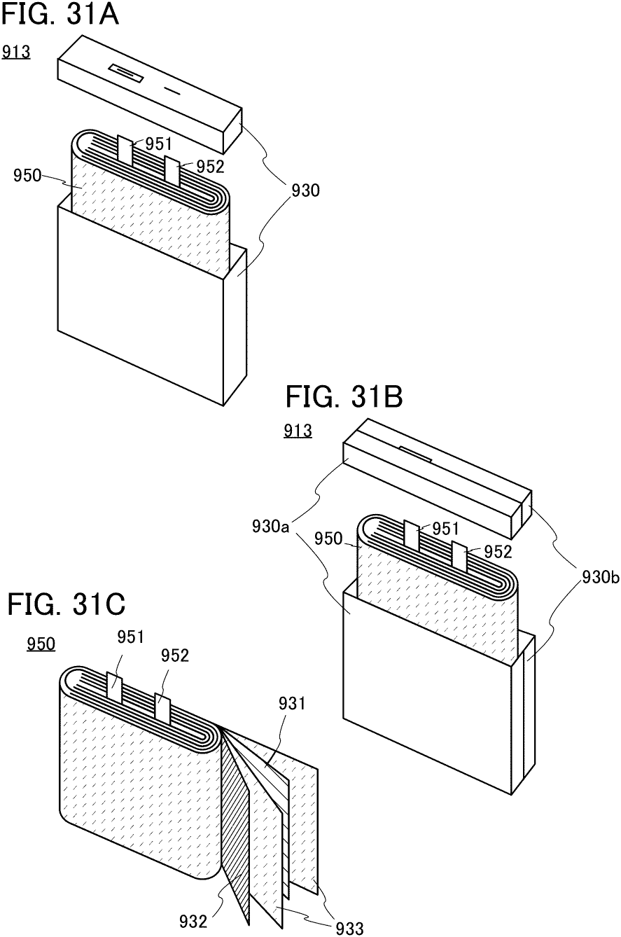

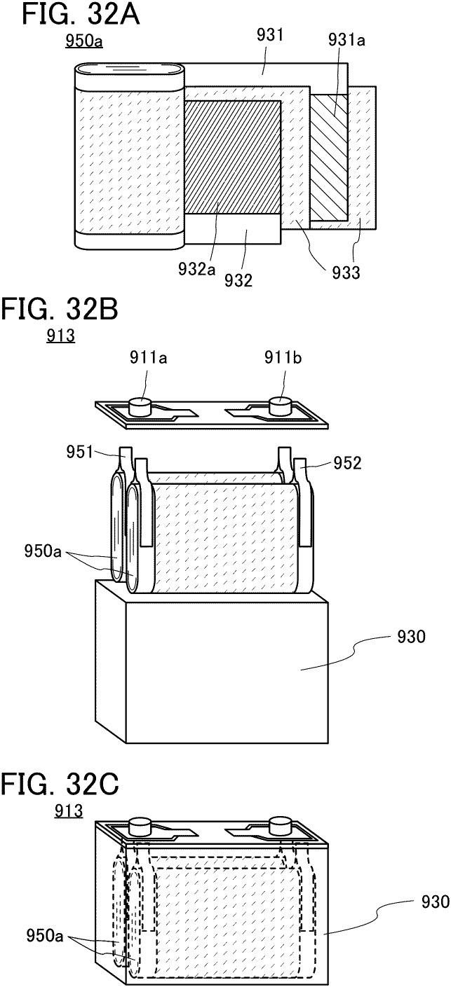

Structure examples of secondary batteries are described with reference to FIG. 31 and FIG. 32.

A secondary battery 913 illustrated in FIG. 31A includes a wound body 950 provided with a terminal 951 and a terminal 952 inside a housing 930. The wound body 950 is immersed in an electrolyte inside the housing 930. The terminal 952 is in contact with the housing 930. The use of an insulator or the like inhibits contact between the terminal 951 and the housing 930. Note that in FIG. 31A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 31B, the housing 930 in FIG. 31A may be formed using a plurality of materials. For example, in the secondary battery 913 illustrated in FIG. 31B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 31C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 32, the secondary battery 913 may include a wound body 950a. The wound body 950a illustrated in FIG. 32A includes the negative electrode 931, the positive electrode 932, and the separators 933. The negative electrode 931 includes a negative electrode active material layer 931a. The positive electrode 932 includes a positive electrode active material layer 932a.

An electrolyte containing fluorine is used for the negative electrode 931, whereby the secondary battery 913 can have high charge and discharge capacity and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 32A and FIG. 32B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 32C, the wound body 950a and an electrolyte are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 32B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 31A to FIG. 31C can be referred to for the other components of the secondary battery 913 illustrated in FIG. 32A and FIG. 32B.

### Laminated Secondary Battery

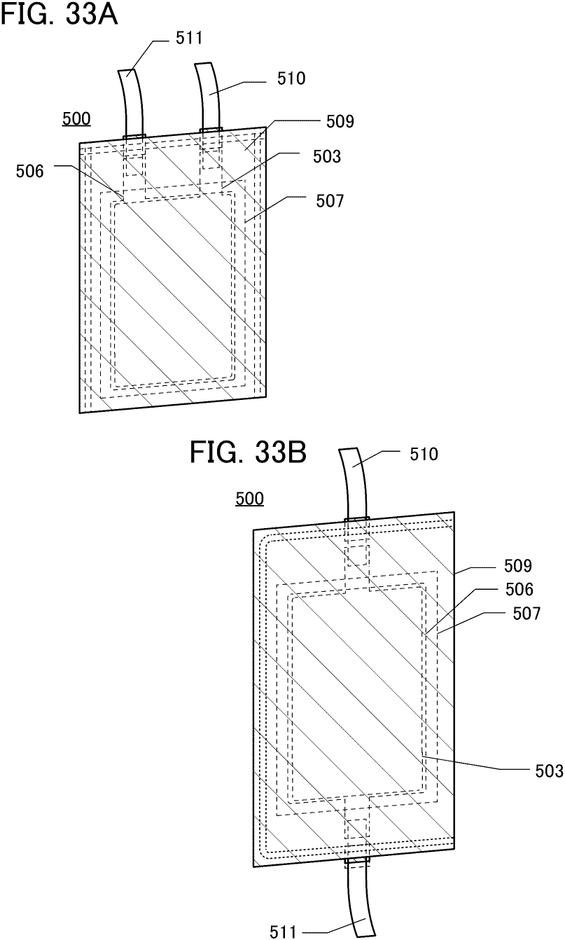

Next, examples of the appearance of a laminated secondary battery are shown in FIG. 33A and FIG. 33B. FIG. 33A and FIG. 33B each include a positive electrode 503, a negative electrode 506, a separator 507, an exterior body 509, a positive electrode lead electrode 510, and a negative electrode lead electrode 511.

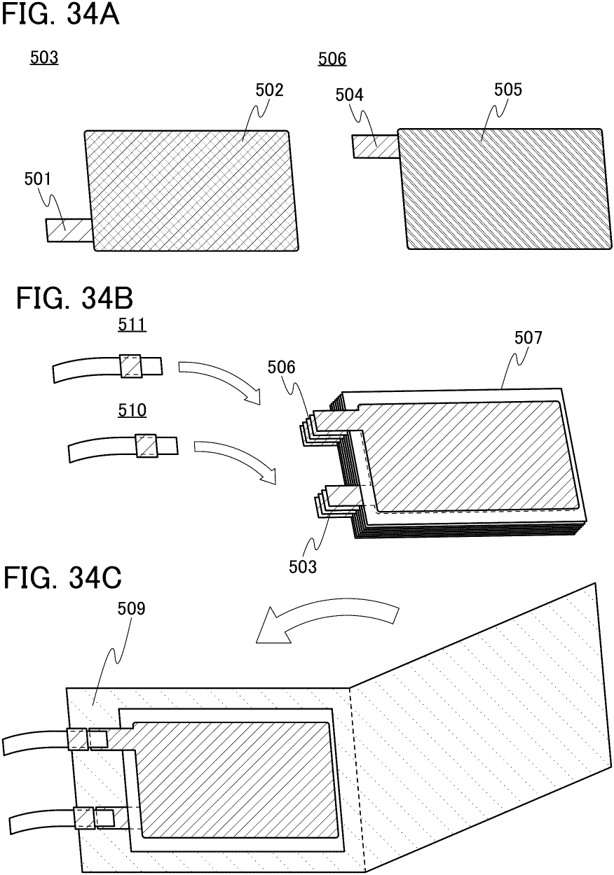

FIG. 34A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples shown in FIG. 34A.

### Method for Manufacturing Laminated Secondary Battery

Here, an example of a method for manufacturing the laminated secondary battery whose external view is shown in FIG. 33A is described with reference to FIG. 34B and FIG. 34C.

First, the negative electrodes 506, the separators 507, and the positive electrodes 503 are stacked. FIG. 34B illustrates the stacked negative electrodes 506, separators 507, and positive electrodes 503. Here, an example in which five negative electrodes 506 and four positive electrodes 503 are used is illustrated. The stacked negative electrodes 506, separators 507, and positive electrodes 506 can also be referred to as a stacked body including the negative electrodes 506, the separators 507, and the positive electrodes 503. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a portion shown by a dashed line, as illustrated in FIG. 34C. Then, the outer edges of the exterior body 509 are bonded to each other. The bonding can be performed by thermocompression, for example. At this time, an unbonded region (hereinafter referred to as an inlet) is provided for part (or one side) of the exterior body 509 so that an electrolyte can be introduced later. As the exterior body 509, a film having an excellent barrier property against water permeation and an excellent gas barrier property is preferably used. The exterior body 509 having a stacked-layer structure including metal foil (for example, aluminum foil) as one of intermediate layers can have a high barrier property against water permeation and a high gas barrier property.

Next, the electrolyte (not illustrated) is introduced into the exterior body 509 from the inlet of the exterior body 509. The electrolyte is preferably introduced in a reduced pressure atmosphere or in an inert atmosphere. Lastly, the inlet is sealed by bonding. In this manner, the laminated secondary battery 500 can be manufactured.

The negative electrode structure obtained in Embodiment 1, i.e., the electrode in which the graphene compound closely clings to the material obtained by mixing the particle containing silicon, the material containing halogen, and the material containing oxygen and carbon and heating the material is used as the negative electrode 506, whereby the secondary battery 500 can have high capacity, high charge and discharge capacity, and excellent cycle performance.

This embodiment can be implemented in appropriate combination with any of the other embodiments.

### Embodiment 4

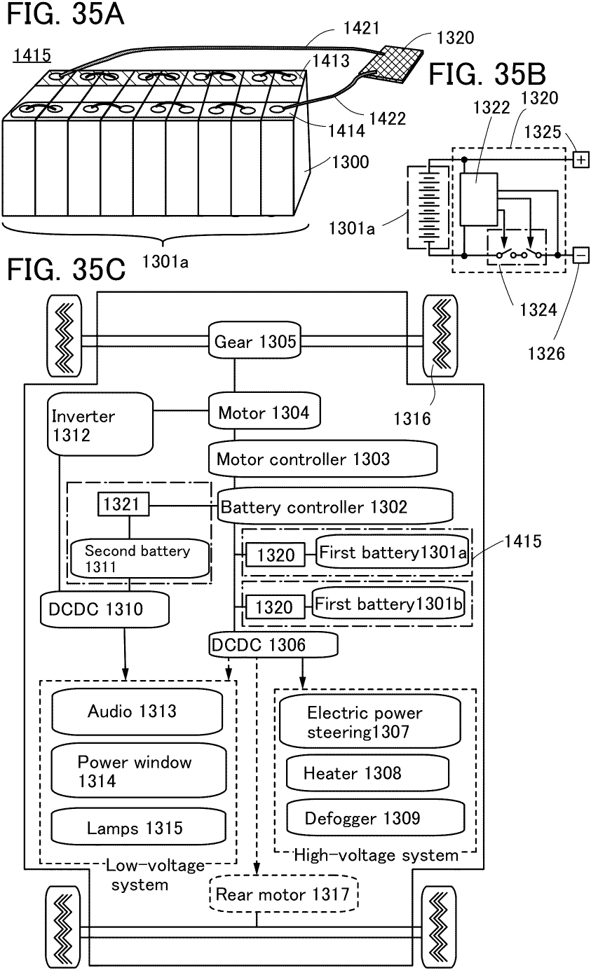

In this embodiment, an example of application to an electric vehicle (EV) is described with reference to FIG. 35A which is different from an example of the cylindrical secondary batteries in FIG. 30D.

FIG. 35C is a block diagram of an example of an electric vehicle. The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 needs high output and high capacity is not so necessary, and the capacity of the second battery 1311 is lower than that of the first batteries 1301a and 1301b.

The internal structure of the first battery 1301a may be the wound structure illustrated in FIG. 31A or the stacked structure illustrated in FIG. 33A and FIG. 33B.

Although this embodiment describes an example in which two first batteries 1301a and 1301b are connected in parallel, three or more first batteries may be connected in parallel. When the first battery 1301a is capable of storing sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries can also be referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DC-DC circuit 1310.

The first battery 1301a will be described with reference to FIG. 35A.

FIG. 35A illustrates an example in which nine rectangular secondary batteries 1300 constitute one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment illustrates the example in which the secondary batteries are fixed by the fixing portions 1413 and 1414, the secondary batteries may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 or a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a BTOS (Battery operating system or Battery oxide semiconductor).

The control circuit portion 1320 senses a terminal voltage of the secondary battery and controls the charge and discharge state of the secondary battery. For example, to prevent overcharging, the control circuit portion 1320 can turn off both an output transistor of a charging circuit and an interruption switch substantially at the same time.

FIG. 35B illustrates an example of a block diagram of the battery pack 1415 illustrated in FIG. 35A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and controls the upper limit of current from the outside, the upper limit of output current to the outside, or the like. The range from the lower limit voltage to the upper limit voltage of the secondary battery is a recommended voltage range, and when a voltage is out of the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal (+IN) 1325 and an external terminal (-IN) 1326.

The switch portion 1324 can be formed by a combination of an n-channel transistor and a p-channel transistor. The switch portion 1324 is not limited to a switch including a Si transistor using single crystal silicon; the switch portion 1324 may be formed using a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide; x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead batteries are usually used for the second battery 1311 due to cost advantage.

In this embodiment, an example in which a lithium-ion secondary battery is used as each of the first battery 1301a and the second battery 1311 is described. As the second battery 1311, a lead storage battery, an all-solid-state battery, or an electric double layer capacitor may be used.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are preferably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU and a GPU.

Next, examples in which the secondary battery of one embodiment of the present invention is mounted on a vehicle, typically a transport vehicle, will be described.

Mounting the secondary battery illustrated in FIG. 30D or FIG. 35A on vehicles can provide next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft or rotary-wing aircraft, rockets, artificial satellites, space probes, planetary probes, or spacecraft. The secondary battery of one embodiment of the present invention can be a secondary battery with high capacity. Thus, the secondary battery of one embodiment of the present invention is suitable for reduction in size and reduction in weight and can be favorably used in transport vehicles.

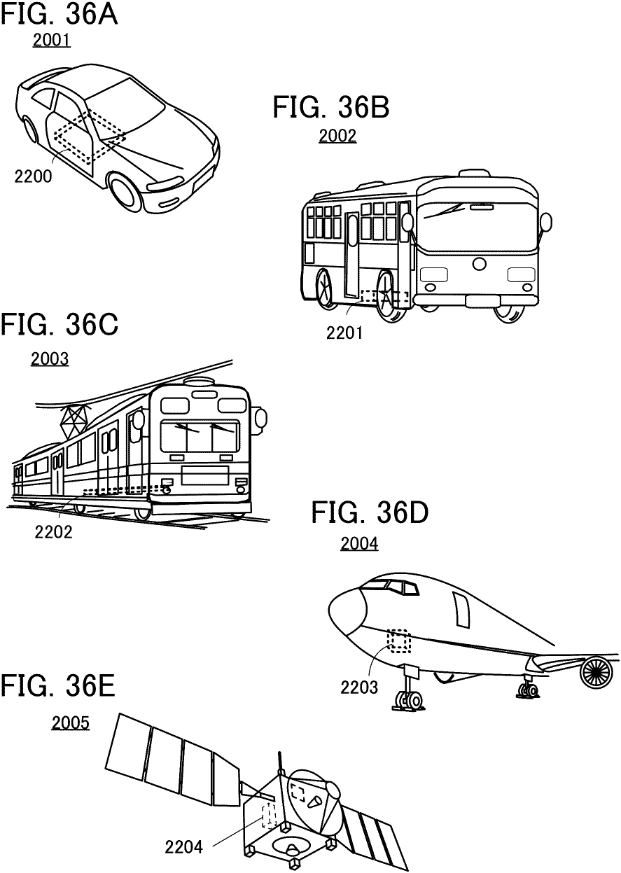

FIG. 36A to FIG. 36E illustrate examples of transport vehicles using one embodiment of the present invention. An automobile 2001 illustrated in FIG. 36A is an electric vehicle that runs on an electric motor as a power source. Alternatively, the automobile 2001 is a hybrid electric vehicle that can appropriately select an electric motor or an engine as a driving power source. In the case where the secondary battery is mounted on the vehicle, the secondary battery is provided at one position or several positions. The automobile 2001 illustrated in FIG. 36A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power from external charging equipment by a plug-in system, a contactless charging system, or the like. In charging, a given method such as CHAdeMO (registered trademark) or Combined Charging System may be employed as a charging method, the standard of a connector, and the like as appropriate. The secondary battery may be a charging station provided in a commerce facility or a household power supply. For example, a plug-in technique enables an exterior power supply to charge a storage battery incorporated in the automobile 2001. Charging can be performed by converting AC power into DC power through a converter such as an AC-DC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 36B illustrates a large transporter 2002 having a motor controlled by electric power, as an example of a transport vehicle. In the secondary battery module of the transporter 2002, a cell unit includes four secondary batteries with a voltage of 3.5 V or higher and 4.7 V or lower, and 48 cells are connected in series to have 170 V as the maximum voltage. A battery pack 2201 has a function similar to that in FIG. 36A except that the number of secondary batteries forming the secondary battery module of the battery pack 2201 or the like is different; thus the description is omitted.

FIG. 36C illustrates a large transport vehicle 2003 having a motor controlled by electricity as an example. In the secondary battery module of the transport vehicle 2003, 100 or more secondary batteries with a voltage of 3.5 V or higher and 4.7 V or lower are connected in series, and the maximum voltage is 600 V, for example. Thus, the secondary batteries are required to have few variations in the characteristics. With the use of a secondary battery employing the structure including an electrolyte containing fluorine in a negative electrode, a secondary battery having stable battery characteristics can be manufactured and its high-volume production at low costs is possible in light of the yield. A battery pack 2202 has a function similar to that in FIG. 36A except that the number of secondary batteries forming the secondary battery module of the battery pack 2202 or the like is different; thus the description is omitted.

FIG. 36D illustrates an aircraft 2004 having a combustion engine as an example. The aircraft 2004 illustrated in FIG. 36D can be regarded as a kind of a transport vehicle since it is provided with wheels for takeoff and landing, and has a battery pack 2203 including a secondary battery module and a charging control device; the secondary battery module includes a plurality of connected secondary batteries.

The secondary battery module of the aircraft 2004 has eight 4 V secondary batteries connected in series, which has the maximum voltage of 32 V, for example. The battery pack 2203 has a function similar to that in FIG. 36A except that the number of secondary batteries forming the secondary battery module of the battery pack 2203 or the like is different; thus the description is omitted.

FIG. 36E illustrates an example of an artificial satellite using a power storage management system of one embodiment of the present invention. An artificial satellite 2005 illustrated in FIG. 36E includes a secondary battery 2204. Because the artificial satellite 2005 is used in an ultra-low-temperature cosmic space, the secondary battery 2204 is desirably covered with a heat-retaining member to be mounted inside the artificial satellite 2005.

This embodiment can be implemented in appropriate combination with any of the other embodiments.

### Embodiment 5

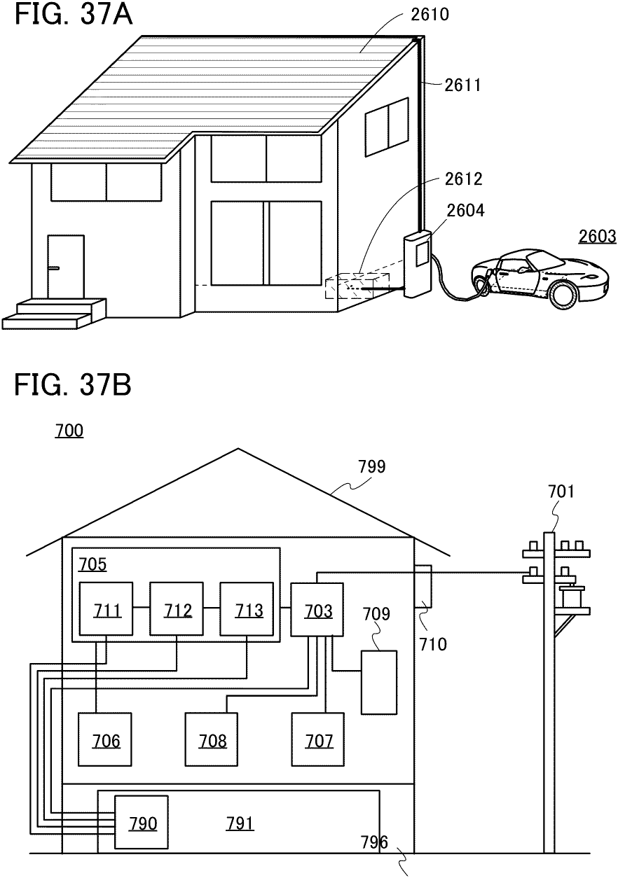

In this embodiment, examples in which the secondary battery of one embodiment of the present invention is mounted on a building will be described with reference to FIG. 37A and FIG. 37B.

A house illustrated in FIG. 37A includes a power storage device 2612 including the secondary battery which is one embodiment of the present invention and a solar panel 2610. The power storage device 2612 is electrically connected to the solar panel 2610 through a wiring 2611 or the like. The power storage device 2612 may be electrically connected to a ground-based charging equipment 2604. The power storage device 2612 can be charged with electric power generated by the solar panel 2610. A secondary battery included in a vehicle 2603 can be charged with the electric power stored in the power storage device 2612 through the charging equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 37B illustrates an example of a power storage device 700 of one embodiment of the present invention. As illustrated in FIG. 37B, a power storage device 791 of one embodiment of the present invention is provided in an underfloor space 796 of a building 799.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

This embodiment can be implemented in appropriate combination with any of the other embodiments.

### Embodiment 6

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

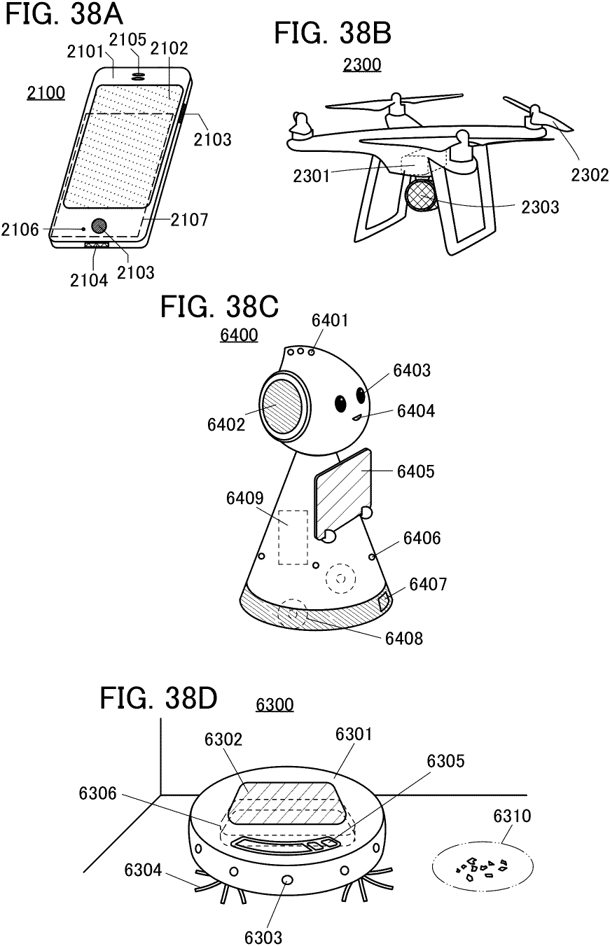

FIG. 38A illustrates an example of a mobile phone. A mobile phone 2100 includes a display portion 2102 set in a housing 2101, an operation button 2103, an external connection port 2104, a speaker 2105, a microphone 2106, and the like. The mobile phone 2100 includes a secondary battery 2107. The use of the secondary battery 2107 having the structure including an electrolyte containing fluorine in a negative electrode can achieve high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by an operating system incorporated in the mobile phone 2100.

The mobile phone 2100 can employ near field communication based on a communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, and a temperature sensor, a touch sensor, a pressure sensitive sensor, or an acceleration sensor is preferably mounted, for example.

FIG. 38B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery employing the structure including an electrolyte containing fluorine in a negative electrode has high energy density and a high degree of safety, and thus can be used safely for a long time over a long period of time and is suitable for the secondary battery used in the unmanned aircraft 2300.

FIG. 38C illustrates an example of a robot. A robot 6400 illustrated in FIG. 38C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user, using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes, in its inner region, the secondary battery 6409 of one embodiment of the present invention and a semiconductor device or an electronic component. A secondary battery employing the structure including an electrolyte containing fluorine in a negative electrode has high energy density and a high degree of safety, and thus can be used safely for a long time over a long period of time and is suitable for the secondary battery 6409 included in the robot 6400.

FIG. 38D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 can be self-propelled, detect dust 6310, and suck up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery employing the structure including an electrolyte containing fluorine in a negative electrode has high energy density and a high degree of safety, and thus can be used safely for a long time over a long period of time and is suitable for the secondary battery 6306 included in the cleaning robot 6300.

This embodiment can be implemented in appropriate combination with any of the other embodiments.

### Notes on Description of This Specification and the Like

In this specification and the like, crystal planes and orientations are indicated by the Miller index. In the crystallography, a bar is placed over a number in the expression of crystal planes and orientations; however, in this specification and the like, because of application format limitations, crystal planes and orientations may be expressed by placing a minus sign (-) at the front of a number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”.

In this specification and the like, segregation refers to a phenomenon in which in a solid made of a plurality of elements (e.g., A, B, and C), a certain element (e.g., B) is spatially non-uniformly distributed.

In this specification and the like, a surface portion of a particle of an active material or the like is preferably a region that is less than or equal to 50 nm, preferably less than or equal to 35 nm, further preferably less than or equal to 20 nm from the surface, for example. A plane generated by a split or a crack may also be referred to as a surface. In addition, a region in a deeper position than a surface portion is referred to as an inner portion.

In this specification and the like, the layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

In this specification and the like, the theoretical capacity of a positive electrode active material refers to the amount of electricity for the case where all lithium that can be inserted and extracted in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, the charge depth obtained when all lithium that can be inserted and extracted is inserted is 0, and the charge depth obtained when all lithium that can be inserted and extracted in a positive electrode active material is extracted is 1.

In this specification and the like, charging refers to transfer of lithium ions from a positive electrode to a negative electrode in a battery and transfer of electrons from a positive electrode to a negative electrode in an external circuit. For a positive electrode active material, extraction of lithium ions is called charging. A positive electrode active material with a charge depth greater than or equal to 0.7 and less than or equal to 0.9 may be referred to as a positive electrode active material charged with high voltage.

Similarly, discharging refers to transfer of lithium ions from a negative electrode to a positive electrode in a battery and transfer of electrons from a negative electrode to a positive electrode in an external circuit. For a positive electrode active material, insertion of lithium ions is called discharging. Furthermore, a positive electrode active material with a charge depth less than or equal to 0.06 or a positive electrode active material from which 90 % or more of the charge capacity in a high-voltage charged state is discharged is referred to as a sufficiently discharged positive electrode active material.

In this specification and the like, an unbalanced phase change refers to a phenomenon that causes a nonlinear change in physical quantity. For example, an unbalanced phase change is presumed to occur around a peak in a dQ/dV curve obtained by differentiating capacitance (Q) with voltage (V) (dQ/dV), resulting in a large change in the crystal structure.

A secondary battery includes a positive electrode and a negative electrode, for example. A positive electrode active material is a material included in the positive electrode. The positive electrode active material is a material that performs a reaction contributing to the charge and discharge capacity, for example. Note that the positive electrode active material may partly include a material that does not contribute to the charge and discharge capacity. A negative electrode active material is a material included in the negative electrode. The negative electrode active material is a material that performs a reaction contributing to the charge and discharge capacity, for example. Note that the negative electrode active material may partly include a material that does not contribute to the charge and discharge capacity.

In this specification and the like, the positive electrode active material of one embodiment of the present invention is expressed as a positive electrode material, a secondary battery positive electrode material, or the like in some cases. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

In this specification and the like, a negative electrode active material of one embodiment of the present invention is expressed as a negative electrode material, a secondary battery negative electrode material, or the like in some cases. In this specification and the like, the negative electrode active material of one embodiment of the present invention preferably contains a compound. In this specification and the like, the negative electrode active material of one embodiment of the present invention preferably contains a composition. In this specification and the like, the negative electrode active material of one embodiment of the present invention preferably contains a composite.

The discharge rate refers to the relative ratio of a current at the time of discharging to battery capacity and is expressed in a unit C. A current corresponding to 1 C in a battery with a rated capacity X (Ah) is X (A). The case where discharging is performed with a current of 2X (A) is rephrased as to perform discharging at 2 C, and the case where discharging is performed with a current of X/5 (A) is rephrased as to perform discharging at 0.2 C. The same applies to the charge rate; the case where charging is performed with a current of 2X (A) is rephrased as to perform charging at 2 C, and the case where charging is performed with a current of X/5 (A) is rephrased as to perform charging at 0.2 C.

Constant current charging refers to a charging method with a fixed charge rate, for example. Constant voltage charging refers to a charging method in which voltage is fixed when reaching the upper voltage limit, for example. Constant current discharging refers to a discharging method with a fixed discharge rate, for example.

### Example 1

In this example, the negative electrode active material of one embodiment of the present invention was formed and the formed negative electrode active material was evaluated.

### Formation of Negative Electrode Active Material

A negative electrode active material was formed according to the flowchart shown in FIG. 19. Silicon was used as the first material 801 and nanosilicon particles produced by Sigma-Aldrich were used as the silicon. Lithium fluoride was used as the material 802 containing halogen. Lithium carbonate was used as the material 803 containing oxygen and carbon.

A sample AS1, a sample AS2, and a sample AS3 were each formed as the negative electrode active material.

### As1

As materials for the sample AS1, silicon, lithium fluoride, and lithium carbonate were prepared (refer to Step S21, Step S22, and Step S23 in FIG. 19). They were compounded such that silicon:lithium fluoride: lithium carbonate = 100:5:5 (weight%), and dry mixing was performed (refer to Step S31 to Step S33 in FIG. 19).

### As2

Silicon and lithium fluoride were prepared as materials for the sample AS2. They were compounded such that silicon: lithium fluoride = 100:10 (weight%), and dry mixing was performed.

### As3

Silicon and lithium carbonate were prepared as materials for the sample AS3. They were compounded such that silicon:lithium carbonate = 100:10 (weight%), and dry mixing was performed.

Each of the mixtures of the materials of the samples was baked at 850° C. for 10 hours in a nitrogen atmosphere, whereby each of the samples was obtained (refer to Step S51 to Step S53 in FIG. 19).

### Sem-edx

Next, the sample AS1, the sample AS2, and the sample AS3 were analyzed by SEM-EDX. For the EDX measurement, an apparatus in which an EDX unit EX-350X-MaX80 produced by HORIBA, Ltd. was provided in SEM, SU8030 produced by Hitachi High-Technologies Corporation was used. The acceleration voltage in the EDX analysis was 10 kV. Table 6, Table 7, and Table 8 show results of the EDX analysis. The unit is the atomic percent. Note that the sum of the atomic concentrations of carbon, nitrogen, oxygen, fluorine, and silicon was 100 atomic percent. Three points of each of the samples were subjected to the EDX analysis.

[TABLE 7]

| AS1 | Atomic concentration (atomic%) | | | | | |
|---|---|---|---|---|---|---|
| | C | N | O | F | Si | Total |
| Point 1 | 19.27 | 4.65 | 19.09 | 0.90 | 56.09 | 100 |
| Point 2 | 37.46 | 2.33 | 13.11 | 1.83 | 45.26 | 100 |
| Point 3 | 22.57 | 1.12 | 18.35 | 3.39 | 54.57 | 100 |

[TABLE 8]

| AS2 | Atomic concentration (atomic%) | | | | | |
|---|---|---|---|---|---|---|
| | C | N | O | F | Si | Total |
| Point 1 | 8.02 | 2.67 | 26.19 | 0.48 | 62.66 | 100 |
| Point 2 | 11.18 | 6.04 | 18.16 | 1.92 | 62.71 | 100 |
| Point 3 | 6.39 | 5.75 | 29.08 | 1.39 | 57.40 | 100 |

[TABLE 9]

| AS3 | Atomic concentration (atomic%) | | | | | |
|---|---|---|---|---|---|---|
| | C | N | O | F | Si | Total |
| Point 1 | 10.92 | 3.09 | 25.26 | 0.58 | 60.14 | 100 |
| Point 2 | 9.98 | 2.91 | 23.75 | 0.15 | 63.22 | 100 |
| Point 3 | 11.12 | 3.63 | 25.06 | 0.17 | 60.04 | 100 |

### Example 2

### Electrode Formation

Next, in accordance with the flowchart in FIG. 21, an electrode was formed using the sample AS1.

The particle containing silicon (the sample AS1) and a solvent were prepared at 1:1 of the particle containing silicon to the solvent (weight ratio) and mixed (Steps S71, S72, S73 in FIG. 21). As the solvent, NMP was used. Mixing was performed at 2000 rpm for three minutes with the use of a planetary centrifugal mixer (Awatori rentaro produced by THINKY CORPORATION) and the mixture was collected to give the mixture E-1 (Steps S74 and S75 in FIG. 21).

Next, the mixture E-1 and a graphene compound were mixed repeatedly with a solvent added thereto. The weight of the graphene compound was set to 0.0625 times (5/80 times) the weight of the particle containing silicon prepared in Step S71. Graphene oxide was used as the graphene compound. Mixing was performed at 2000 rpm for three minutes with the use of the planetary centrifugal mixer and the mixture was collected (Steps S81 and S82 in FIG. 21). Then, the collected mixture was stiff-kneaded, NMP was added thereto as appropriate, mixing was performed at 2000 rpm for three minutes with the use of the planetary centrifugal mixer, and the mixture was collected (Steps S83, S84, and Step S85 in FIG. 21). Step S83 to Step S85 were repeated five times to give the mixture E-2 (Step S86 in FIG. 21).

Next, the mixture E-2 and a precursor of polyimide were mixed (Step S88 in FIG. 21). The weight of the prepared polyimide was set to 0.1875 times (15/80 times) the weight of the particle containing silicon prepared in Step S71. Mixing was performed at 2000 rpm for three minutes with the use of the planetary centrifugal mixer. After that, NMP whose weight was 1.5 times the weight of the particle containing silicon prepared in Step S71 was prepared and added to the mixture so that the viscosity of the mixture was adjusted (Step S89 in FIG. 21), further mixing was performed (twice at 2000 rpm for three minutes with the use of the planetary centrifugal mixer), and the mixture was collected, whereby the mixture E-3 was obtained as a slurry (Steps S90, S91, and S92 in FIG. 21).

Next, a current collector was prepared and the mixture E-3 was applied (Steps S93 and S94 in FIG. 21). An undercoated copper foil was prepared as the current collector and the mixture E-3 was applied to the copper foil with the use of a doctor blade with a gap thickness of 100 µm. The current collector used was the prepared copper foil having a thickness of copper of 18 µm and including a coating layer containing carbon as the undercoat. AB was used as a material of the coating layer containing carbon.

Then, the first heating was performed on the copper foil to which the mixture E-3 was applied at 50° C. for one hour (Step S95 in FIG. 21). After that, the second heating was performed under reduced pressure at 400° C. for five hours (Step S96 in FIG. 21), whereby an electrode was formed. By the heating, graphene oxide is reduced, so that the amount of oxygen is decreased.

### Sem

SEM observation of the surface and cross section of the formed electrode was performed. In Example 2, S-4800 produced by Hitachi High-Technologies Corporation was used as the SEM. The accelerating voltage was 5 kV. The electrode subjected to cross-section observation had been processed by an ion milling method before the observation so as to be exposed on its cross section.

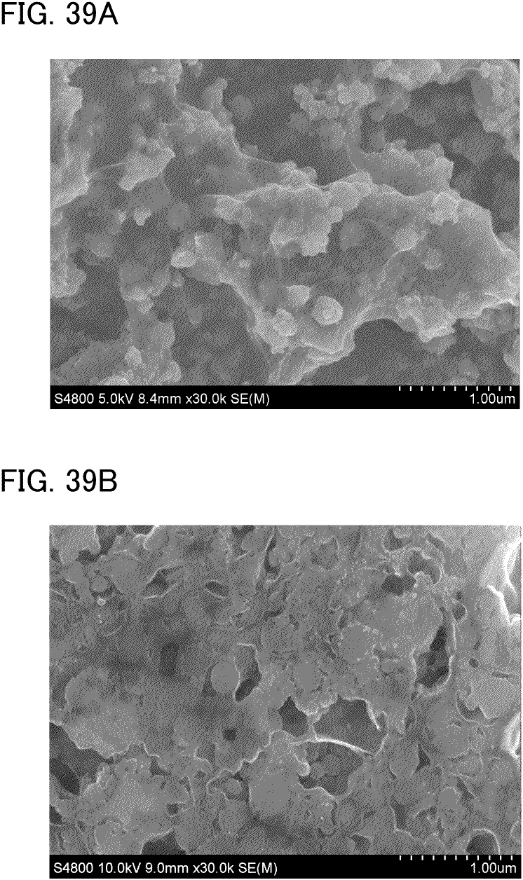

FIG. 39A and FIG. 39B are observation images of the surface and cross section of the electrode formed with the sample AS1. In the sample AS1 formed using LiF and Li₂CO₃ and subjected to heat treatment, it was confirmed that the graphene compound closely clung to the silicon particle. When the degree of clinging described with reference to FIG. 2 in Embodiment 1 was measured using the cross-sectional SEM image of the sample AS1, the value was over 120 %, which showed that the graphene compound closely clung to the silicon particle.

### Example 3

In this example, the negative electrode active material of one embodiment of the present invention was formed and the formed negative electrode active material was evaluated.

### Formation of Negative Electrode

Next, an electrode was formed using the sample AS3 according to the flowchart shown in FIG. 21.

The particle containing silicon (the sample AS3, also referred to as silicon subjected to lithium carbonate treatment) and a solvent were prepared at 1:1 of the particle containing silicon to the solvent (weight ratio) and mixed (Steps S71, S72, and S73 in FIG. 21). As the solvent, NMP was used. Mixing was performed at 2000 rpm for three minutes with the use of a planetary centrifugal mixer (Awatori rentaro produced by THINKY CORPORATION) and the mixture was collected to give the mixture E-1 (Steps S74 and S75 in FIG. 21).

Next, the mixture E-1 and a graphene compound were mixed repeatedly with a solvent added thereto. The weight of the graphene compound was set to 0.0625 times (5/80 times) the weight of the particle containing silicon prepared in Step S71. Graphene oxide was used as the graphene compound. Mixing was performed at 2000 rpm for three minutes with the use of the planetary centrifugal mixer and the mixture was collected (Steps S81 and S82 in FIG. 21). Then, the collected mixture was stiff-kneaded, NMP was added thereto as appropriate, mixing was performed at 2000 rpm for three minutes with the use of the planetary centrifugal mixer, and the mixture was collected (Steps S83, S84, and Step S85 in FIG. 21). Step S83 to Step S85 were repeated five times to give the mixture E-2 (Step S86 in FIG. 21).

Next, the mixture E-2 and a precursor of polyimide were mixed (Step S88 in FIG. 21). A precursor of polyimide produced by Toray Industries, Inc. was used as polyimide. The weight of the prepared polyimide was set to 0.1875 times (15/80 times) the weight of the particle containing silicon prepared in Step S71. Mixing was performed at 2000 rpm for three minutes with the use of the planetary centrifugal mixer. After that, NMP whose weight was 1.5 times the weight of the particle containing silicon prepared in Step S71 was prepared and added to the mixture so that the viscosity of the mixture was adjusted (Step S89 in FIG. 21), further mixing was performed (twice at 2000 rpm for three minutes with the use of the planetary centrifugal mixer), and the mixture was collected, whereby the mixture E-3 was obtained as a slurry (Steps S90, S91, and S92 in FIG. 21).

Next, a current collector was prepared and the mixture E-3 was applied (Steps S93 and S94 in FIG. 21). An undercoated copper foil was prepared as the current collector and the mixture E-3 was applied to the copper foil with the use of a doctor blade with a gap thickness of 100 µm. The current collector used was the prepared copper foil having a thickness of copper of 18 µm and including a coating layer containing carbon as the undercoat. AB was used as a material of the coating layer containing carbon.

Then, the first heating was performed on the copper foil to which the mixture E-3 was applied at 50° C. for one hour (Step S95 in FIG. 21). After that, the second heating was performed under reduced pressure at 400° C. for five hours (Step S96 in FIG. 21), whereby an electrode was formed. By the heating, graphene oxide in the electrode is reduced to be RGO (Reduced Graphene Oxide), and the amount of oxygen is decreased.

### Sem

SEM observation of the surface and cross section of the electrode formed in this example was performed. S4800 produced by Hitachi High-Technologies Corporation was used as the SEM. The accelerating voltage was 5 kV. The electrode subjected to cross-section observation had been processed by an ion milling method before the observation so as to be exposed on its cross section.

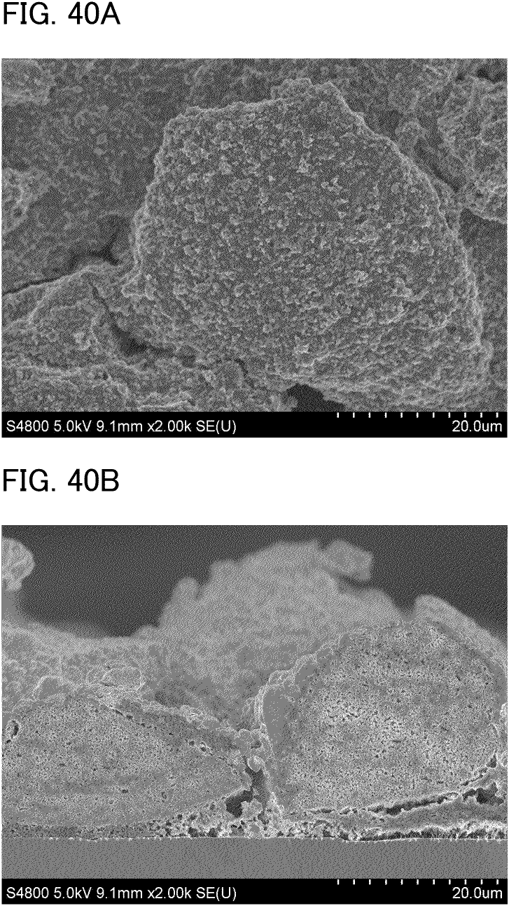

FIG. 40A and FIG. 40B are SEM observation images of the surface and cross section of the electrode of this example. A region where nanosilicon aggregates and a region including nanosilicon and RGO are found in FIG. 40A and FIG. 40B. In addition, it is found that a composite particle in which the region including nanosilicon and RGO is in contact with the region where nanosilicon aggregates to cover the region where nanosilicon aggregates is formed.

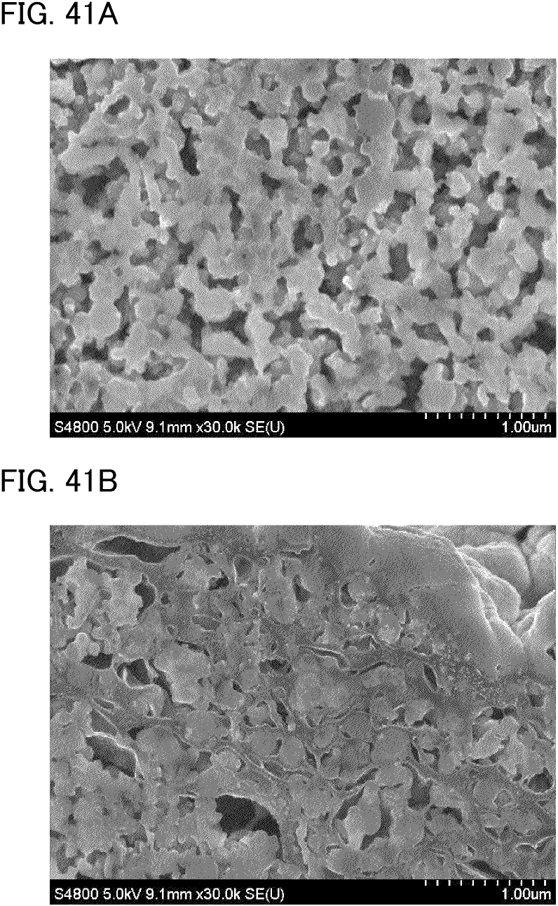

FIG. 41A and FIG. 41B are each an enlarged SEM observation image of part of the cross-sectional observation portion in FIG. 40B; FIG. 41A is an observation image of the region where nanosilicon aggregates, and FIG. 41B is an observation image of the region including nanosilicon and RGO. It is found in the region including nanosilicon and RGO in FIG. 41B that RGO clings to nanosilicon.

### Fabrication of Coin Cell

Next, using the electrode formed in this example, a CR2032 type coin cell (with a diameter of 20 mm and a height of 3.2 mm) was fabricated.

Lithium metal was used for a counter electrode. An electrolyte solution was used in which lithium hexafluorophosphate (LiPF₆) was mixed into a mixture of ethylene carbonate (EC) and diethyl carbonate (DEC) with EC:DEC = 3:7 (in volume ratio), at a concentration of 1 mol/L.

As a separator, a 25-µm-thick polypropylene separator was used.

A positive electrode can and a negative electrode can that were formed using stainless steel (SUS) were used.

### Charging and Discharging Characteristics

The evaluation of charging and discharging characteristics was performed on the fabricated coin cell. In the fabricated coin cell, lithium is occluded in the electrode in discharging and lithium is released from the electrode in charging.

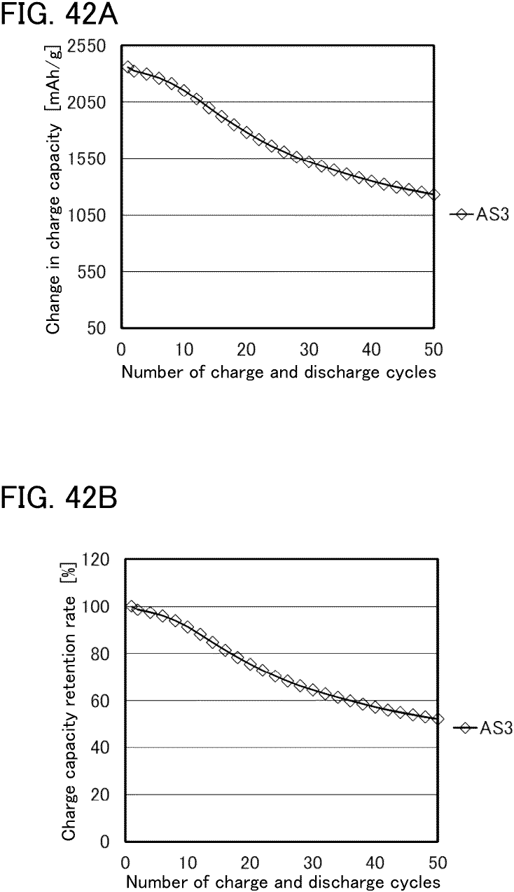

The discharging condition (lithium occlusion) was set to constant current discharging (0.1 C and lower voltage limit of 0.01 V) and then constant voltage discharging (lower current density of 0.01 C), and charging condition (lithium release) was set to constant current charging (0.1 C and upper voltage limit of 1 V). Discharging and charging were performed at 25° C. FIG. 42A and FIG. 42B show changes in capacity with respect to the cycle number in charge and discharge cycles. Table 9 shows the maximum charge capacity in the charge and discharge cycle test and the charge capacity retention rate after 50 cycles. As shown in FIG. 42A, FIG. 42B, and Table 9, favorable charge and discharge cycle performance was confirmed.

[TABLE 10]

| Electrode | Cycle test performance | |
|---|---|---|
| | Maximum charge capacity | Charge capacity retention rate after 50 cycles |
| AS3 | 2360.4 mAh/g | 52.21 % |

### REFERENCE NUMERALS

570: electrode, 570a: negative electrode, 570b: positive electrode, 571: current collector, 571a: negative electrode current collector, 571b: positive electrode current collector, 572: active material layer, 572a: negative electrode active material layer, 572b: positive electrode active material layer, 576: electrolyte, 581: electrolyte, 582: particle, 582a: first particle, 582b: second particle, 583: graphene compound, 584: electrolyte, 585: first region, 586: second region, 591: first tangent, 592: first distance, 593: second distance, 801: first material:, 802: material containing halogen:, 803: material containing oxygen and carbon:, 804: mixture:, 805: particle:, 806: mixture:, 807: particle.

1. An electrode comprising:
a first region; and
a second region,
wherein the first region comprises a first particle comprising silicon,
wherein the second region comprises a second particle comprising silicon and a graphene compound, and
wherein the second region is in contact with at least part of the first region.

2. The electrode according to claim 1,
wherein the second region covers the first region.

3. The electrode according to claim 1,
wherein the graphene compound is in contact with the second particle to cling to the second particle.

4. The electrode according to claim 1,
wherein the first particle and the second particle each comprise a region where a particle surface is terminated with one or more of a functional group comprising oxygen and carbon, a functional group comprising oxygen and hydrogen, a functional group comprising oxygen and lithium, and a hydrogen atom.

5. The electrode according to claim 1,
wherein the first particle and the second particle each comprise oxygen, carbon, and lithium in at least part of a surface portion.

6. The electrode according to claim 1,
wherein the first particle and the second particle each comprise amorphous silicon.

7. The electrode according to claim 1,
wherein the first particle and the second particle each comprise polycrystalline silicon.

8. An electrode comprising:
a particle comprising silicon; and
a graphene compound,
wherein the particle comprises a bond with a functional group comprising oxygen and carbon, a functional group comprising oxygen, or a fluorine atom in at least part of a surface of the particle,
wherein the graphene compound comprises hydrogen or a functional group comprising hydrogen, and
wherein the graphene compound closely clings to the particle.

9. The electrode according to claim 8,
a plurality of particles each comprising silicon; and
the graphene compound, ’
wherein the plurality of the particles each comprises a bond with a functional group comprising oxygen and carbon, a functional group comprising oxygen, or a fluorine atom in at least part of each of a surface of the plurality of the particles, and
wherein the graphene compound closely clings to the plurality of the particles .

10. The electrode according to claim 8,
wherein the particle comprises a carbonate group, a hydrocarbonate group, a hydroxy group, an epoxy group, or a carboxyl group.

11. The electrode according to claim 8,
wherein the particle comprises a region where a particle surface is terminated with one or more of a functional group comprising oxygen and carbon, a functional group comprising oxygen and hydrogen, a functional group comprising oxygen and lithium, and a hydrogen atom.

12. The electrode according to claim 8,
wherein the particle comprises oxygen, carbon, and lithium in at least part of a surface portion.

13. The electrode according to claim 8,
wherein the particle comprising silicon comprises amorphous silicon.

14. The electrode according to claim 8,
wherein the particle comprising silicon comprises polycrystalline silicon.

15. The electrode according to claim 8,
wherein the graphene compound comprises a hole.

16. The electrode according to claim 15,
wherein the graphene compound comprises a plurality of carbon atoms and one or more hydrogen atoms,
wherein the one or more hydrogen atoms each terminate any one of the plurality of the carbon atoms, and
wherein the hole is formed by the plurality of the carbon atoms and the one or more hydrogen atoms.

17. A secondary battery comprising:
the electrode according to claim 8; and
an electrolyte.

18. A moving vehicle comprising the secondary battery according to claim 17.

19. An electronic device comprising the secondary battery according to claim 17.

20. A method for manufacturing a negative electrode active material, the method comprising:
a first step of mixing a particle comprising silicon, lithium fluoride, a material comprising halogen, and a material comprising oxygen and carbon to form a first mixture; and
a second step of heating the first mixture,
wherein the heating in the second step is performed at a temperature higher than or equal to 350° C. and lower than or equal to 900° C. for longer than or equal to 1 hour and shorter than or equal to 60 hours, and
wherein the heating in the second step is performed in a nitrogen atmosphere or a rare gas atmosphere.

21. A method for manufacturing a negative electrode active material layer, the method comprising:
a first step of mixing a negative electrode active material manufactured by the method for manufacturing a negative electrode active material according to claim 20, a graphene compound, and a solvent to form a second mixture;
a second step of mixing the second mixture, a precursor of polyimide, and a solvent to form a third mixture;
a third step of applying the third mixture to metal foil to form a first coating film;
a fourth step of drying the first coating film to form a second coating film; and
a fifth step of heating the second coating film,
wherein the heating in the fifth step is performed in a reduction atmosphere, and
wherein the heating in the fifth step reduces the graphene compound and imidizes the precursor of polyimide.

22. A method for manufacturing an electrode for a lithium-ion secondary battery, the method comprising:
a first step of mixing silicon and lithium carbonate to form a first mixture;
a second step of heating the first mixture to obtain a particle comprising silicon;
a third step of mixing the particle comprising silicon and a solvent to obtain a second mixture;
a fourth step of mixing the second mixture and a graphene compound to form a third mixture;
a fifth step of mixing the third mixture, a precursor of polyimide, and the solvent to form a fourth mixture;
a sixth step of applying the fourth mixture to metal foil;
a seventh step of drying the fourth mixture; and
an eighth step of heating the fourth mixture to form an electrode,
wherein the heating in the eighth step is performed in a reduction atmosphere.

23. The method for manufacturing an electrode for a lithium-ion secondary battery, according to claim 22,
wherein the particle comprising silicon comprises oxygen, carbon, and lithium in at least part of a surface portion.

24. The method for manufacturing an electrode for a lithium-ion secondary battery, according to claim 20,
wherein the particle comprising silicon comprises amorphous silicon.

25. The method for manufacturing an electrode for a lithium-ion secondary battery, according to claim 20,
wherein the particle comprising silicon comprises polycrystalline silicon.

26. The method for manufacturing an electrode for a lithium-ion secondary battery, according to claim 22,
wherein the particle comprising silicon comprises amorphous silicon.

27. The method for manufacturing an electrode for a lithium-ion secondary battery, according to claim 22,
wherein the particle comprising silicon comprises polycrystalline silicon.
